(19) United States
(12) Patent Application Publication
(10) Pub. No.: US 2025/0336979 A1
(43) Pub. Date: Oct. 30, 2025

(54) SCALABLE SYNTHESIS OF SALICYLALDEHYDATE-BASED METAL-ORGANIC FRAMEWORKS AND APPLICATIONS THEREOF

(71) Applicant: Khalifa University of Science and Technology, Abu Dhabi (AE)

(72) Inventors: Dinesh Shetty, Abu Dhabi (AE); Abdul Khayum Mohammed, Abu Dhabi (AE)

(21) Appl. No.: 19/261,490

(22) Filed: Jul. 7, 2025

Related U.S. Application Data
(63) Continuation-in-part of application No. 18/243,310, filed on Sep. 7, 2023.
(60) Provisional application No. 63/404,293, filed on Sep. 7, 2022.

(51) Int. Cl. H01M 4/62; C07F 15/02; H01M 4/133; H01M 4/587; H01M 10/0525

(52) U.S. Cl. CPC H01M 4/628; C07F 15/025; H01M 4/133; H01M 4/587; H01M 10/0525

(57) ABSTRACT

Embodiments of the present disclosure describe metal organic framework (MOF)-like composite material (MOFite) including a salicylaldehydate-based iron metal organic framework composition and graphite, a lithium-ion battery including a cathode and an anode including a salicylaldehydate-based iron metal organic framework composition and graphite, and a scalable synthesis methods for salicylaldehydate-based metal-organic frameworks (SA-MOFs), specifically Fe-Tp, and their applications in lithium-ion batteries (LIBs).

### CROSS-REFERENCE TO RELATED APPLICATION

This application is a Continuation-in-Part of 18/243,310, filed on Sep. 7, 2023, which claims the benefit of U.S. Provisional Application No. 63/404,293, filed on Sep. 7, 2022, and which applications are incorporated herein by reference. A claim of priority to all, to the extent appropriate, is made.

### BACKGROUND

Metal-organic frameworks (MOFs) are two- or three-dimensional (2D/3D) coordination solids with defined and tailored structures and permanent porosity. The precisely integrated molecular architecture of MOFs allows various functional activities such as molecular storage and conversion, optoelectronics, and separation applications. Notably, the large library of metal knots and organic linkers allows the construction of many topochemical diverse classes of functional porous structures. Among various classes of MOFs, recently, the two and three-dimensional conjugated MOFs (2D/3D-c-MOFs) are developed and are well known for their intrinsic optic and electronic conductive properties. The weakly stacked 2D layers of frameworks in 2D-c-MOFs provide large exposure to active sites. Moreover, the in-plane 2D-conjugation enlarges the viability of 2D-c-MOFs in photo-electro-induced molecular conversions and storage. Herein, such extended in-plane conjugation originated from the intrinsic pi-conjugation of the organic linker and vacant d-orbitals from metal ions. Similarly, 3D-c-MOFs offer more open 3D porosity with conductivity range in all dimensions. However, the organic linkers explored for the coordination interactions in 2D/3D-c-MOFs are largely limited to hydroxyl (—OH), (—NH2), and thiol (—SH) moieties. Roughly 20-30 2D/3D-c-MOFs have been explored in the past decade from aromatic units such as benzene, triphenylene, trinaphthylene, coronene, and phthalocyanine. In addition, all the c-MOFs reported so far have been synthesized via solvothermal or interfacial methods, which are economically and environmentally less favorable. This is because toxic organic solvents such as hydrochloric acid, and hydrofluoric acid are being used to separate the metal ions and get the organic linkage. Meanwhile, the introduction of new linkage chemistry in 2D/3D-c-MOFs remains a great challenge due to the lack of suitable coordinating organic pockets in the aromatic linkers. Moreover, considering the environmental and economic factors, the synthetic routes of such potential materials are recommended as rapid and solvent-free methods.

### SUMMARY

In general, embodiments of the present disclosure describe two-dimensional/three-dimensional conjugated salicylaldehydate metal organic framework (2D/3D-c-SA MOF) compositions and method of making the two-dimensional/three-dimensional conjugated salicylaldehydate metal organic framework (2D/3D-c-SA MOF) compositions.

Accordingly, embodiments of the present disclosure describe two-dimensional/three-dimensional conjugated salicylaldehydate metal organic framework (2D/3D-c-SA MOF) compositions comprising one or more metal ions and one or more ligands; wherein the ligand is C₃ symmetric aldehyde organic linker.

Embodiments of the present disclosure describe a method for green synthesis of two-dimensional/three-dimensional conjugated salicylaldehydate metal organic framework (2D/3D-c-SA MOF) compositions comprising adding one or more organic ligands to one or more metal ions, wherein the ligand is a C₃ symmetric aldehyde organic linker; mechano-mixing the above into a solid paste form; adding one or more drops of DI water to the solid paste; heating the mixture in a closed container sufficient to form a solid powder; washing the solid powder with solvents to obtain a 2D/3D-c-SA MOF powder.

Embodiments of the present disclosure describe a scalable synthesis method for salicylaldehydate-based metal-organic frameworks (SA-MOFs), specifically Fe-Tp, and their application as high-performance anode materials for lithium-ion batteries (LIBs). The Fe-Tp MOF is synthesized using cost-effective techniques such as ball milling and motor-assisted mixing, enabling large-scale production while maintaining exceptional electrochemical performance. Fe-Tp exhibits ultrahigh specific capacities (up to 1447 mAh g⁻¹ at 0.1 A g⁻¹) and long-term cyclic stability, outperforming conventional graphite anodes.

Additionally, the embodiments herein describe a composite material, termed “MOFite,” which combines Fe-Tp (at approximately 10%) with commercial graphite (at approximately 90%). MOFite significantly enhances the specific capacity of graphite, doubling its performance after approximately 400 charge-discharge cycles. The hierarchical porous structure of Fe-Tp, rich in lithiophilic sites, facilitates efficient lithium-ion diffusion and interaction, making it helpful for lithium ion battery (LIB) applications.

These embodiments also demonstrate the feasibility of large-scale production (up to 25 grams per batch, in some examples) without compromising performance, addressing critical challenges in the commercialization of MOF-based materials. Fe-Tp and MOFite are proposed herein as cost-effective, scalable solutions for improving energy density and cyclic stability in LIBs, with potential applications in electric vehicles, portable electronics, and renewable energy storage systems.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 is a flowchart illustrating the steps utilized in a green synthetic method of a two-dimensional/three-dimensional conjugated salicylaldehydate metal organic framework (2D/3D-c-SA MOF) composition according to one or more embodiments of the present disclosure.

FIG. 2A shows the graphical representation of the synthesis of SA-MOFs. The precursors are mixed in solid-state in the presence of a few drops of water and thermally treated for a few hours. FIG. 2B shows the monolayer space-filling and models of Cu-Tp and Ni-Tp that show coordination interactions between the Tp and metal ions. FIG. 2C shows the simulated square planar ball and stick models of Cu-Tp and Ni-Tp. The pore size of ˜1.0 nm and an interlayer distance of 0.3 nm were observed for both MOFs. FIG. 2D-F show the experimental (black) and calculated (orange) PXRD profiles of Cu-Tp-I (FIG. 2D, Cu-Tp-II (FIG. 2E), and Ni-Tp (FIG. 2F) square-planar models, along with the Bragg positions (green), the difference between both patterns (blue) and the Pawley refinement (red).

FIG. 3A-FIG. 31 show digital photographs of the products obtained from the functional group (—OH and HC═O) controlled building blocks with copper salts. FIG. 3A shows the functional group for the organic linker Pg. FIG. 3B shows the functional group for the organic linker Tp. FIG. 3C shows the functional group for the organic linker Ht. FIG. 3D shows the product obtained for Cu-Pg-I. FIG. 3E shows the product obtained for Cu-Tp-I. FIG. 3F shows the product obtained for Cu-Ht-I. FIG. 3G shows the product obtained for Cu-Pg-II. FIG. 3H shows the product obtained for Cu-Tp-II. FIG. 31 shows the product obtained for Cu-Ht-II.

FIG. 4A-FIG. 4B show digital photographs of the products obtained from building blocks with only aldehydes. FIG. 4A shows the product obtained for Cu-Tta-I. FIG. 4B shows the product obtained for Cu-Tfpa-I.

FIG. 5A-FIG. 5E show the Crystal structure model of Cu-Tp-MOF, with square planar coordination environment of copper atoms. FIG. 5A shows Nine-unit cells viewed along the z-axis; FIG. 5B shows Four-unit cells; FIG. 5C shows One-unit cell; FIG. 5D shows the Square-planar conformation of the copper atom; and FIG. 5E shows the view along the y-axis.

FIG. 6A-FIG. 6E show the Crystal structure model of Cu-Tp-MOF, with Tetrahedral coordination environment of copper atoms. FIG. 6A shows Nine-unit cells viewed along the z-axis; FIG. 6B shows Four-unit cells; FIG. 6C shows One-unit cell; FIG. 6D shows the Tetrahedral conformation of the copper atom; and FIG. 6E shows the View along the y-axis.

FIG. 7A-FIG. 7E shows the Crystal structure model of Cu-Tp-MOF with copper atoms in octahedral coordination environment, including two coordinated water molecules in the apical positions. FIG. 7A shows Nine-unit cells viewed along the z-axis; FIG. 7 B shows Four-unit cells; FIG. 7C shows One-unit cell; FIG. 7D shows the Octahedral conformation of the copper atom; and FIG. 7E shows the View along the y-axis.

FIG. 8A shows the PXRD profile of Cu-Tp-Film and Cu-Tp-I. FIG. 8B shows the PXRD profile of Cu-Tp-Film and blank copper foil.

FIG. 9 shows the comparison of FT-IR spectra of Cu-Tp-Film with Tp and Cu-Tp-I.

FIG. 10A shows the graphical representation of the synthesis of Fe-Tp. The precursors are mixed in solid-state and thermally treated for 24 hours. FIG. 10B shows the Chem Draw image of Fe-Tp. FIG. 10C show the experimental (blue) and calculated (phase 1—black and phase 2—red) PXRD profiles of Fe-Tp along with the difference between them (green). FIG. 10D shows the TEM image of a single crystal (size ˜142 nm) of Fe-Tp. FIG. 10E shows the octahedral coordination of Fe with Tp linker. It showed two independent framework fragments from the 3D model of Fe-Tp. The phenyl groups (in blue and white colors) arranged in an independent framework with iron atoms (in red color), are shown in a dotted circle. FIG. 10F shows the theoretical stick model (3D) of Fe-Tp. The Fe-Tp consist of two crystalline phases (Biphasic) with different unit cell length (a=11.61 \acute{Å} and 11.92 \acute{Å}). The independent doubly interpenetrated frameworks are shown in white and red colors. FIG. 10G shows the polyhedral model of the octahedral coordination of Fe (Blue) with Tp (Yellow) [Carbon—black, and Oxygen—red]. FIG. 10H shows the simplified representation of the topology of Fe-Tp (srs-c-a). The inorganic building blocks are shown as blue trigonal and organic linkers are represented as yellow trigonals.

FIG. 11A shows the FTIR profiles of SA-MOFs with Tp linker. FIG. 11B shows the XPS profiles of SA-MOFs show the metal ions chemical states (Cu²⁺ and Ni²⁺) in the MOFs. FIG. 11C-FIG. 11E show the N₂ gas adsorption isotherms of Cu-Tp-I, Cu-Tp-II, and Ni-Tp and their corresponding BET surface areas as 167, 105, and 109 m² g⁻¹, respectively. FIG. 11F-FIG. 11H show the SEM images of Cu-Tp-I (FIG. 11F), Cu-Tp-II (FIG. 11G) and Ni-Tp (FIG. 11H). Inset: EDX images show the metal distribution within the MOFs. FIG. 111-FIG. 11K show the TEM images of Cu-Tp-I (FIG. 111), Cu-Tp-II (FIG. 11J) and Ni-Tp (FIG. 11K).

FIG. 12A and FIG. 12B show the NLDFT pore width vs surface area of Cu-Tp-I (FIG. 12A) and Cu-Tp-II (FIG. 12B).

FIG. 13A and FIG. 13B show the NLDFT pore width vs pore volume of Cu-Tp-I (FIG. 13A) and Cu-Tp-II (FIG. 13B).

FIG. 14A and FIG. 14B show the Horvath-Kawazoe microporous distribution of Cu-Tp-I (FIG. 14A) and Cu-Tp-II (FIG. 14B).

FIG. 15A shows the FTIR profiles of Fe-Tp with Tp linker. In FIG. 15B, the XPS profiles of Fe-Tp show the chemical states of iron and oxygen. FIG. 15C (i) and FIG. 15C (ii) show the digital photographs of Fe-Tp before (FIG. 15C (i)) and after (FIG. 15C (ii)) acid treatment. FIG. 15D (i) and FIG. 15D (ii) show the SEM images of Fe-Tp monoliths (FIG. 15D (i)) which are composed of microspheres (FIG. 15D (ii)) (200-500 nm). FIG. 15E shows the TEM image of Fe-Tp. FIG. 15F (i)-FIG. 15F (iii) shows the SEM elemental mapping of Fe-Tp (Carbon (grey), FIG. 15F (i); Oxygen (red), FIG. 15F (ii); and Iron (green), FIG. 15F (iii). FIG. 15G shows the SEM image of Fe-Tp after acid treatment. FIG. 15H shows the PXRD of Fe-Tp after acid treatments. FIG. 15I shows the FT-IR of Fe-Tp after acid treatments.

FIG. 16A-FIG. 16(b) show the SEM images of Tp-Cu foil. FIG. 16A shows that the vertical SEM image displayed MOF formation even at the edges surface. The SEM image of bare copper foil is shown in the inset. FIG. 16B shows the petal-like morphology of TpCu at the surface of the foil.

FIG. 17A-FIG. 17D show the SEM elemental mapping images of Cu-Tp-Film. FIG. 17A shows the SEM image of the Cu-Tp film. FIG. 17B shows the SEM elemental mapping images of Carbon. FIG. 17C shows the SEM elemental mapping images of Oxygen. FIG. 17D shows the SEM elemental mapping images of Copper.

FIG. 18A shows the current-voltage plot of Tp-Cu foil. FIG. 18B shows the temperature-conductivity plot of Tp-Cu foil.

FIG. 19 shows the impedance analysis of Tp-Cu Film at the temperature ranges from 50° C. to 90° C.

FIG. 20 shows the conductivity vs temperature plot from impedance analysis of Tp-Cu film.

FIG. 21A shows the solid-state UV-visible spectroscopy of Cu-Tp-I and FIG. 21B shows the solid-state UV-visible spectroscopy of Cu-Tp-II.

FIG. 22A shows the Tauc plots of Cu-Tp-I and FIG. 22B shows the Tauc plots of Cu-Tp-II.

FIG. 23A-FIG. 23F show the CO₂ adsorption-desorption isotherm of Cu-Tp-I (FIG. 23A, FIG. 23B), Cu-Tp-II (FIG. 23C, FIG. 23D) and Ni-Tp (FIG. 23E, FIG. 23F) at 273 K and 298 K respectively.

FIG. 24A shows the graphical representation of photocatalytic CO₂ reduction experiment. A thin film of Cu-Tp-I is shown in the round bottom flask containing NaHCO₃ and H₂SO₄ mixture. The evolved CO₂ molecules are photo-catalytically reduced into CO. FIG. 24B shows the plot of CO yield vs irradiation time. FIG. 24C shows the stability analysis of Cu-Tp-I for four cycles (4 hours in each cycle).

FIG. 25 shows the electrocatalytic oxygen evolution reaction analysis of SA-MOFs-Current density vs potential.

FIG. 26A shows the possible electrochemical redox reactions of Fe-Tp. FIG. 26B shows the impedance analysis of Fe-Tp at various electrolyte concentrations. FIG. 26C shows the redox peaks of three-electrode CV of Fe-Tp at 5 mV sec⁻¹ and 1 M H₂SO₄. FIG. 26D shows the GCDC analysis of Fe-Tp at various electrolyte concentrations at 0.1 A g⁻¹. FIG. 26E shows the electrolyte concentrations vs specific capacity plot of Fe-Tp at 0.1 and 1 A g⁻¹.

FIG. 27A shows the graphical representation of the Fe-Tp supercapacitor with the digital photograph. FIG. 27B shows the impedance analysis of the Fe-Tp supercapacitor.

FIG. 27C shows the CV of the Fe-Tp supercapacitor at 20 mV sec⁻¹ (inset: the digital photograph of Fe-Tp supercapacitor powered 3.6 V LED). FIG. 27D shows the GCDC profile of Fe-Tp supercapacitor at various current densities. FIG. 27E shows the long-term cyclic stability analysis of Fe-Tp supercapacitor along with coulombic efficiency. FIG. 27F shows the comparison of cyclic stability of Fe-Tp supercapacitor with reported MOF-based supercapacitors.

FIG. 28A shows the cyclic stability of Fe-Tp at 1 A g⁻¹ in three-electrode assembly; FIG. 28B shows the GCDC of Fe-Tp in three-electrode assembly; FIG. 28C shows the rate performance of Fe-Tp in three-electrode assembly; FIG. 28D shows the cyclic stability of Fe-Tp at 1 A g⁻¹ in full cell; and FIG. 28E shows the GCDC of Fe-Tp full cell.

FIG. 29A and FIG. 29B show the PXRD profiles of multi metallic SA-MOFs. FIG. 29A shows the PXRD profile of NiCu-Tp multi metallic SA MOF. FIG. 29B shows the PXRD profile of CoFe-Tp multi metallic SA MOF.

FIG. 30 illustrates a schematic cross-sectional view of a lithium-ion battery illustrating its principal internal components and overall structure according to some embodiments.

FIG. 31 is a flowchart illustrating the steps utilized in synthesizing a salicylaldehydate-based iron metal-organic framework (Fe-Tp) composition according to some embodiments.

FIG. 32A shows a synthetic scheme of the synthesis of Fe-Tp according to some embodiments.

FIG. 32B shows a graphical representation of the synthesis of Fe-Tp using the ball-milling mechanochemical synthesis method according to some embodiments.

FIG. 32C illustrates SEM images of Fe-Tp showing spherical morphology according to some embodiments.

FIG. 32D which illustrates the experimental PXRD of Fe-Tp in small-scale (milli-gram level) synthesis using mortar and pestle large-scale synthesis (several grams, −25 g, using ball-milling method according to some embodiments.

FIG. 33A illustrates a diagrammatic representation Li+ ion diffusion through the hierarchically porous Fe-Tp and possible site interactions according to some embodiments.

FIG. 33B illustrates an optimized crystal structure with 48 Li atoms, highlighting the structure with the maximum Li capacity at neutral conditions (without applying any electric potential) according to some embodiments.

FIG. 33C illustrates an interaction of lithium with various binding sites (Fe and O) in the Fe-Tp according to some embodiments.

FIG. 33D illustrates an interaction of FeO₆ unit with lithium according to some embodiments.

FIG. 34A illustrates the rate performance of the half-cell analysis of Fe-Tp according to some embodiments.

FIGS. 34B-34D each illustrate the cyclic stability analysis at various current density (0.5, 1, and 2 A g⁻¹, for each of FIGS. 34B, 34C, and 34D, respectively) according to some embodiments.

FIG. 34E illustrates the cyclic stability analysis of 25 g batch of Fe-Tp according to some embodiments.

FIG. 34F illustrates the GCDC profiles at various current densities (0.1 to 10 A g⁻¹) according to some embodiments.

FIG. 34G illustrates the CV profile according to some embodiments.

FIG. 34H illustrates the plot scan rate (mV sec⁻¹) Vs. % contribution (diffusion or capacitive) according to some embodiments.

FIG. 35A illustrates the electrochemical performance of a full cell fabricated using a lithiated Fe-Tp anode (Li-Fe-Tp) and a lithium iron phosphate (LFP) cathode, with a theoretical capacity of 170 mAh g⁻¹ according to some embodiments.

FIG. 35B illustrates the long-term cycling performance of the full cell at 1.0 C according to some embodiments.

FIG. 35C depicts the full cell's performance at 10 C, where it delivered an initial specific capacity of 65 mAh g⁻¹ according to some embodiments.

FIG. 35D illustrates the electrochemical impedance spectroscopy (EIS) profile of the full cell, recorded before and after 100 cycles according to some embodiments.

FIG. 36A illustrates the fabrication process of MOFite, a composite material designed as a performance booster for commercially available graphite anodes in lithium-ion batteries (LIBs) according to some embodiments.

FIG. 36B illustrates the initial specific capacity of MOFite and graphite during charge-discharge experiments at a current density of 2 A g⁻¹ according to some embodiments.

FIG. 36C illustrates the extended cycling performance of MOFite compared to graphite according to some embodiments.

FIG. 36D illustrates the long-term cycling performance of MOFite and graphite after 800 charge-discharge cycles according to some embodiments.

### DETAILED DESCRIPTION

The past decade has witnessed constructive progress in developing two-dimensional conjugated MOFs (2D-c-MOFs) for improved electro and photochemical energy storage and conversions. However, the organic coordination functionalities of 2D-c-MOFs are primarily limited to nucleophilic hydroxyl (—OH), amine (—NH2), and thiol (—SH) moieties. On the other hand, generally, 2D-c-MOFs are produced by economically and environmentally less favored solvothermal reactions.

In general, the present disclosure relates to compositions of various novel two-dimensional and three-dimensional conjugated salicylaldehydate metal organic frameworks (2D/3D-c-SA MOFs) by introducing the novel coordination chemistry using the C₃ symmetric aldehyde organic linkers and metal ions (Cu, Mg, Cr, Mn, Fe, Co, Ni, Mo, Ru, U, Pd, Rh, Ir, Tc, Sc, Pt, Al) through cost-effective and efficient mechanochemical synthesis (called salicylaldehydate MOF or SA-MOFs) and the methods of synthesizing the same. The metal ion may be present as a metal knot, wherein the metal can differ with coordination spheres, which in turn decides the resulting structural symmetry (e.g., square planar, octahedral etc.) The reversible coordination of salicylaldehydate functional pocket with the metal centers allowed the construction of porous and crystalline SA-MOFs. There is variability due to various metal centers with different coordination spheres. The 2D/3D-c-MOFs showed semiconductive property, electrochemical energy storage property (as in supercapacitor and battery devices) and electrocatalytic and photocatalytic molecular conversion properties. Notably, Fe-Tp MOF showed excellent chemical stability in even 10 M acids indicating their potential utilities in harsh environments.

Embodiments of the present disclosure describe a two-dimensional/three-dimensional conjugated salicylaldehydate metal organic framework (2D/3D-c-SA MOF) composition comprising one or more metal ions and one or more ligands, wherein the ligand is a C₃ symmetric aldehyde organic linker. Some embodiments of the present disclosure describe 2D/3D-c-SA MOF compositions wherein the ligand comprises but is not limited to 1, 3, 5-triformylphloroglucinol (Tp), 2-hydroxytriformylbenzene (Ht), tris (4-formylphenyl) amine (Tfp), 1,3,5-triazine-2,4,6-triyl) tribenzaldehyde (Tta), phloroglucinol (Pg). Yet other embodiments of the present disclosure describe 2D/3D-c-SA MOF compositions wherein the metal ion comprise, but is not limited to Cu, Mg, Cr, Mn, Fe, Co, Ni, Mo, Ru, U, Pd, Rh, Ir, Tc, Sc, Pt, Al.

Some embodiments of the present disclosure describe a 2D/3D-c-SA MOF composition, wherein the composition comprises hcb layers with ABC stacking. Some embodiments of the present disclosure describe a 2D/3D-c-SA MOF composition wherein the composition maintains crystalline network at low thermal treatment. Some embodiments of the present disclosure describe a 2D/3D-c-SA MOF composition, wherein the temperature for thermal treatment ranges from 30°° C. to 60° C. One or more embodiments of the present disclosure describe a 2D/3D-c-SA MOF composition, wherein the composition is stable in solvents. Some embodiments of the present disclosure describe a 2D/3D-c-SA MOF composition, wherein the solvent comprises water or highly polar solvents.

Some embodiments of the present disclosure describe a 2D/3D-c-SA MOF composition, wherein the composition has a pore size in the range of 0.8 to 1.3 nm. Some embodiments of the present disclosure describe a 2D/3D-c-SA MOF composition, wherein the composition has a pore size in the range of 0.7 to 1.5 nm. Some embodiments of the present disclosure describe a 2D/3D-c-SA MOF composition, wherein the composition has a pore size in the range of 0.8 to 1.0 nm. Some embodiments of the present disclosure describe a 2D/3D-c-SA MOF composition, wherein the composition has a pore size in the range of 0.9 to 1.2 nm. Some embodiments of the present disclosure describe a 2D/3D-c-SA MOF composition, wherein the composition has an interlayer distance in the range of 0.25 to 0.35 nm. Yet other embodiments of the present disclosure describe a 2D/3D-c-SA MOF composition, wherein the composition is stable at temperatures in the range of 200° C.-375° C. One or more embodiments of the present disclosure describe a 2D/3D-c-SA MOF composition, wherein the composition exhibits CO₂ uptake.

Certain embodiments of the present disclosure describe a 2D/3D-c-SA MOF composition, wherein the composition is a thin film. Some embodiments of the present disclosure describe a 2D/3D-c-SA MOF composition, wherein the thin film has a thickness in the range of 20 μm-35 μm. Some embodiments of the present disclosure describe a 2D/3D-c-SA MOF composition, wherein the thin film has a thickness in the range of 15 μm-40 μm. Some embodiments of the present disclosure describe a 2D/3D-c-SA MOF composition, wherein the thin film exhibits uniform flower petal-like morphology on the entire surface. Some embodiments of the present disclosure describe a 2D/3D-c-SA MOF composition, wherein the thin film exhibits semiconductive property. Some embodiments of the present disclosure describe a 2D/3D-c-SA MOF composition, wherein the thin film exhibits photocatalytic reduction of CO₂. Some embodiments of the present disclosure describe a 2D/3D-c-SA MOF composition, wherein the photocatalytic reduction occurs without the use of cocatalyst or sacrificial agents. Sacrificial agents are the electron donors or hole scavengers that reduce the recombination tendency of electrons or holes and accelerate the rate of catalytic reaction. In general, alcohols or amines can be used as sacrificial agents. For example, triethanolamine (TEOA) is a well-known sacrificial agent. Some embodiments of the present disclosure describe a 2D/3D-c-SA MOF composition, wherein the thin film exhibits photostability in the photocatalytic reduction of CO2. Some embodiments of the present disclosure describe a 2D/3D-c-SA MOF composition, wherein the thin film retains 93% photocatalytic efficiency after repeated cycles, and wherein the cycle comprises a duration of 4-6 hours. Some embodiments of the present disclosure describe a 2D/3D-c-SA MOF composition, wherein the thin film retains 70% to 95% photocatalytic efficiency after repeated cycles, wherein the cycle comprises a duration of 3-10 hours.

Some embodiments of the present disclosure describe a 2D/3D-c-SA MOF composition, wherein the thin film is recyclable. Some embodiments of the present disclosure describe a 2D/3D-c-SA MOF composition, wherein the thin film exhibits structural stability to visible light irradiation. Structural stability refers to the stability of molecular arrangement and the structural integrity of the network. That is when in the presence of external energy sources, including light, the bonding between the ligand and a metal ion remains intact. Yet other embodiments of the present disclosure describe a 2D/3D-c-SA MOF composition, wherein the composition exhibits a state between semicrystalline and porous. Some embodiments of the present disclosure describe a 2D/3D-c-SA MOF composition, wherein the composition exhibits supercapacitor property. Some embodiments of the present disclosure describe a 2D/3D-c-SA MOF composition, wherein the composition retains 90% of the initial capacitance until 25000charge-discharge cycles. Some embodiments of the present disclosure describe a 2D/3D-c-SA MOF composition, wherein the composition exhibits supercapacitor property and retains 80%-90% of the initial capacitance until 36000 charge-discharge cycles. Certain embodiments of the present disclosure describe a 2D/3D-c-SA MOF composition, wherein the composition exhibits rechargeable lithium-ion battery anode specific capacity. One or more embodiments of the present disclosure describe a 2D/3D-c-SA MOF, wherein the composition is electrically conductive. Yet other embodiments of the present disclosure describe a 2D/3D-c-SA MOF composition, wherein the composition is suitable for electrocatalytic conversion reactions.

Embodiments of the present disclosure further describe a method for green synthesis of a two-dimensional/three-dimensional conjugated salicylaldehydate metal organic framework (2D/3D-c-SA MOF) composition. The method comprises adding one or more organic ligand to one or more metal ion; wherein the ligand is C₃ symmetric aldehyde organic linker. This is followed by mechano-mixing the above into a solid paste form and then adding a drop of DI water to the solid paste. This is followed by heating the mixture in a closed container sufficient to form a solid powder and then washing the solid powder with solvents to obtain the 2D/3D-c-SA MOF as powder.

In general, the present disclosure relates to the scalable synthesis of salicylaldehydate-based metal-organic frameworks (SA-MOFs), specifically Fe-Tp, and their applications in lithium-ion batteries (LIBs). The embodiments described herein addresses critical challenges in energy storage technology by introducing a novel class of MOFs with hierarchical porous structures and densely packed lithiophilic sites, which facilitate efficient lithium-ion diffusion and interaction. Fe-Tp is synthesized using cost-effective mechanochemical techniques, such as ball milling and motor-assisted mixing, enabling large-scale production while maintaining exceptional electrochemical performance.

The embodiments herein further describe a composite material, termed “MOFite,” which combines Fe-Tp with commercial graphite to significantly enhance the specific capacity and cyclic stability of graphite anodes. These advancements provide scalable, environmentally friendly, and high-performance solutions for LIB applications, including electric vehicles, portable electronics, and renewable energy systems. The detailed description below outlines the synthesis methods, structural features, electrochemical performance, and practical applications of Fe-Tp and MOFite in LIBs.

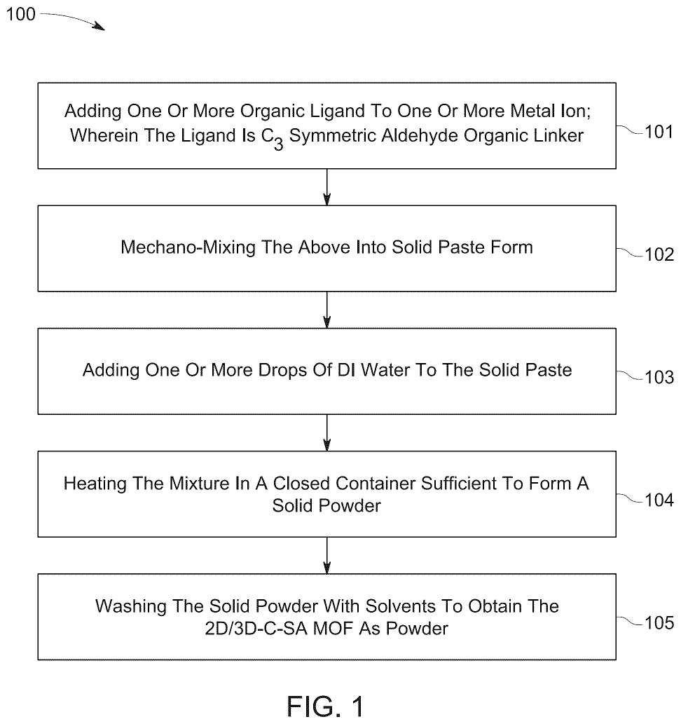

FIG. 1 is a flowchart illustrating the steps utilized in a green synthetic method of a two-dimensional/three-dimensional conjugated salicylaldehydate metal organic framework (2D/3D-c-SA MOF) composition according to one or more embodiments of the present disclosure. As shown in FIG. 1, the method may comprise adding (101) one or more organic ligand to one or more metal ion; wherein the ligand is C₃ symmetric aldehyde organic linker. This is followed by mechano-mixing (102) the above into a solid paste form and then adding (103) a drop of DI water to the solid paste. This is followed by heating (104) the mixture in a closed container sufficient to form a solid powder and then washing (105) the solid powder with solvents to obtain the 2D/3D-c-SA MOF as powder. Step 101 comprises adding (101) one or more organic ligand to one or more metal ion. The organic linkers comprise C₃ symmetric aldehyde organic linkers. Some examples of organic linkers or ligands include, but are not limited to 1, 3, 5-triformylphloroglucinol (Tp), 2-hydroxytriformylbenzene (Ht), tris (4-formylphenyl) amine (Tfpa), 1,3,5-triazine-2,4,6-triyl) tribenzaldehyde (Tta), phloroglucinol (Pg). Any extendable linker with symmetric salicylaldehyde units may be used. The extended version can help extend the conjugation, thereby achieving better opto-electronic behavior. The metal ions comprise, but are not limited to Cu, Mg, Cr, Mn, Fe, Co, Ni, Mo, Ru, U, Pd, Rh, Ir, Tc, Sc, Pt, Al. The metal ion may be present as a metal knot, wherein the metal can differ with coordination spheres, which in turn decides the resulting structural symmetry (e.g., square planar, octahedral etc.) The reversible coordination of salicylaldehydate functional pocket with the metal centers allowed the construction of porous and crystalline SA-MOFs. The 2D/3D-c-MOFs showed semiconductive properties, electrochemical energy storage properties (as in supercapacitor and battery devices), and electrocatalytic and photocatalytic molecular conversion properties. Notably, Fe-Tp MOF showed excellent chemical stability in even 10 M acids indicating their potential utilities in harsh environments.

Step 102 includes mechano-mixing (102) the above into a solid paste form. This is a cost-effective and efficient form of mechanochemical synthesis. Cu-Tp-I was synthesized through mechanochemical reactions using a mortar and pestle. The Tp linker (0.15 mmol) was directly added into the 1.5 equivalent of Cu (NO₃)₂.3H₂O (0.225 mmol) and mechano-mixed thoroughly into a solid paste form. For Cu-Tp-II, the synthetic procedure was the same as above, except that CuCl₂.2H₂O instead of Cu(NO₃)₂.3H₂O was used. The Cu-Pg-I and Cu-Pg-II were synthesized through mechanochemical reactions using a mortar and pestle. The Pg linker (0.15 mmol) was directly added into 1.5 equivalent of Cu(NO₃)₂.3H₂O or CuCl₂.2H₂O (0.225 mmol) (0.225 mmol) and thoroughly mechano-mixed into a solid paste form. The Cu-Ht-I and Cu-Ht-II were synthesized through mechanochemical reactions using a mortar and pestle. The Ht linker (0.15 mmol) was directly added into the 1.5 equivalent of Cu(NO₃)₂.3H₂O or CuCl₂.2H₂O (0.225 mmol) and mechano-mixed thoroughly into a solid paste form. The Cu-Tfpa was synthesized through mechanochemical reactions by using a mortar and pestle. The Tfpa linker (0.15 mmol) was directly added into the 1.5 equivalent of Cu(NO₃)₂.3H₂O (0.225 mmol) and mechano-mixed thoroughly into a solid paste form. For the synthesis of 3D MOF of Fe-Tp, the Fe-Tp MOF was synthesized through mechanochemical reactions without any catalyst or solvents. The Tp (0.15 mmol) linker was directly added to FeCl3·6H₂O (0.15 mmol) in a granite mortar and then ground thoroughly into a solid paste form.

Step 103 includes adding one or more drops of DI water to the solid paste and Step 104 includes heating the above mixture in a closed container sufficient to form a solid powder. A drop of DI water (˜50 μL) was added to the solid mixture for uniform mixing and subsequently, the mixture was heated at 90° C. in a closed container for 5 hours. The temperature and the duration of heating were varied to get the optimal condition. The temperature ranges from 25° C. to 140° C. The optimal temperature was obtained at 90° C. One or more embodiments of the present disclosure describe a method wherein the heating was done for 1-72 hours. Some embodiments of the present disclosure describe a method wherein the heating was done for 5-24 hours. The duration of heating for 5 hours achieved the optimal condition.

In Step 105, the resulting solid powder was washed in solvents to obtain the 2D/3D-c-SA MOF as powder. The resulting solid powder in Step 104 was washed with N, N-dimethylacetamide (DMA), tetrahydrofuran (THF), water, and acetone to obtain Cu-Tp-I as a green color powder. For Cu-Pg-I and Cu-Pg-II, the resulting materials were obtained as dark color brown products. The resulting Cu-Ht-I and Cu-Ht-II were obtained as bright and pale green color products, respectively. The resulting Cu-Tfpa was obtained as pale green color products. The resulting Cu-Tta was obtained as pale green color products. The resulting 3D MOF of Fe-Tp was obtained as a dark red-brown color powder.

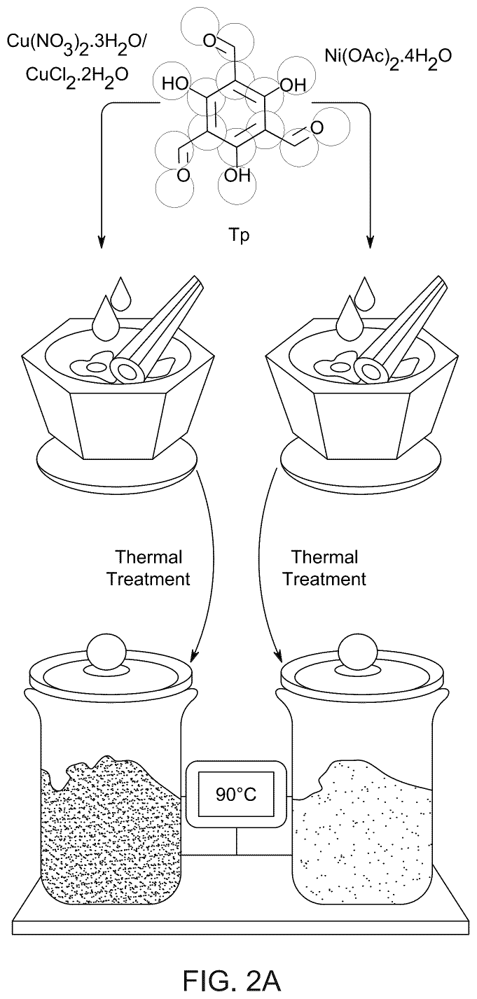

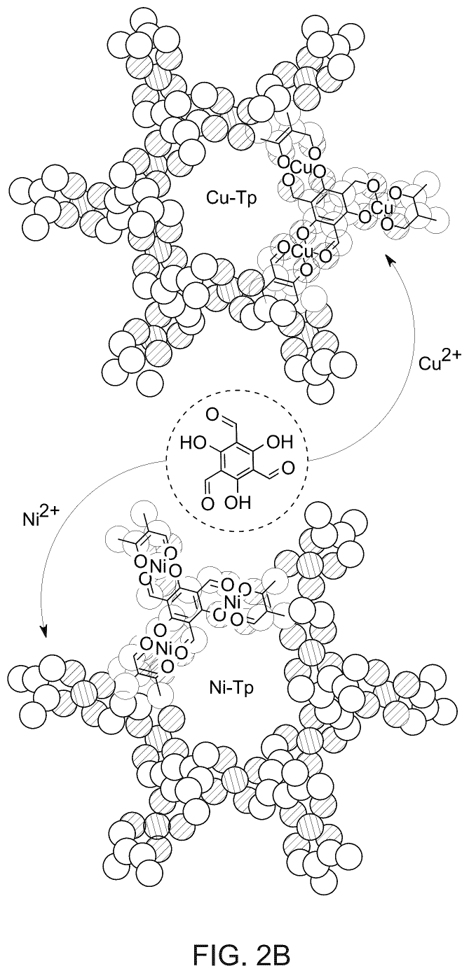

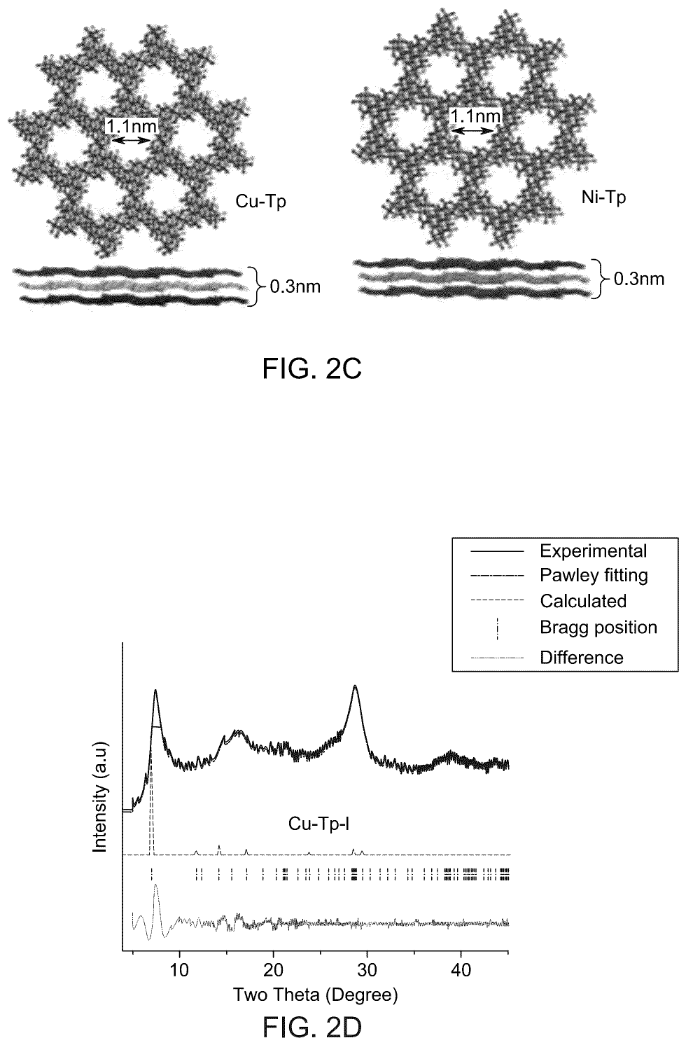

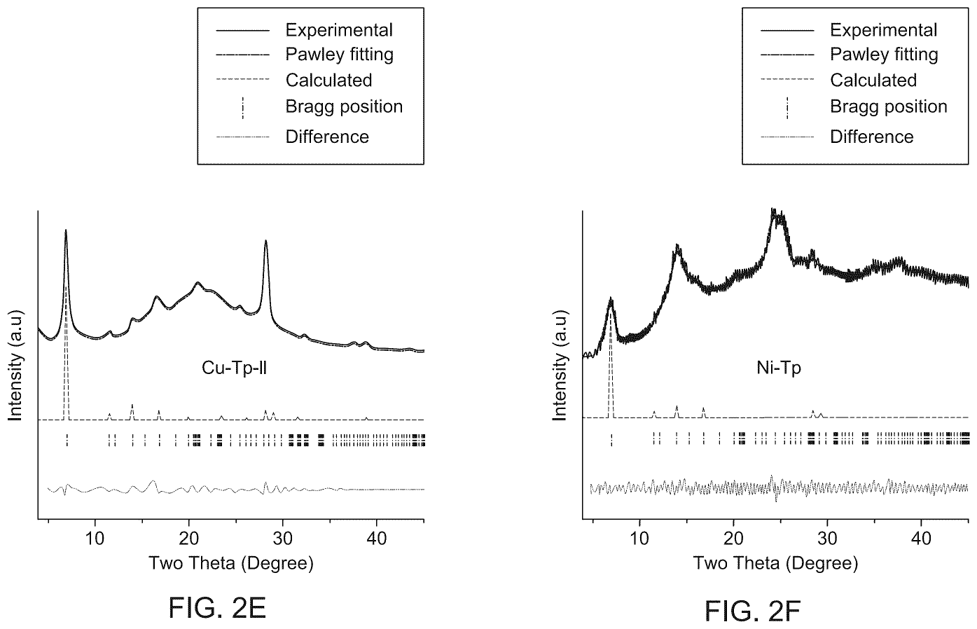

FIG. 2A shows the graphical representation of the synthesis of SA-MOFs. The precursors are mixed in solid-state in the presence of a few drops of water and thermally treated for a few hours. FIG. 2B shows the monolayer space-filling and models of Cu-Tp and Ni-Tp that show coordination interactions between the Tp and metal ions. FIG. 2C shows the simulated square planar ball and stick models of Cu-Tp and Ni-Tp. The pore size of ˜1.0 nm and an interlayer distance of 0.3 nm were observed for both MOFs. FIG. 2D-F show the experimental (black) and calculated (orange) PXRD profiles of Cu-Tp-I (FIG. 2D), Cu-Tp-II (FIG. 2E), and Ni-Tp (FIG. 2F) square-planar models, along with the Bragg positions (green), the difference between both patterns (blue) and the Pawley refinement (red).

Some embodiments of the present disclosure describe a method, wherein the composition comprises hcb layers with ABC stacking. Some embodiments of the present disclosure describe a method of synthesis of 2D/3D-c-SA MOF composition, wherein the composition maintains crystalline network at low thermal treatment. Some embodiments of the present disclosure describe a method of synthesis of 2D/3D-c-SA MOF composition, wherein the temperature for thermal treatment ranges from 25° C. to 140° C. One or more embodiments of the present disclosure describe a 2D/3D-c-SA MOF composition, wherein the composition is stable in solvents. Some embodiments of the present disclosure describe a 2D/3D-c-SA MOF composition, wherein the solvent comprises water or highly polar solvents. Highly polar solvents include, but are not limited to, dimethyl formamide (DMF), dimethyl acetamide (DMA).

Some embodiments of the present disclosure describe a method of synthesis of 2D/3D-c-SA MOF composition, wherein the composition has a pore size in the range of 0.8 to 1.3 nm. Some embodiments of the present disclosure describe a method of synthesis of 2D/3D-c-SA MOF composition, wherein the composition has a pore size in the range of 0.7 to 1.5 nm. Some embodiments of the present disclosure describe a method of synthesis of 2D/3D-c-SA MOF composition, wherein the composition has a pore size in the range of 0.8 to 1.0 nm. Some embodiments of the present disclosure describe a method of synthesis of 2D/3D-c-SA MOF composition, wherein the composition has a pore size in the range of 0.9 to 1.2 nm. Some embodiments of the present disclosure describe a method of synthesis of 2D/3D-c-SA MOF composition, wherein the composition has a pore size in the range of 0.5 to 1.5 nm. Some embodiments of the present disclosure describe a method of synthesis of 2D/3D-c-SA MOF composition, wherein the composition has an interlayer distance in the range of 0.25 to 0.35 nm. Yet other embodiments of the present disclosure describe a method of synthesis of 2D/3D-c-SA MOF composition, wherein the composition is stable at temperatures in the range of 200° C.-375° C. One or more embodiments of the present disclosure describe a method of synthesis of 2D/3D-c-SA MOF composition, wherein the composition exhibits CO₂ uptake or absorbs CO₂.

Certain embodiments of the present disclosure describe a method of synthesis of 2D/3D-c-SA MOF composition, wherein the composition is a thin film. Some embodiments of the present disclosure describe a method of synthesis of 2D/3D-c-SA MOF composition, wherein the thin film has a thickness in the range of 20 μm-35 μm. Some embodiments of the present disclosure describe a method of synthesis of 2D/3D-c-SA MOF composition, wherein the thin film has a thickness in the range of 15 μm-40 μm. Some embodiments of the present disclosure describe a method of synthesis of 2D/3D-c-SA MOF composition, wherein the thin film exhibits uniform flower petal like morphology on the entire surface. Some embodiments of the present disclosure describe a method of synthesis of 2D/3D-c-SA MOF composition, wherein the thin film exhibits semiconductive property. Some embodiments of the present disclosure describe a method of synthesis of 2D/3D-c-SA MOF composition, wherein the thin film exhibits photocatalytic reduction of CO₂. Some embodiments of the present disclosure describe a method of synthesis of 2D/3D-c-SA MOF composition, wherein the thin film exhibits photocatalytic reduction, which occurs without the use of cocatalyst or sacrificial agents. Some embodiments of the present disclosure describe a method of synthesis of 2D/3D-c-SA MOF composition, wherein the thin film exhibits photostability in the photocatalytic reduction of CO₂. Some embodiments of the present disclosure describe a method of synthesis of 2D/3D-c-SA MOF composition, wherein the thin film retains 93% photocatalytic efficiency after repeated cycles, wherein the cycle comprises a duration of 4-6 hours. Some embodiments of the present disclosure describe a method of synthesis of 2D/3D-c-SA MOF composition, wherein the thin film retains 70% to 95% photocatalytic efficiency after repeated cycles, wherein the cycle comprises a duration of 3-10 hours.

Some embodiments of the present disclosure describe a method of synthesis of 2D/3D-c-SA MOF composition, wherein the thin film is recyclable. Some embodiments of the present disclosure describe a method of synthesis of 2D/3D-c-SA MOF composition, wherein the thin film exhibits structural stability to visible light irradiation. Yet other embodiments of the present disclosure describe a method of synthesis of 2D/3D-c-SA MOF composition, wherein the composition exhibits a state between semicrystalline and porous. Some embodiments of the present disclosure describe a method of synthesis of 2D/3D-c-SA MOF composition, wherein the composition exhibits supercapacitor property. Some embodiments of the present disclosure describe a method of synthesis of 2D/3D-c-SA MOF composition, wherein the composition retains 90% of the initial capacitance until 25000 charge-discharge cycles. One or more embodiments of the present disclosure describe a method of synthesis of 2D/3D-c-SA MOF composition, wherein the composition maintains 80% of the initial capacitance even after 36000 continuous charge-discharge cycles at the current density of 5 A g⁻¹. Yet other embodiments of the present disclosure describe a method of synthesis of 2D/3D-c-SA MOF composition, wherein the composition maintains the initial capacitance in the range of 70% to 96% even after 20000 to 36000 continuous charge-discharge cycles. Notably, the coulombic efficiency was upheld at 95-96% throughout the 36000 cycles.

Certain embodiments of the present disclosure describe a method of synthesis of 2D/3D-c-SA MOF composition, wherein the composition exhibits rechargeable lithium-ion battery anode specific capacity. One or more embodiments of the present disclosure describe a 2D/3D-c-SA MOF, wherein the composition is electrically conductive. Yet other embodiments of the present disclosure describe a 2D/3D-c-SA MOF composition, wherein the composition is suitable for electrocatalytic conversion reactions.

### EXAMPLES

### Example 1: Synthesis of 2D/3D-c-SA MOF

Synthesis of Cu-Tp-I: The Cu-Tp-I was synthesized through mechanochemical reaction using a mortar and pestle. The Tp linker (0.15 mmol) was directly added into the 1.5 equivalent of Cu(NO₃)₂.3H₂O (0.225 mmol) and mechano-mixed thoroughly into a solid paste form. A drop of DI water (˜50 μL) was added to the solid mixture for uniform mixing and the mixture was subsequently heated at 90° C. in a closed container for 5 hours. The resulting solid powder was washed with N, N-dimethylacetamide (DMA), tetrahydrofuran (THF), water, and acetone to obtain Cu-Tp-I as a green color powder.

Synthesis of Cu-Tp-II: The synthetic procedure was the same as above, except that CuCl₂.2H₂O was used instead of Cu(NO₃)₂.3H₂O.

Synthesis of Cu-Pg-I and Cu-Pg-II: The Cu-Pg-I and Cu-Pg-II were synthesized through mechanochemical reactions using a mortar and pestle. The Pg linker (0.15 mmol) was directly added into the 1.5 equivalent of Cu(NO₃)₂.3H₂O or CuC₂.2H₂O (0.225 mmol) and thoroughly mechano-mixed into a solid paste form. A drop of DI water (˜50 μL) was added to the solid mixture for uniform mixing and the mixture was subsequently heated at 90° C. in a closed container for 5 hours. The resulting materials were obtained as dark color brown products.

Synthesis of Cu-Ht-I and Cu-Ht-II: The Cu-Ht-I and Cu-Ht-II were synthesized through mechanochemical reactions using a mortar and pestle. The Ht linker (0.15 mmol) was directly added into the 1.5 equivalent of Cu(NO₃)₂.3H₂O or CuC₂.2H₂O (0.225 mmol) and mechano-mixed thoroughly into a solid paste form. Next, a drop of DI water (˜50 μL) was added to the solid mixture for uniform mixing and the mixture was subsequently heated at 90° C. in a closed container for 5 hours. The resulting Cu-Ht-I and Cu-Ht-II were obtained as bright and pale green color products respectively.

Synthesis of Cu-Tfpa: The Cu-Tfpa was synthesized through mechanochemical reactions by using a mortar and pestle. The Tfpa linker (0.15 mmol) was directly added into the 1.5 equivalent of Cu(NO₃)₂.3H₂O (0.225 mmol) and mechano-mixed thoroughly into a solid paste form. A drop of DI water (˜50 μL) was added to the solid mixture for uniform mixing and the mixture was subsequently heated at 90° C. in a closed container for 5 hours. The resulting Cu-Tfpa was obtained as a pale green color product.

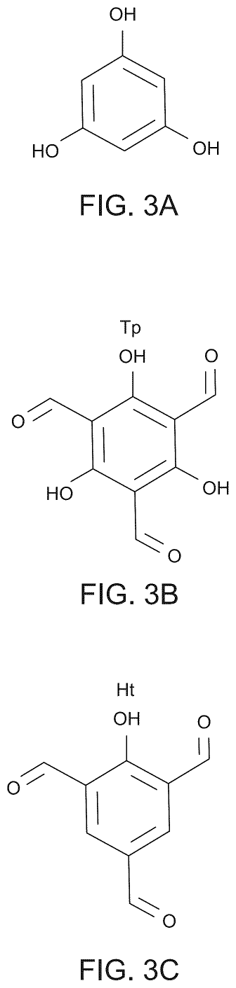

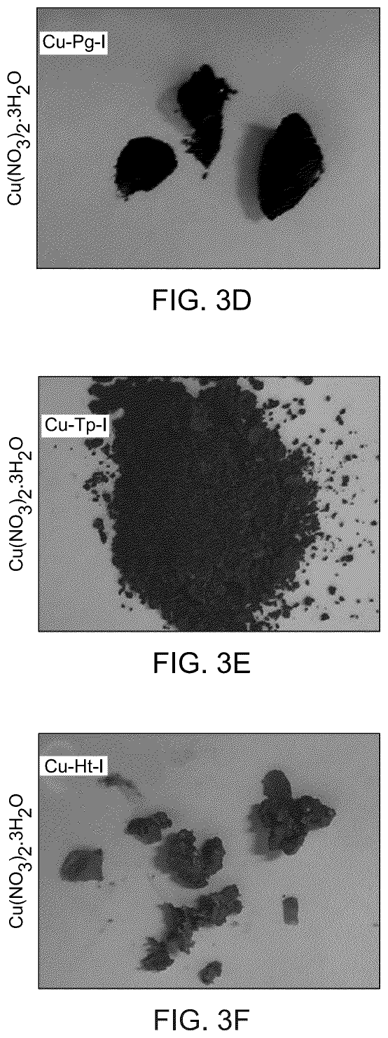

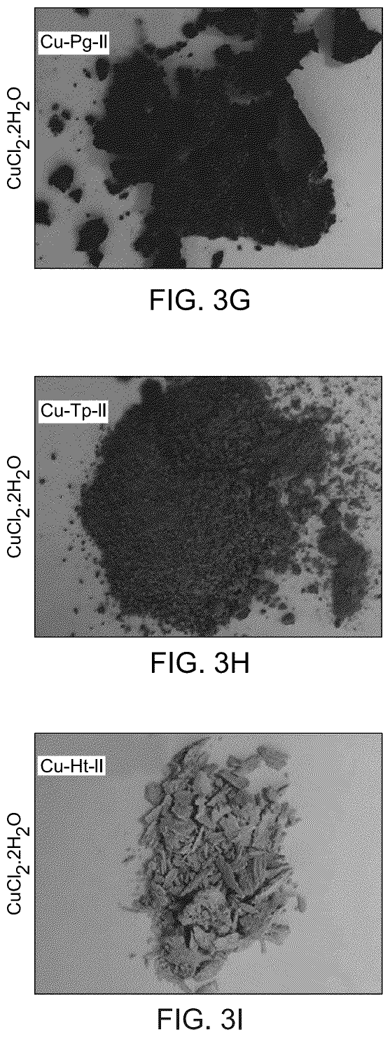

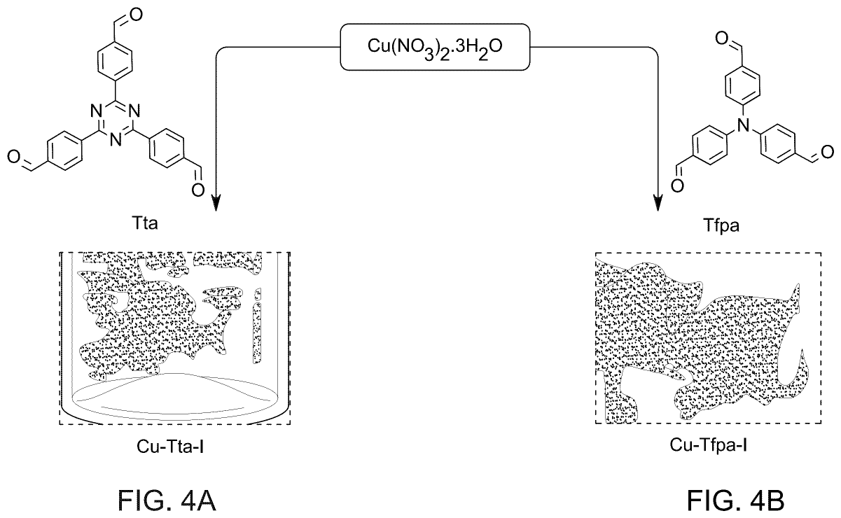

Synthesis of Cu-Tta: The Cu-Tta was synthesized through mechanochemical reactions by using a mortar and pestle. The Tta linker (0.15 mmol) was directly added into the 1.5 equivalent of Cu(NO₃)₂.3H₂O (0.225 mmol) and mechano-mixed thoroughly into a solid paste form. Next, a drop of DI water (˜50 μL) was added to the solid mixture for uniform mixing and the mixture was subsequently heated at 90° C. in a closed container for 5 hours. The resulting Cu-Tta was obtained as a pale green color product. FIG. 3A-FIG. 31 show digital photographs of the products obtained from the functional group (—OH and HC═O) controlled building blocks with copper salts. FIG. 3A shows the functional group for the organic linker Pg. FIG. 3B shows the functional group for the organic linker Tp. FIG. 3C shows the functional group for the organic linker Ht. FIG. 3D shows the product obtained for Cu-Pg-I. FIG. 3E shows the product obtained for Cu-Tp-I. FIG. 3F shows the product obtained for Cu-Ht-I. FIG. 3G shows the product obtained for Cu-Pg-II. FIG. 3H shows the product obtained for Cu-Tp-II. FIG. 3I shows the product obtained for Cu-Ht-II. FIG. 4A-FIG. 4B show digital photographs of the products obtained from building blocks with only aldehydes. FIG. 4A shows the product obtained for Cu-Tta-I. FIG. 4B shows the product obtained for Cu-Tfpa-I. TABLE 1 shows the crystal structure models of copper-based SA-MOFs.

TABLE 1
Summary of the crystal structure models of copper-based SA-MOF

| | | | |
|---|---|---|---|
| Metal element | Copper | Copper | Copper |
| Coordination | Square-planar | Tetrahedral | Octahedral |
| environment | | | |
| a (Å) | 14.540 | 13.869 | 14.583 |
| b (Å) | 14.540 | 13.869 | 14.583 |
| c (Å) | 9.477 | 8.827 | 7.134 |
| α (⁰) | 90 | 90 | 90 |
| B (⁰) | 90 | 90 | 90 |
| γ (⁰) | 120 | 120 | 120 |
| Volume (Å³) | 1735.15 | 1470.35 | 1314.05 |
| Density (g/cm³) | 1.737 | 2.049 | 1.665 |
| Space group | P3₁ | P3₁ | P-3c1 |
| Cell Formula | C₅₄H₁₈O₃₆Cu₉ | C₅₄H₁₈O₃₆Cu₉ | C₃₆H₂₄O₃₀Cu₆ |

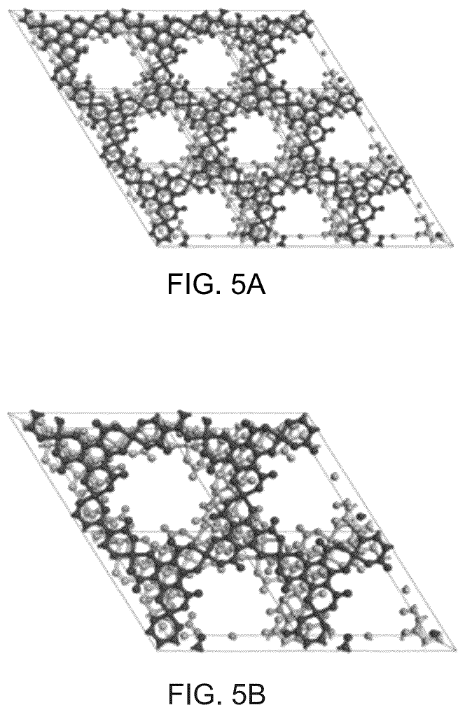

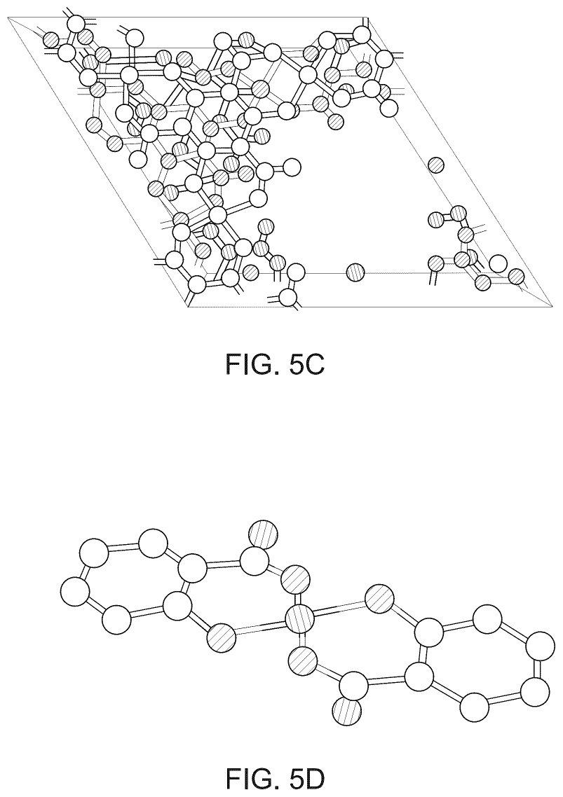

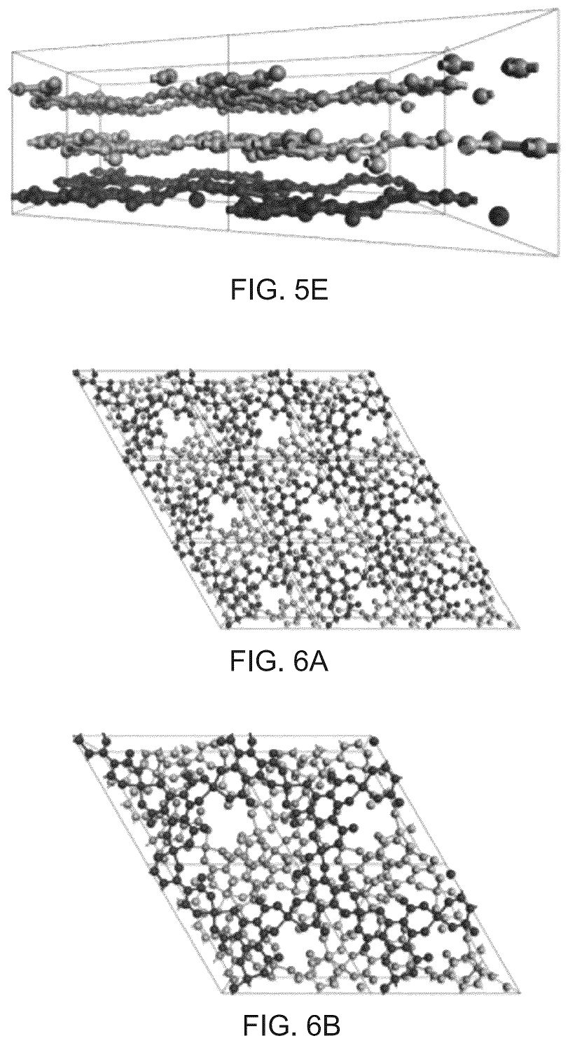

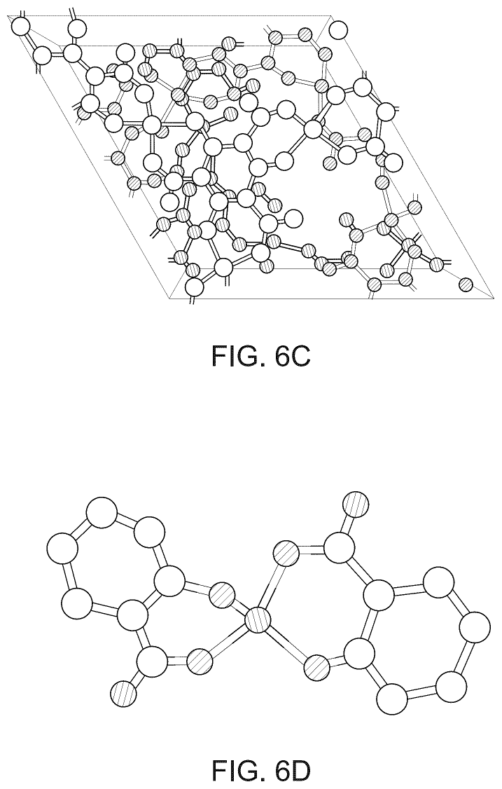

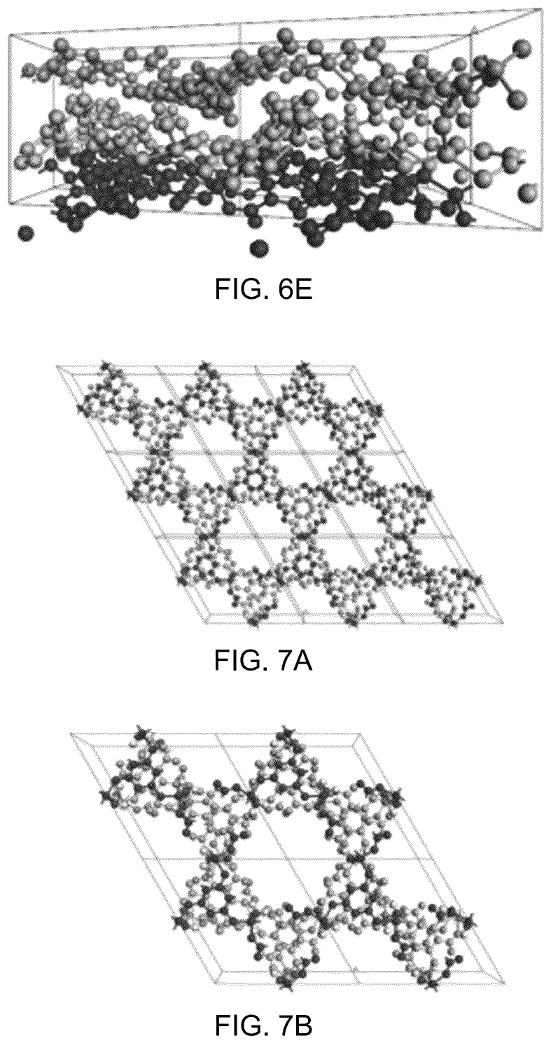

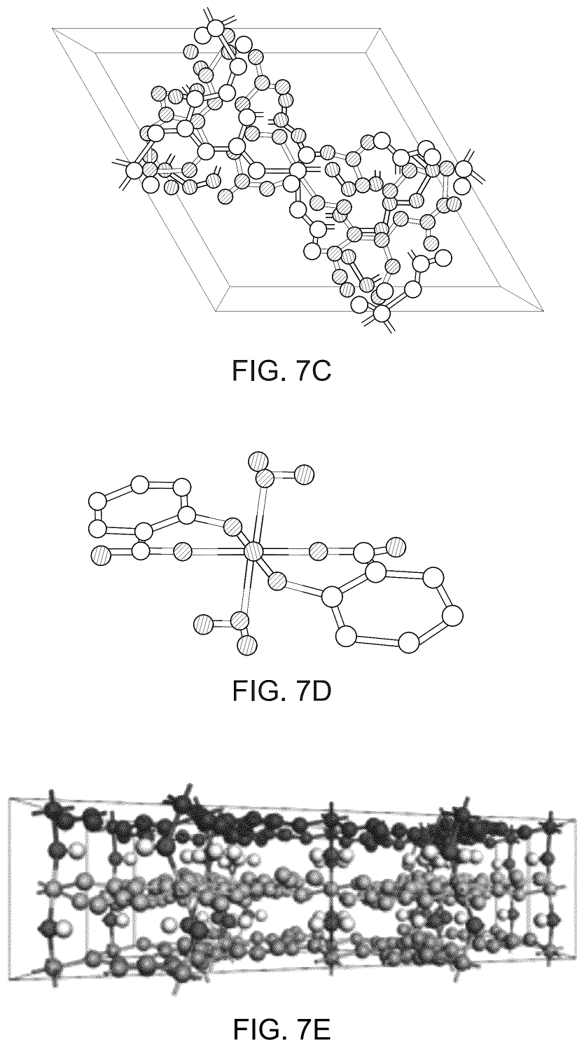

FIG. 5A-FIG. 5E show the crystal structure model of Cu-Tp-MOF, with square planar coordination environment of copper atoms. FIG. 5A shows Nine-unit cells viewed along the z-axis; FIG. 5B shows four-unit cells; FIG. 5C shows One-unit cell; FIG. 5D shows the Square-planar conformation of the copper atom; and FIG. 5E shows the view along the y-axis. FIG. 6A-FIG. 6E show the crystal structure model of Cu-Tp-MOF, with Tetrahedral coordination environment of copper atoms. FIG. 6A shows Nine-unit cells viewed along the z-axis; FIG. 6B shows Four-unit cells; FIG. 6C shows One-unit cell; FIG. 6D shows the Tetrahedral conformation of the copper atom; and FIG. 6E shows the view along the y-axis. FIG. 7A-FIG. 7E shows the crystal structure model of Cu-Tp-MOF with copper atoms in octahedral coordination environment, including two coordinated water molecules in the apical positions. FIG. 7A shows Nine-unit cells viewed along the z-axis; FIG. 7B shows Four-unit cells; FIG. 7C shows One-unit cell; FIG. 7D shows the Octahedral conformation of the copper atom; and FIG. 7E shows the view along the y-axis.

The mechano-mixed SA-MOFs are yielded as fine nanocrystalline powders. The powder X-ray diffraction (PXRD) analysis was performed to study the structural periodicity of SA-MOFs. Interestingly, all as-synthesized SA-MOFs showed crystallinity in their respective PXRD profiles. The Cu-Tp-I (FIG. 2D) displayed major peaks at two theta ˜7.5°, ˜14.6°, ˜16.2°, ˜21.3°, and ˜28.6°. Similarly, Cu-Tp-II (FIG. 2E) showed the PXRD profile with two theta at ˜7.1°, ˜14.0°, ˜16.6°, ˜21.1°, and ˜28.2°. On the other hand, the diffraction peaks of Ni-Tp (FIG. 2F) originated at two theta ˜7.0°, ˜14.2°, ˜20.3°, ˜25.2°, and ˜28.5°. The overall similar PXRD profiles of Cu-Tp-I, Cu-Tp-II, and Ni-Tp indicate the formation of isostructural compounds, suggesting that the metal centers have a similar coordination environment. In order to understand the possible structures of SA-MOFs, crystal models were simulated using Material Studio software. The Cu-Tp MOF was modelled in the P3₁ space group, with lattice parameters a=b=14.54 Å and c=9.48 Å (FIG. 2B), assuming a possible square planar hybridization of Cu^{2 +} atoms in coordination with two salicylaldehyde groups, which results in the formation of hcb layers with ABC stacking. In the optimized structures, the layers are not fully eclipsed; instead, they are slightly displaced one from each other to align the copper atoms with aldehyde oxygen atoms from adjacent layers. The linker phenyl rings are stacked with parallel displaced □-□ interactions (3.2 Å centroid to carbon). The corresponding simulated PXRD pattern shows a good match with the experimental profile observed for Cu-Tp-I and Cu-Tp-II (FIG. 2D, FIG. 2E, and FIG. 5A-FIG. 7E). Similarly, an equivalent model was optimized with square planar Ni²⁺ atoms at the metal position in the P3₁ space group (a=b=14.55 Å and c=9.37 Å). The excellent agreement between simulated and experimental PXRD patterns of Ni-Tp indicates the formation of the 2D conjugated framework.

### Example 2: Synthesis of Cu-Tp-Film

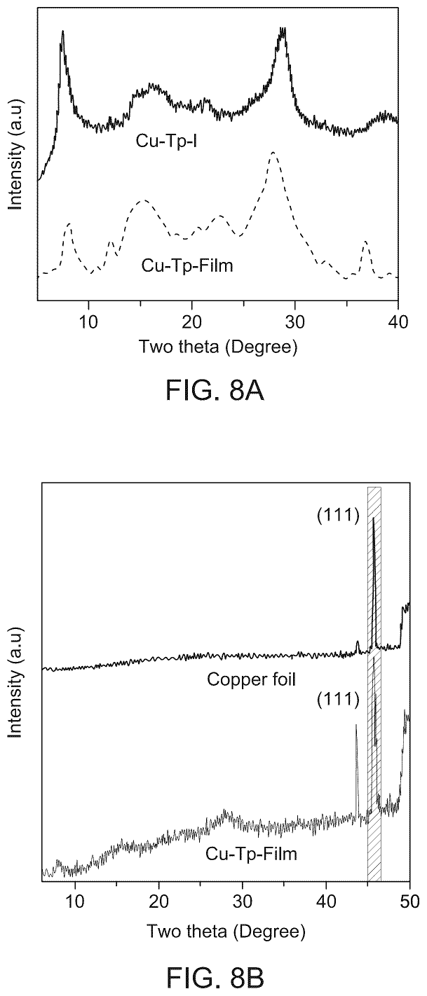

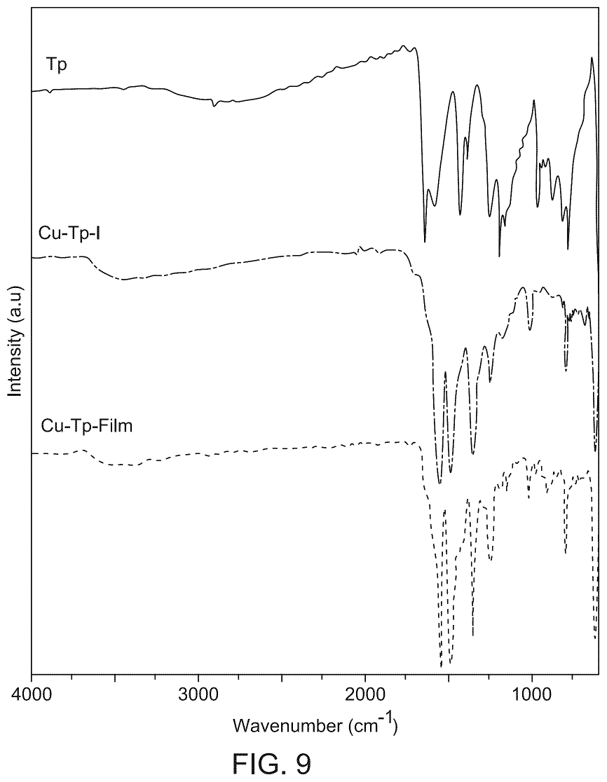

The Cu-Tp-Film was fabricated by a salt-free insitu growth of Cu-Tp MOF on the surface of a copper foil. The Tp linker (20 mg) was dissolved in 5 ml of DMA solvent, and copper foil (1×1 cm) was placed on the bottom of the reaction container. The reaction was kept for 72 hours, and the solution was decanted using a dropper. A uniform green color film was observed on the copper foil surface after air-drying the foil for 24 hours. FIG. 8A shows the PXRD profile of Cu-Tp-Film and Cu-Tp-I. FIG. 8B shows the PXRD profile of Cu-Tp-Film and blank copper foil. FIG. 9 shows the comparison of FT-IR spectra of Cu-Tp-Film with Tp and Cu-Tp-I.

### Example 3: Synthesis of 3D MOF of Fe-Tp

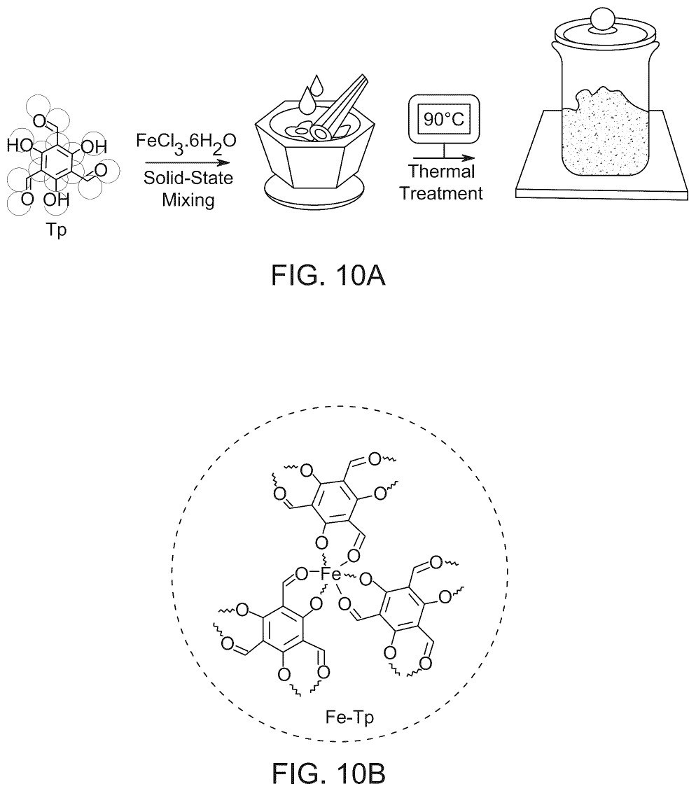

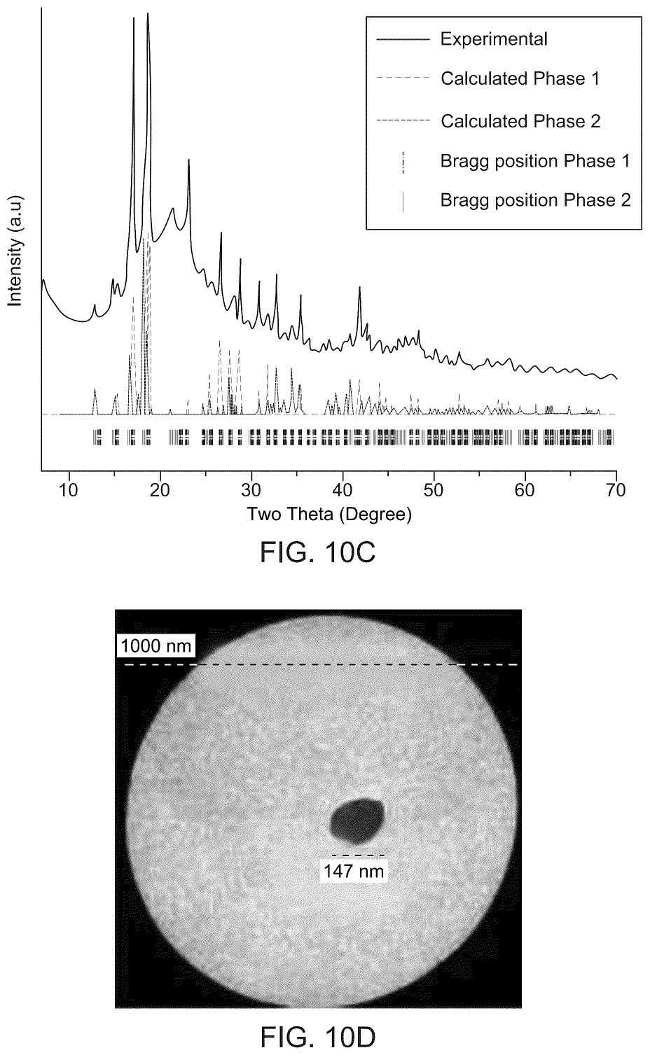

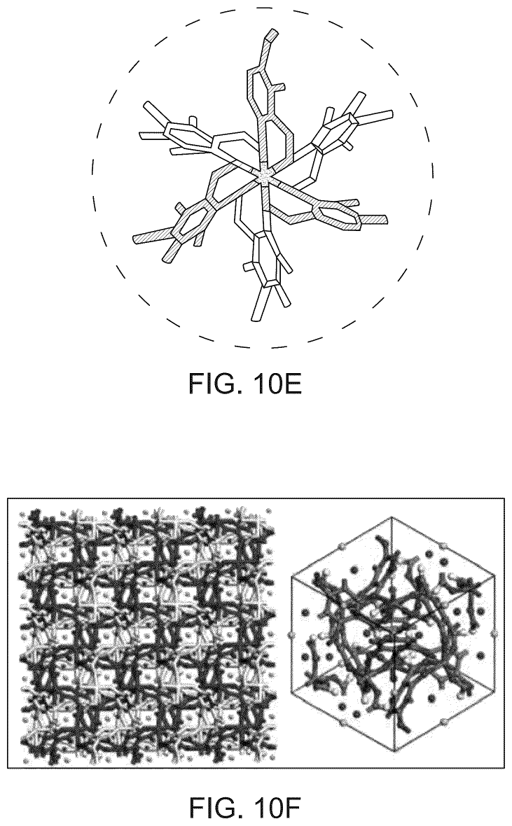

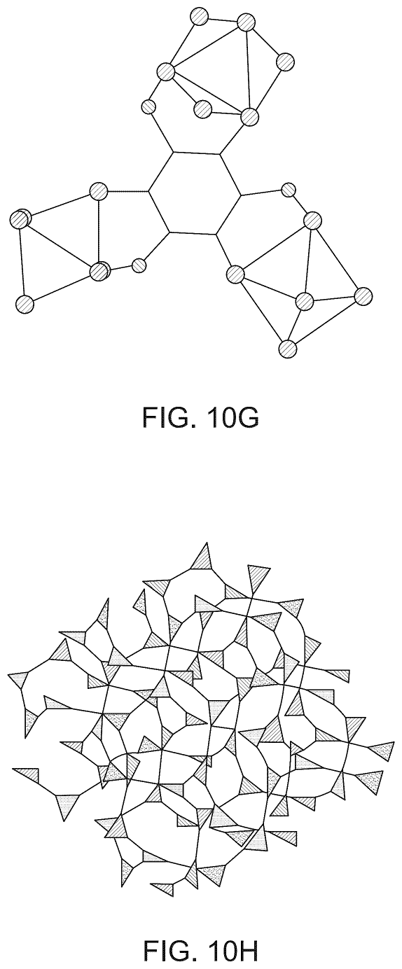

Synthesis of 3D MOF of Fe-Tp: The Fe-Tp MOF was synthesized through mechanochemical reactions without any catalyst or solvents. The Tp (0.15 mmol) linker was directly added to FeCl3·6H2O (0.15 mmol) in a granite mortar and then ground thoroughly into a solid paste form. The mixture was taken in a closed container and subsequently heated at 90° C. for 24 hours. The resulting solid was washed with N, N-dimethylacetamide (DMA), water, and acetone to remove monomer impurities. Finally, the 3D MOF of Fe-Tp was obtained as a dark red-brown color powder. FIG. 10A shows the graphical representation of the synthesis of Fe-Tp. The precursors are mixed in solid-state and thermally treated for 24 hours. FIG. 10B shows the Chem Draw image of Fe-Tp. FIG. 10C show the Experimental (blue) and calculated (phase 1—black and phase 2—red) PXRD profiles of Fe-Tp along with the difference between them (green). FIG. 10D shows the TEM image of a single crystal (size ˜142 nm) of Fe-Tp. FIG. 10E shows the octahedral coordination of Fe with Tp linker. It showed two independent framework fragments from the 3D model of Fe-Tp. The phenyl groups (in blue and white colors) arranged in an independent framework with iron atoms (in red color), are shown in a dotted circle. FIG. 10F shows the theoretical stick model (3D) of Fe-Tp. The Fe-Tp consist of two crystalline phases (Biphasic) with different unit cell length (a=11.61 Å and 11.92 Å). The independent doubly interpenetrated frameworks are shown in white and red colors. FIG. 10G shows the polyhedral model of the octahedral coordination of Fe (Blue) with Tp (Yellow) [Carbon—black, and Oxygen—red]. FIG. 10H shows the simplified representation of the topology of Fe-Tp (srs-c-a). The inorganic building blocks are shown as blue trigonal and organic linkers are represented as yellow trigonals.

The powder X-ray diffraction (PXRD) analysis demonstrated the crystalline nature of the sample (FIG. 10C). Due to the impossibility to obtain crystals suitable for single-crystal X-ray diffraction with the mechanochemical synthetic approach employed, the structure elucidation process was completed by combining 3D electron diffraction and PXRD data analysis along with computer modeling (FIG. 10D). Electron diffraction measurements collected with several nanocrystals of 140-150 nm size were indicative of the formation of a crystalline phase with cubic symmetry. However, differences were noted in the lattice parameters between the measured crystals, consistently finding two unit-cell axes values of 11.98(6) and 12.292(6) Å, respectively. Accordingly, crystal models were constructed using Materials Studio software, and simulated the PXRD patterns of the optimized structures. Thus, the experimental PXRD pattern can be indexed by considering the presence of two cubic phases with Pa3-symmetry, and lattice parameters a=11.61(1) and a=11.92(3) Å (TABLE 2). These values compare reasonably well to those found by electron diffraction with a reasonable difference of ˜0.4 Å due to the lower accuracy of unit cell determination by electron diffraction. The optimized structures consist of two interpenetrated frameworks (white and red color frameworks in FIG. 10F) with srs topology (FIG. 10E, FIG.10G and FIG.10H), similar to related metal-catecholate frameworks, where the iron atoms are octahedrally coordinated by three Tp linkers, and with presence of guest species corresponding to chlorine atoms and water molecules in the pores. The appearance of crystals with two different lattice parameters is attributed to the different amount of guest species, such as the chlorine atoms and water molecules, which were probably trapped during the MOF crystallization, and could not be completely removed during the washing due to the ultra-microporous nature of Fe-Tp. MOFs with flexible behavior with variation in unit cell volumes are not uncommon, and many examples have been previously observed. Alternatively, the presence of linkers by orientational disorder might be the origin of differently strained unit cells, resulting in the emergence of two sets of crystals with slightly yet distinctively different lattice parameters. Moreover, alternative crystal structures based on the formation of tri-connected networks such as non-interpenetrated srs, or two-periodic hcb layers were ruled out based on the discrepancies between their calculated PXRD patterns and the experimental one.

TABLE 2
STRUCTURE DETAILS OF Fe-Tp

| | Phase 1 | Phase 2 |
|---|---|---|
| Crystal system | Cubic | Cubic |
| Space Group | Pa3̅ | Pa3̅ |
| a (Å) | 11.611(1) | 11.912(1) |
| Cell Volume (Å³) | 1565.34 | 1690.26 |
| Atom sites | O1, 0.16531, 0.23037, | O1, 0.25489, 0.30852, |
| (name, x, y, z) | 0.58472 | 0.56802 |
| | O2, −0.03983, 0.34935, | O2, 0.04540, 0.33874, |
| | 0.56925 | 0.48347 |
| | C3, 0.55912, 0.69842, | C3, 0.53674, 0.69551, |
| | 0.71511 | 0.66567 |
| | C4, 0.88595, 0.40305, | C4, 0.93224, 0.40315, |
| | 0.25317 | 0.22478 |
| | C5, 0.75814, 0.79625, | C5, 0.78105, 0.47489, |
| | 0.48211 | 0.53849 |
| | O7, 0.92543, 0.11562, | O6, 0.12918, 0.86133, |
| | 0.40527 | 0.69371 |
| | Fe8, 0.88248, 0.88248, | Fe7, 0.88328, 0.88328, |
| | 0.88248 | 0.88328 |
| | Cl9, 0.50000, 0.50000, | Cl8, 0.50000, 0.50000, |
| | 0.50000 | 0.50000 |

### Example 4: Structural Analysis of 2D and 3D MOFs

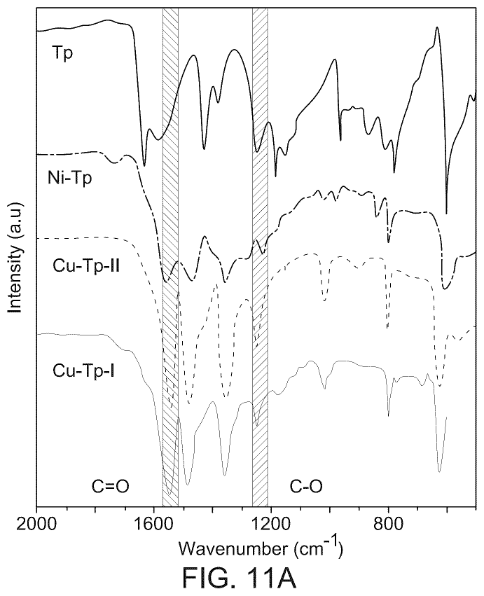

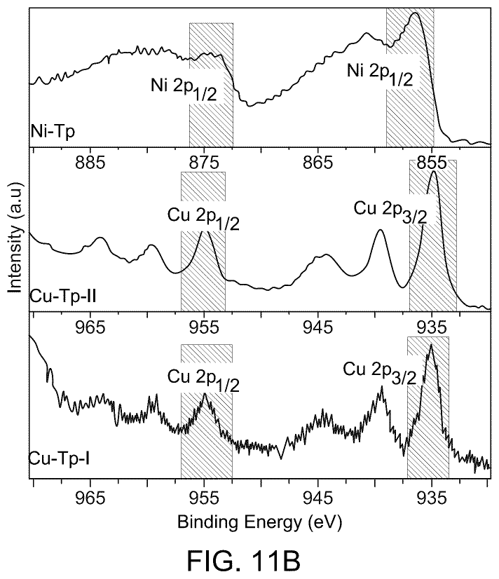

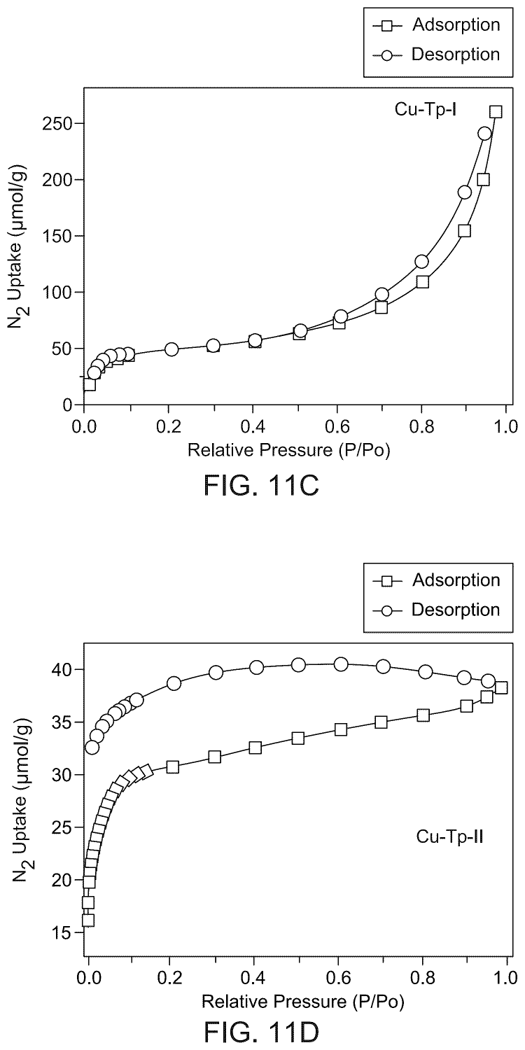

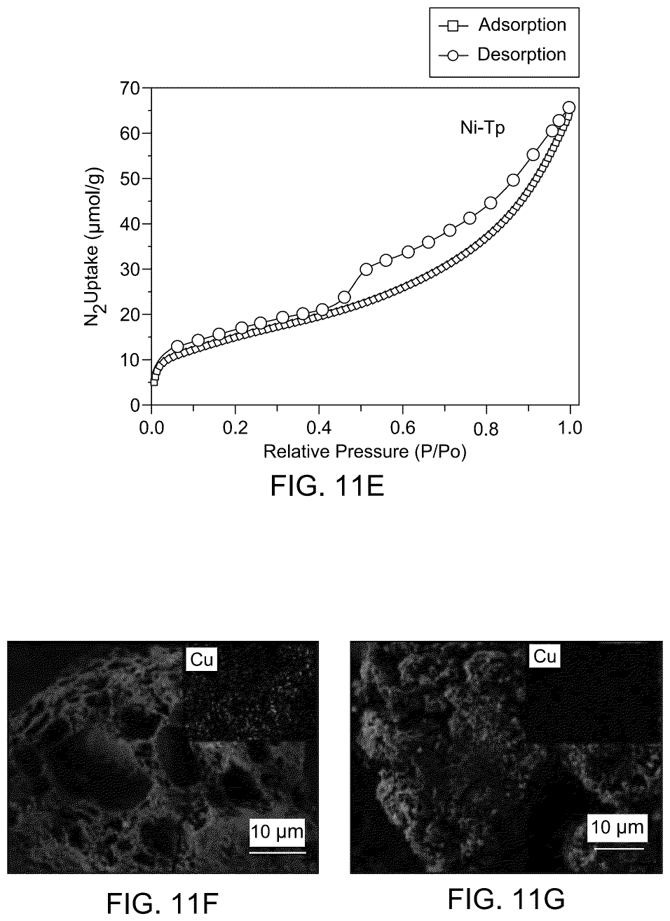

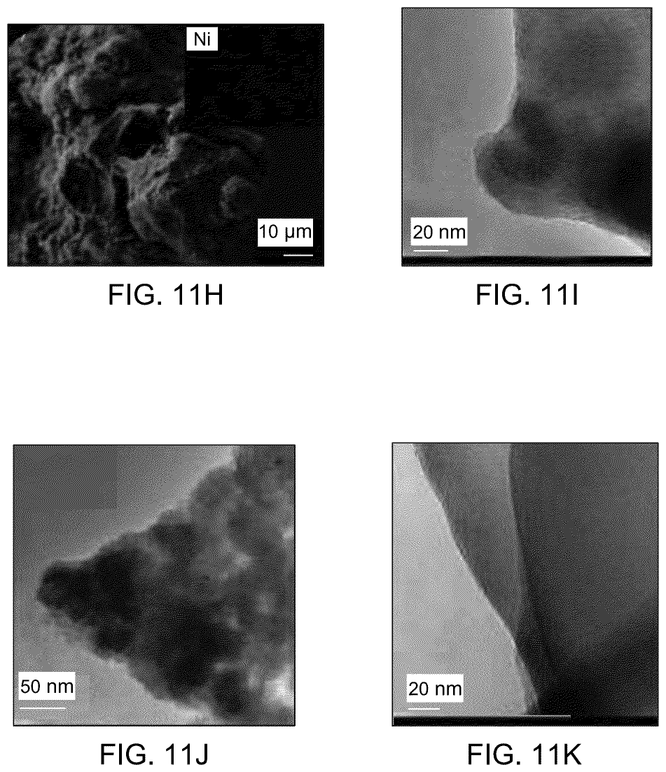

FIG. 11A shows the FTIR profiles of SA-MOFs with Tp linker. FIG. 11B shows the XPS profiles of SA-MOFs show the metal ions chemical states (Cu²⁺ and Ni²⁺) in the MOFs. FIG. 11C-FIG. 11E show the N₂ gas adsorption isotherms of Cu-Tp-I, Cu-Tp-II, and Ni-Tp and their corresponding BET surface areas are 167, 105, and 109 m² g⁻¹, respectively. FIG. 11F-FIG. 11H show the SEM images of Cu-Tp-I (FIG. 11F), Cu-Tp-II (FIG. 11G) and Ni-Tp (FIG. 11H). Inset: EDX images show the metal distribution within the MOFs. FIG. 111-FIG. 11K show the TEM images of Cu-Tp-I (FIG. 111), Cu-Tp-II (FIG. 11J) and Ni-Tp (FIG. 11K). The FTIR spectrum further revealed SA-MOFs chemical bonding details (FIG. 11A). Notably, the —C═O stretching peak for Tp is shifted from 1619 cm⁻¹ to 1550-1560 cm⁻¹ for all SA-MOFs. The significant shift could be due to the coordinative interaction of metal ion with —C═O that results in partial breaking of the double bond and consequently decreases the vibrational energy between carbon and oxygen.

Notably, the PXRD profiles of all SA-MOFs suggested the formation of crystalline networks even at low thermal treatment (60° C.) for five hours. However, there was no framework formation when the reaction was performed at room temperature (25° C.), which signifies the role of activation energy for the desired MOF formation. Furthermore, the solid-state synthesis of Cu-Tp-I was performed with varying equivalencies of Cu2⁺ ions (0.5 to 4.5 eq. Cu2⁺: 1 Tp). The FTIR (Fourier transform infrared) profiles of resulting c-MOFs showed similar chemical bonding features. In contrast, the PXRD profiles suggest that the 1.5 eq Cu2⁺ ratio best matches the modeled structure. Moreover, the PXRD and FTIR spectra of thermally treated Cu(NO3)2.3H2O salt do not match with the Cu-Tp-I, which indicates the purity of Cu-Tp-I. All SA-MOFs exhibit excellent chemical and structural stability in solvents.

The characteristic PXRD and FTIR features of SA-MOFs were retained after 72 hours of treatment in water or highly polar DMA, which indicates that the coordinative interaction of metal ions with Tp is strong enough to resist the solvation. Furthermore, control studies were carried out to understand the role of salicylaldehyde functional pocket in SA-MOFs. After the solid-state reaction with Cu²⁺ salts, the C₃ symmetric hydroxyl functionalized phloroglucinol (Pg) yielded a brownish-black color product, whereas triformyl benzene core with one —OH group (2-hydroxytriformylbenzene; Ht) resulted in a greenish color product. However, all these products were solubilized in water or DMA solvents, suggesting the weak interaction of Cu²⁺ ions with these organic linkers, and ruling out the formation of extended structures. In addition, to test the coordination of Cu²⁺ ions solely with formyl (H—C═O) groups, C₃ symmetric tris(4-formylphenyl) amine (Tfpa) and 1, 3, 5-triazine-2,4,6-triyl)tribenzaldehyde (Tta) were subjected for the similar mechanochemical mixing with metal salts. Although the color of the mixture changed from blue to green during the mechano-mixing and thermal treatment, the resulting material showed poor chemical stability in water with immediate solvation.

The PXRD and FTIR profiles of these as-synthesized organic core and metal mixture did not show any indication of the formation of ordered crystalline frameworks. Taking together these functional groups-controlled experiments prove the significant role of symmetric ortho —OH and —HC═O groups in forming stable MOFs. The chemical states of elements in SA-MOFs were evident in the X-ray photoelectron spectroscopy (XPS) analysis (FIG. 11B). Cu-Tp-I showed prominent Cu 2p_{3/2} and Cu 2p_{1/2} peaks at 934.87 and 955.07 eV. The strong satellite peaks at 939.3 and 959.3 eV indicate the +2 oxidation state of Cu in the framework. Similarly, the Cu-Tp-II showed the evidentiary presence of Cu²⁺ in the framework with Cu 2p_{3/2} (934.93 eV) and Cu 2p_{1/2} (954.80 eV) with satellite peaks. The XPS profile of Ni-Tp showed two significant peaks corresponding to Ni 2p_{3/2} (856.42 eV) and Ni 2p_{1/2} (874.36 Ev) with corresponding weak satellite peaks. The higher binding energy of nickel indicates its +2 oxidation state.

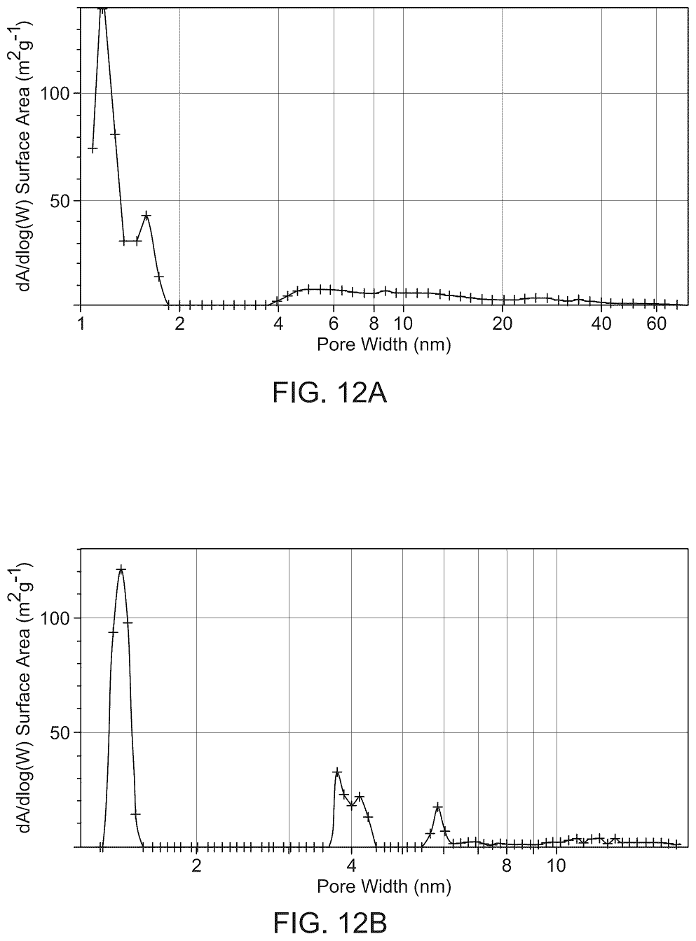

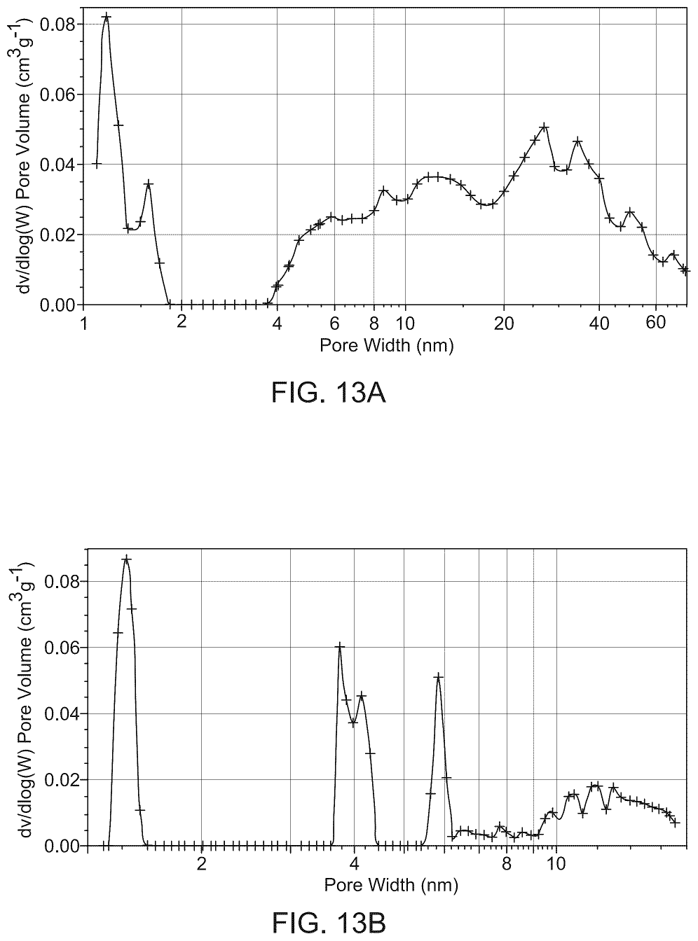

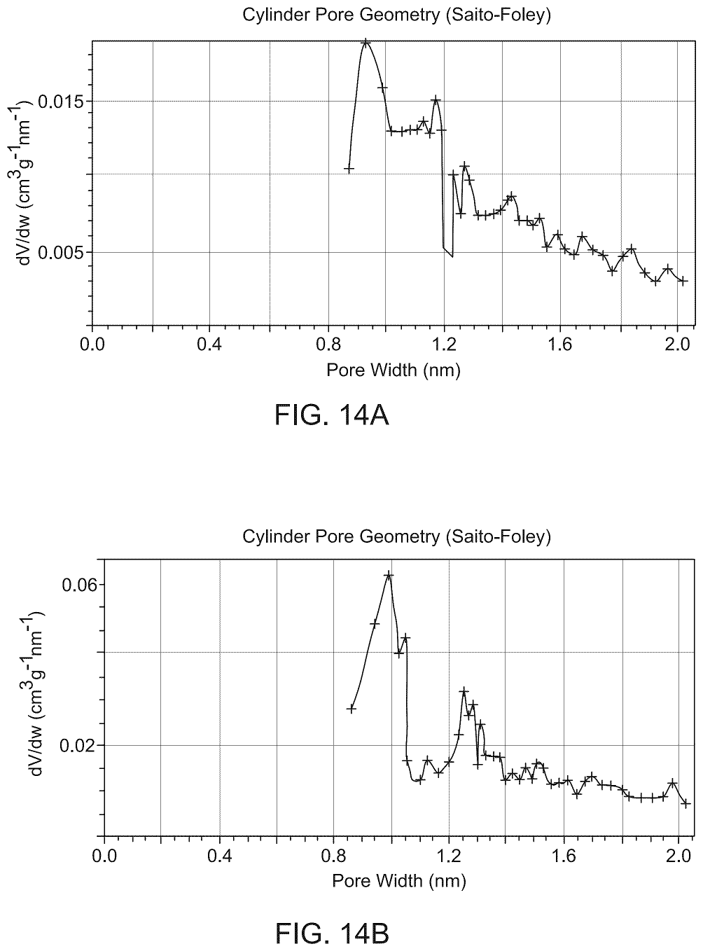

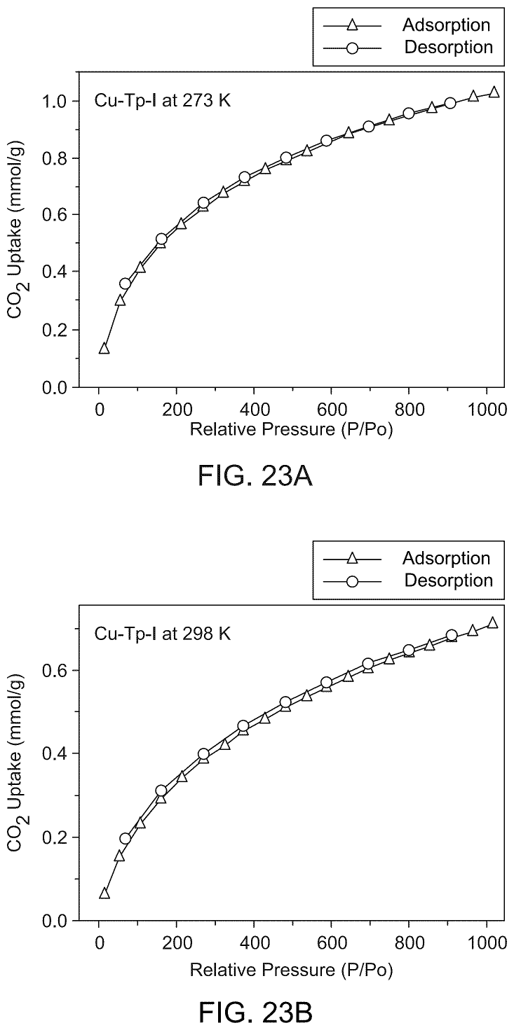

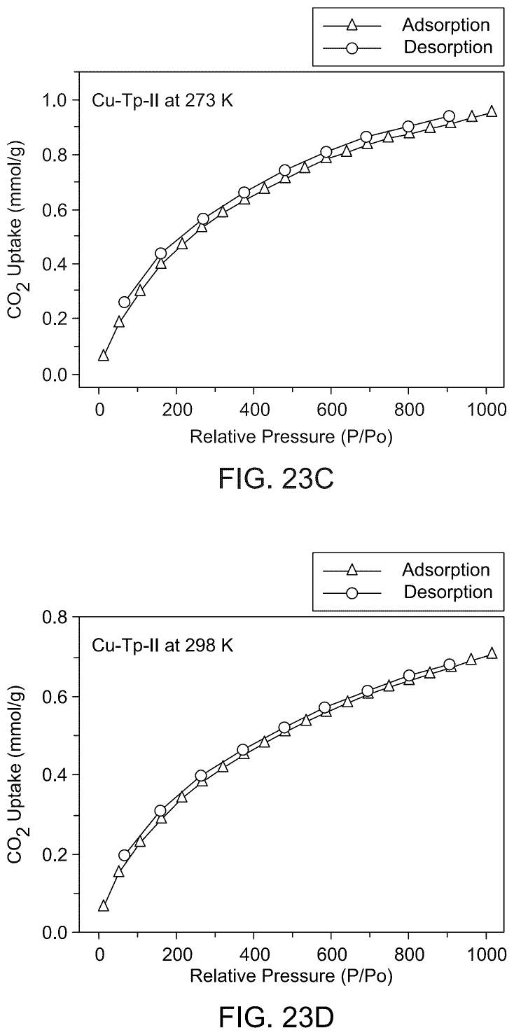

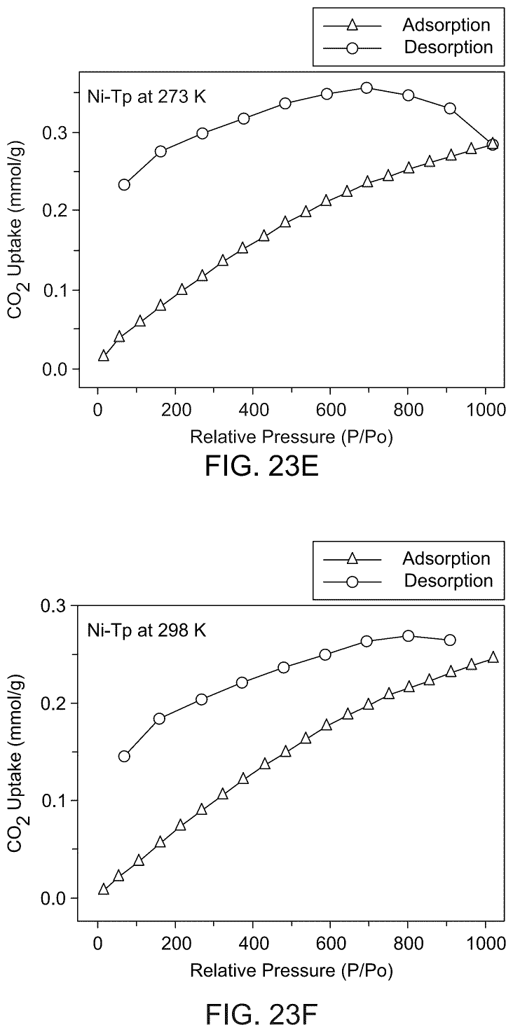

The porosity features of SA-MOFs were analyzed by N₂ gas adsorption isotherm at 77 K (FIG. 11C-FIG. 11E). Cu-Tp-I and Cu-Tp-II showed the BET surface areas of 167 and 105 m² g⁻¹, respectively. The sharp non-local density functional theory (NLDFT) pore size distribution (FIG. 12A, FIG. 12B, FIG. 13A and FIG. 13B) and Horvath-Kawazoe microporous distribution (FIG. 14A and FIG. 14B) of SA-MOFs revealed the inherent microporous nature (˜1.1 nm) of the material. The obtained pore size is consistent with the proposed crystal structure of Cu-Tp MOF. Meanwhile, the Ni-Tp exhibited a BET surface area of 109 m² g⁻¹. NLDFT pore size distribution of Ni-Tp showed a pore size around 1.1 nm. Again SA-MOFs were analyzed for the CO₂ gas uptake at 273 K and 298 K (FIG. 23A-FIG. 23F). Both Cu-Tp MOFs showed higher CO2 uptake compared to Ni-Tp. The Cu-Tp-I and Cu-Tp-II adsorbed 1020 and 955 μmol g⁻¹ at 273 K and 1 bar. Moreover, Ni-Tp adsorbed only 355 μmol g⁻¹ at 273 K and 1 bar. In addition, Cu-Tp-I, Cu-Tp-II, and Ni-Tp showed CO₂ uptake of 706, 636, and 245 μmol g⁻¹, respectively, at 298 K and 1 bar. The scanning electron microscopy (SEM) displayed macroporous surface features of SA-MOFs. The elemental mapping of these MOFs shows uniform distribution of carbon, oxygen, and respective metal elements (FIG. 11F-FIG. 11H; inset). The transmission electron microscopy (TEM) revealed the 2D sheet-like morphology for all SA-MOFs on a nanoscopic scale (FIG. 111-FIG. 11K).

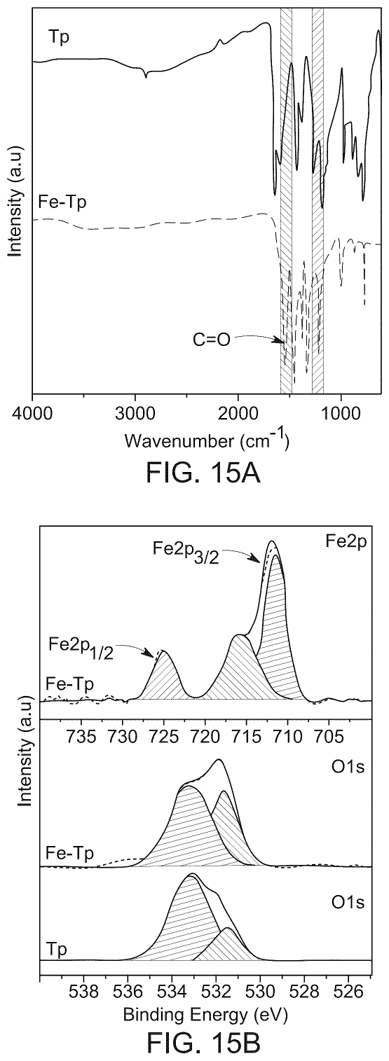

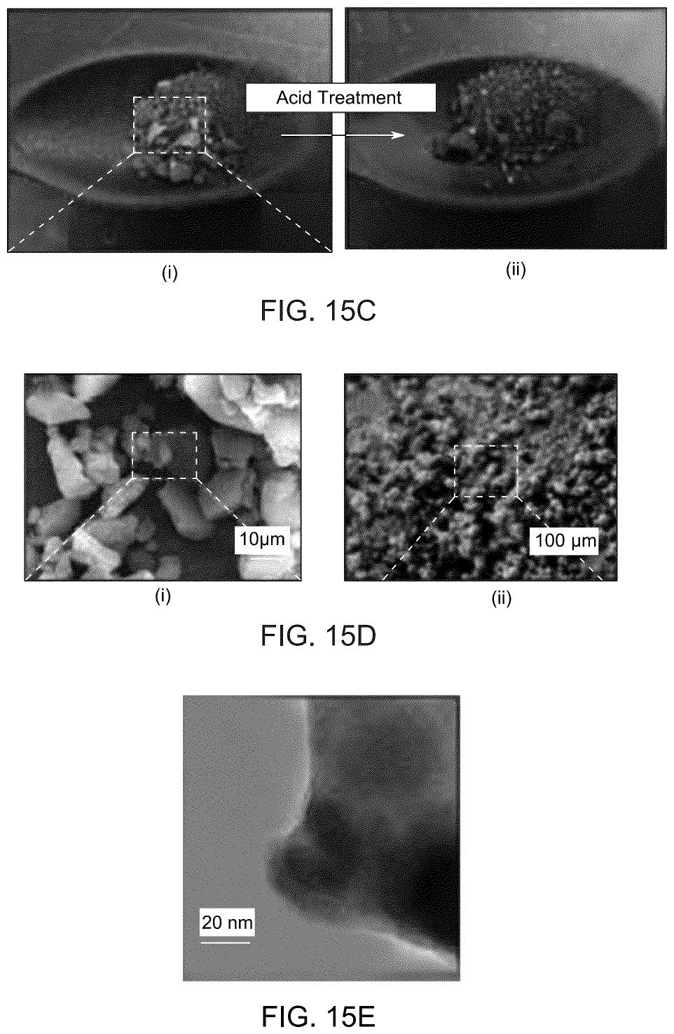

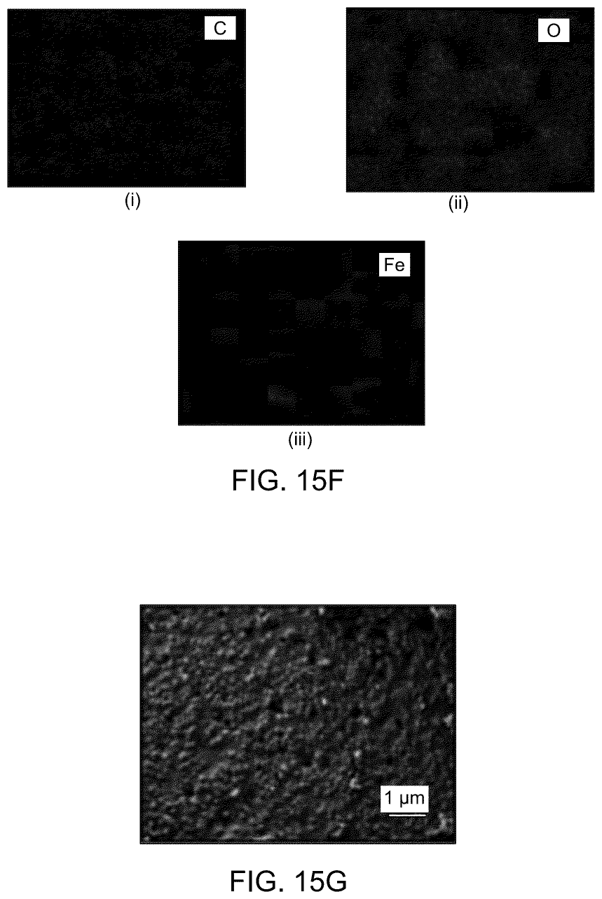

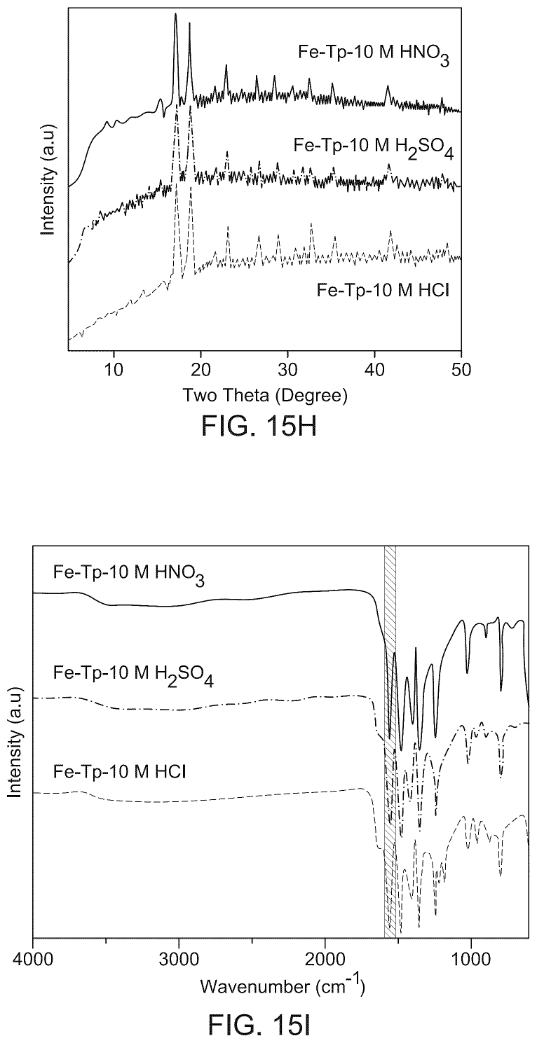

FIG. 15A shows the FTIR profiles of Fe-Tp and Tp linker. In FIG. 15B, the XPS profiles of Fe-Tp show the chemical states of iron and oxygen. FIG. 15C(i) and FIG. 15C(ii) show the digital photographs of Fe-Tp before (FIG. 15C(i)) and after (FIG. 15C(ii)) acid treatment. FIG. 15D(i) and FIG. 15D(ii) show the SEM images of Fe-Tp monoliths (FIG. 15D(i)) which are composed of microspheres (FIG. 15 D(ii)) (200-500 nm). FIG. 15E shows the TEM image of Fe-Tp. FIG. 15F(i)-FIG. 15F(iii) show the SEM elemental mapping of Fe-Tp (Carbon (grey), FIG. 15F(i); Oxygen (red), FIG. 15F(ii); and Iron (green), FIG. 15F(iii). FIG. 15G shows the SEM image of Fe-Tp after acid treatment. FIG. 15H shows the PXRD of Fe-Tp after acid treatments. FIG. 151 shows the FT-IR of Fe-Tp after acid treatments.

The chemical bonding features of the 3D Fe-Tp MOF were investigated from the FTIR spectra (FIG. 15A). The aldehyde C═O peak was shifted from 1619 cm⁻¹ to 1560 cm⁻¹ after coordinating with Fe³⁺ metal ions. The lower frequency of C═O could be due to the strong coordination interaction of the carbonyl group with Fe³⁺ cations, which may partially break the double bond character. In addition, a slightly lower frequency shift was also noted for C—O of Tp (1245 cm⁻¹) to Fe-Tp (1239 cm^{31 1}). It indicates the participation of both oxygens (carbonyl and hydroxyl) in the coordination bonds. Notably, the X-ray photoelectron spectroscopy (XPS) analysis imparted further details of the chemical environment of Fe-Tp (FIG. 15B). The presence of Fe³⁺ was indicated by two major peaks of Fe2p_{1/2} (725.5 eV) and Fe2p_{3/2} (711.7 eV) with corresponding weak satellite peaks. Meanwhile, the O1s of Fe-Tp showed a higher intensity peak at 531.7 eV indicating the metal-oxygen interaction. Moreover, the synthetic viability of the Fe-Tp were monitored by controlling the temperature, time, and equivalency of metal ions using PXRD. The reaction time study (1-24 hrs) suggested the formation of Fe-Tp can be achieved even within an hour of thermal treatment. The PXRD and FT-IR of the thermally treated reaction mixture after an hour showed similar crystallinity and chemical bonding features to the product obtained after 24 hours. The variation of temperature of the reaction further suggests the feasibility of obtaining Fe-Tp MOF even at low temperatures (60° C.).

The critical role of salicylaldehyde functional groups to coordinate with Fe³⁺ cations and form a 3D network was investigated using two different C₃ linkers. One linker contains only aldehyde groups (Tfb; 1, 3, 5-triformylbenzene) and the other has only hydroxyl groups (Pg; phloroglucinol). The solid-state reaction of Tfb with FeCl₃.6H₂O yielded a reddish-orange color paste (Tfb-Fe) after thermal treatment. The FT-IR of Tfb-Fe showed similar IR peaks of Tfb, which indicates no bond is formed between aldehyde and Fe³⁺ ions. Also, the product is soluble in organic solvents and water, thus ruling out the formation of any robust, periodic framework. On the other hand, the solid-state reaction of Pg and FeCl₃.6H₂O resulted in a black color product with amorphous nature in the PXRD profile. This suggested the significant role of ortho-positioned aldehyde and hydroxyl groups in holding the Fe³⁺ ions in an ordered arrangement.

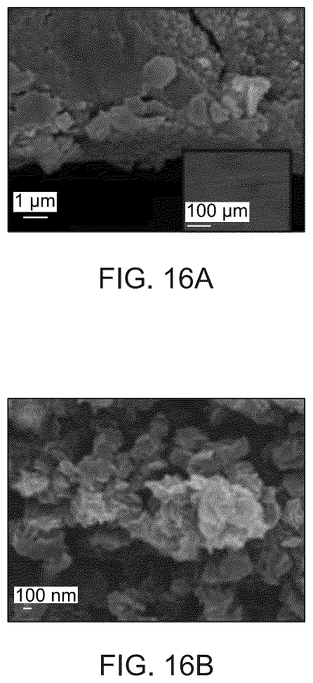

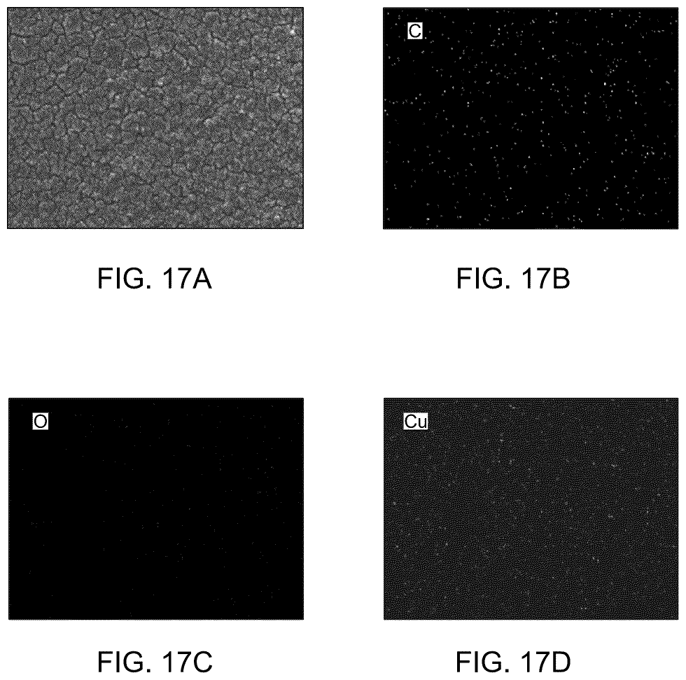

The PXRD of Tp-Cu foil showed a similar crystalline pattern compared to Cu-Tp-I and Cu-Tp-II (FIG. 8A). Major peaks were observed at two theta 7.9°, 12.2°, 15.3°, and 27.9°, along with a strong 111 plane diffraction of metallic copper at 43°. Moreover, the FTIR of Cu-Tp-Foil displayed characteristic peaks similar to Cu-Tp-MOFs without any notable changes (FIG. 9). The XPS profile showed Cu 2p3/2 (934.72 eV) and Cu 2p1/2 (954.647 eV) with corresponding satellite peaks. The SEM images showed the surface growth of MOF on copper foil (FIG. 16A and FIG. 16B). The SEM images of Cu-Tp-Foil, FIG. 16A, shows the vertical SEM image displayed MOF formation even at the edges surface. The SEM image of bare copper foil is shown in the inset. FIG. 16B shows the petal-like morphology of Cu-Tp at the surface of the foil. Unlike the granular Cu-Tp-I and Cu-Tp-II, the Cu-Tp-Foil exhibited a uniform flower petal-like morphology on the entire surface. The SEM images also showed the foil edge covered with the Cu-Tp particles. The vertical image of the scissor-cut Cu-Tp-Foil showed a clear distinction between the grown Cu-Tp and Cu foil with the thicknesses of ˜25-30 μm and ˜20 μm, respectively. Furthermore, the evenly distributed carbon and oxygen in the SEM elemental map signifies the uniformity of the Cu-Tp film on the copper surface (FIG. 17A-FIG. 17D). The SEM elemental mapping images of Cu-Tp-Film is shown in FIG. 17A-FIG. 17D. FIG. 17A shows the SEM image of the Cu-Tp film. FIG. 17B shows the SEM elemental mapping images of Carbon. FIG. 17C shows the SEM elemental mapping images of Oxygen. FIG. 17D shows the SEM elemental mapping images of Copper. All these characterizations suggested the formation of Cu-Tp MOF on the surface of copper foil.

### Example 5: Semiconductive Properties of Cu-Tp Film

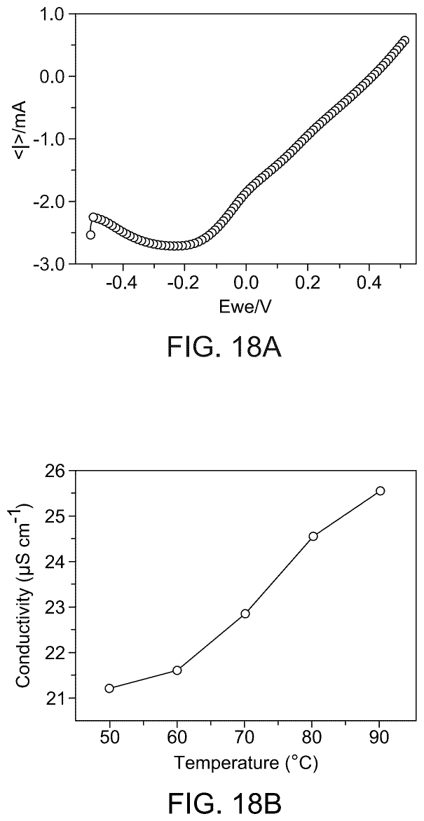

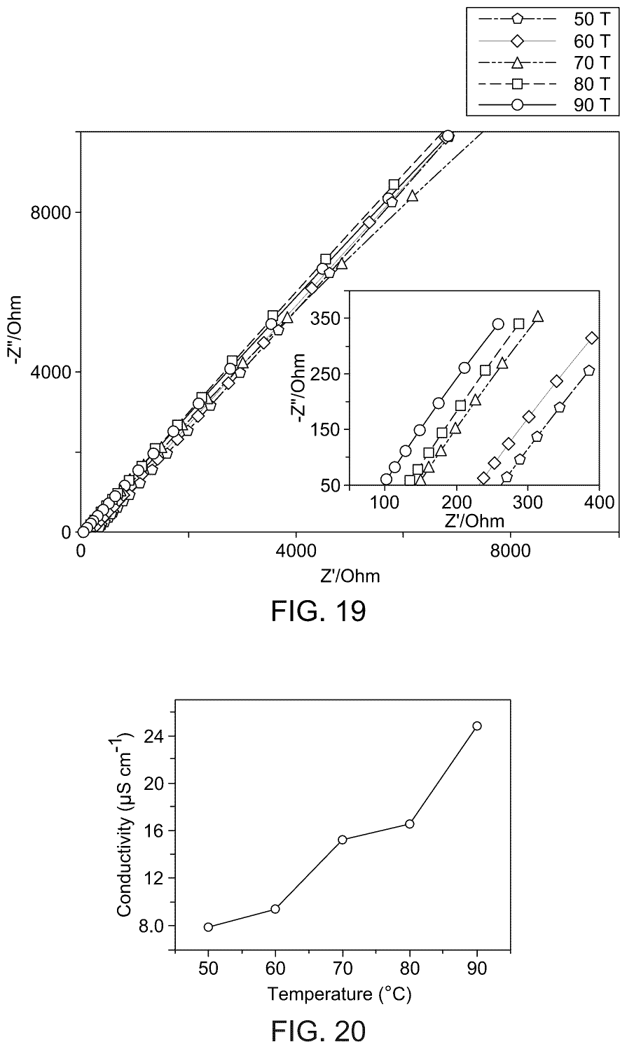

The Cu-Tp-Foil was subjected to two-contact mode current-voltage analysis to understand the electronic conductivity features. The I-V plot suggested the increment in electrical conductivity (from 21.20 μS cm−¹ to 25.60 μS cm⁻¹) with increasing temperature from 50° C. to 90° C. (FIG. 18A and FIG. 18B). The observation signifies the semiconductive property, which follows the Arrhenius type dependence on temperature from 50° C. to 90° C. The semiconductive property was also evident in the impedance measurement in the temperature ranging from 50° C. to 90° C. (FIG. 19). Herein, the electrical conductivity was increased from 7.88 μS cm⁻¹ to 24.80 μS cm⁻¹, keeping the Arrhenius relation (FIG. 20). It is important to note that the conductivity of blank copper foil decreased with increasing temperature. It indicates the semiconductive property of Cu-Tp-Foil originated from the deposited thin film of Cu-Tp MOF. The improved semiconductive property of Cu-Tp-Foil compared to granular Cu-Tp signifies the potential possibilities of conductivity enhancement by further fabrications.

### Example 6: Photocatalytic Reduction of CO₂

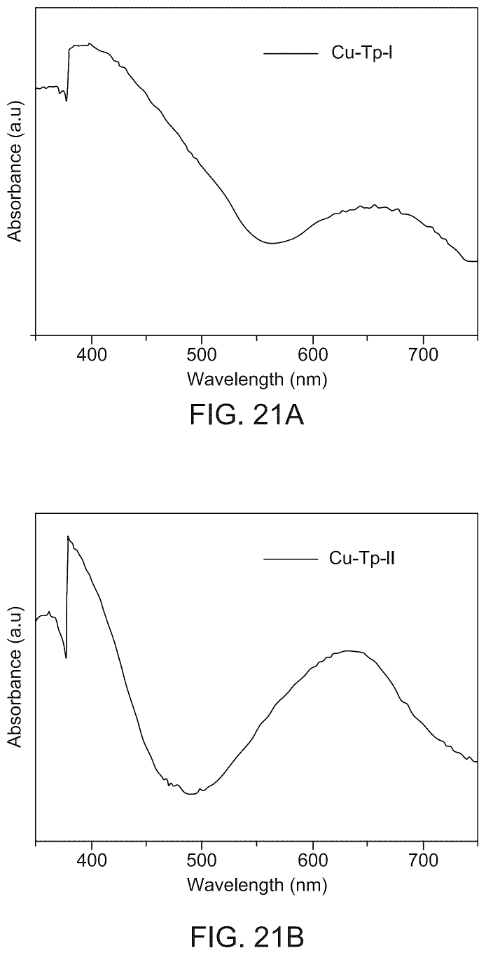

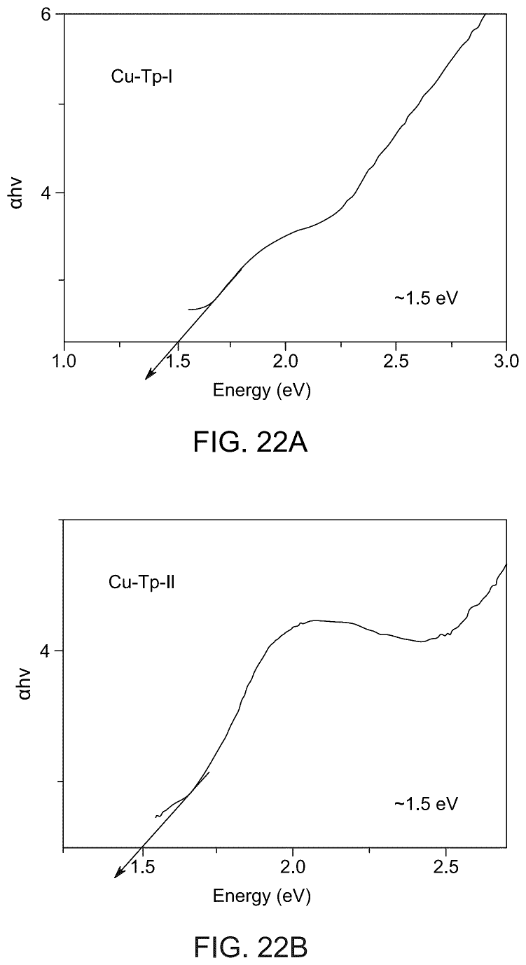

The optical band gaps of SA-MOFs were calculated by using solid-state spectroscopic analysis. The UV-visible spectra of SA-MOFs showed two significant absorption ranges: from 750 nm to 600 nm and from 550 nm to 350 nm (FIG. 21A-FIG. 21B). FIG. 21A shows the solid-state UV-visible spectroscopy of Cu-Tp-I and FIG. 21B shows the solid-state UV-visible spectroscopy of Cu-Tp-II. The near infrared-visible light absorption of SA-MOFs indicates a semiconductive band gap of ˜1.5 eV (FIG. 22A and FIG. 22B). Furthermore, the copper-rich distribution of Cu-Tp-I aids the reversible sorption of CO₂ molecules through Lewis acid-base interactions. The higher CO₂ adsorption of Cu-Tp-I compared to Ni-Tp was evident from the CO₂ gas adsorption isotherm (FIG. 23A-FIG. 23F). FIG. 23A-FIG. 23D show the CO₂ adsorption-desorption isotherm of Cu-Tp-I and Cu-Tp-II at 273 K and 298 K. Both Cu-Tp MOFs showed higher CO₂ uptake compared to Ni-Tp (FIG. 23E and FIG. 23F). The Cu-Tp-I and Cu-Tp-II adsorbed 1020 and 955 μmol g−1 at 273 K and 1 bar. Moreover, Ni-Tp adsorbed only 355 μmol g−1 at 273 K and 1 bar. In addition, Cu-Tp-I, Cu-Tp-II, and Ni-Tp showed CO₂ uptake of 706, 636, and 245 μmol g−1, respectively, at 298 K and 1 bar.

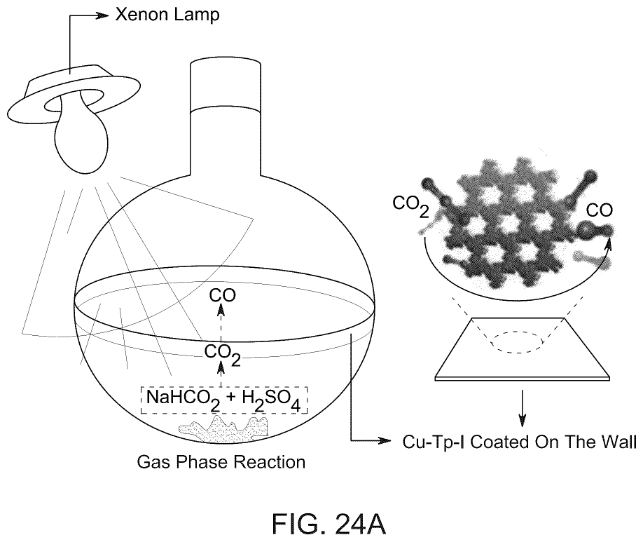

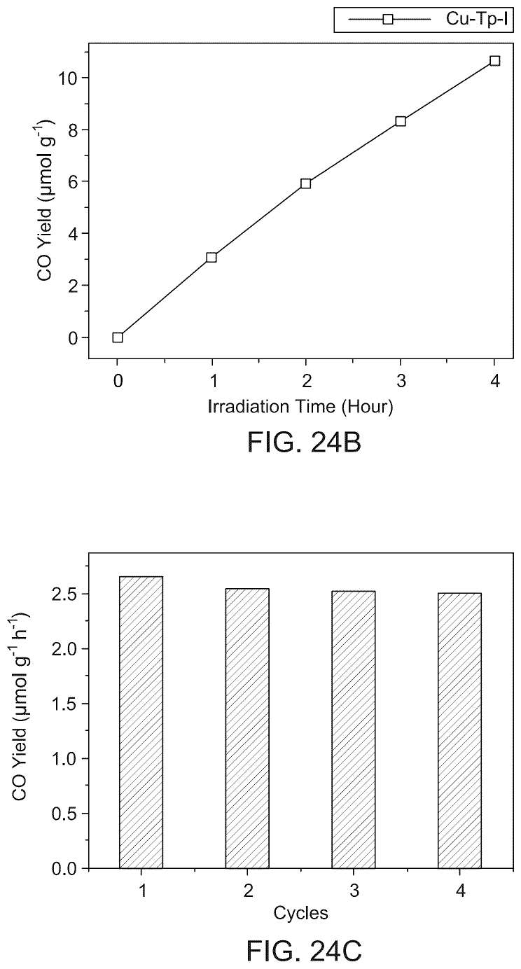

It is worth mentioning at this juncture, that converting CO₂ to CO (a potential carbon source for producing value-added products) by using solar light is paramount for a sustainable future. However, the poor product selectivity during the photocatalytic reaction requires a further tedious gas separation process. Therefore, developing a material that can selectively convert CO₂ into a single product (for example, CO) has paramount economic and industrial relevance. Considering the good reversible CO₂ adsorption and semiconductive features, Cu-Tp-I MOF was employed for photocatalytic CO₂ reduction. The photocatalysis was carried out in a sealed quartz flask under 300 W Xenon arc lamp irradiation without any supporting cocatalyst and sacrificial agents (FIG. 24A). Notably, Cu-Tp-I acted as a single source for light absorption and catalytic activity. Interestingly, the catalytic conversion resulted in the formation of CO as a sole product (100%) with good efficiency of 2.65 μmol g⁻¹ h⁻¹. The time-dependent study showed the increment in the production of CO molecule from 1 hour (3.067 μmol g⁻¹) to 4 hours (10.62 μmol g⁻¹) (FIG. 24B). The linear increment in the production of CO suggested stable utilization of the active sites in the porous matrix for catalytic conversion. Moreover, the recyclability analysis of Cu-Tp-I suggested 93% of catalytic efficiency retention even after four cycles (each cycle equals 4 hours) (FIG. 24C). These results indicate the excellent photostability of Cu-Tp-I for catalytic conversion reactions. Again, control experiments were conducted to confirm the exclusive role of Cu-Tp-I in photocatalysis. These experiments showed that CO was not detected in the dark or in the absence of CO₂ and/or photocatalyst, suggesting that light irradiation, input CO₂, and the photocatalyst were critical factors for the photocatalytic CO2 reduction reaction. The retention of structural characteristics of Cu-Tp-I after the long-term photocatalytic experiment was evident from the PXRD and FTIR analysis. The PXRD of Cu-Tp-I after photocatalytic CO₂ reduction showed a crystalline profile indicating the strong structural stability towards visible light irradiation. Also, the FTIR profile of Cu-Tp-I underlined the stable chemical bonding in the framework.

### Example 7: Photocatalytic H₂O₂ Production

A chemically stable, manganese (III)-based conjugated metal-organic framework (Mn-Tp MOF) has been developed, comprising octahedrally coordinated Mn³⁺ centers and salicylaldehydate-functionalized 1,3,5-triformylphloroglucinol (Tp) linkers forming a three-dimensional x-conjugated network. The framework is synthesized through a scalable, catalyst-free solid-state grinding process followed by thermal curing, yielding a crystalline material with srs topology and dual interpenetrated cubic phases. Mn-Tp exhibits broad visible-light absorption (400-750 nm) and a narrow band gap (˜1.65 eV), facilitating efficient photoinduced charge separation and light-driven redox processes. Photocatalytic hydrogen peroxide (H₂O₂) generation proceeds via a dual-pathway mechanism involving oxygen reduction (ORR) and water oxidation (WOR), with the Mn centers enabling selective two-electron O₂ activation and suppressing undesired H₂O₂ decomposition. The catalyst achieves H₂O₂ production rates up to 10,487 μmol g⁻¹ h⁻¹, surpassing structurally analogous Fe-Tp MOF (less than 100 μmol g⁻¹ h⁻¹), and maintains structural integrity under harsh acidic and aqueous conditions, offering a high-performance platform for sustainable oxidation chemistry, decentralized peroxide production, and solar-driven environmental applications.

### Example 8: Electrocatalytic Properties of 2D/3D SA-MOFs

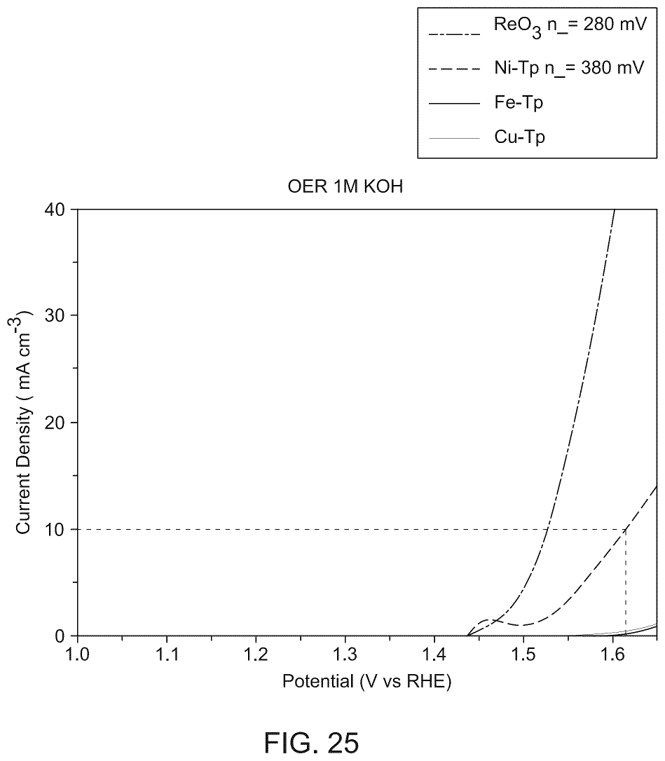

(i) Electrocatalytic Oxygen Evolution and 5-hydroxymethylfurfural oxidation: The SA-MOFs are potential materials for electrocatalytic conversion reactions like CO₂ reduction, N₂ fixation, hydrogen evolution, oxygen evolution or reduction reaction etc. For example, Ni-Tp MOF acts as a good electrode material in electrocatalytic OER with 380 mV of overpotential (FIG. 25). FIG. 25 shows the electrocatalytic oxygen evolution reaction analysis of SA-MOFs-Current density Vs potential. The chronoamperometry showed the stability of Ni-Tp MOF for 24 hours with >50% retention of initial current density.

The Ni-Tp demonstrates a highly selective electrocatalytic conversion of 5-hydroxymethylfural (HMF) to 2, 5-furandicarboxylic acid (FDCA) with excellent faradaic efficiency (96±4%). In-situ Raman and X-ray absorption spectroscopy (XAS) reveal that Ni-Tp acts as a precatalyst for uniformly dispersed nickel (oxy) hydroxide (NiOOH) in the electrocatalytic organic oxidation reaction (OOR) process. The combination of efficient electron transport of the Ni-Tp and the uniform dispersion of newly formed nickel (oxy) hydroxide with excellent electrolyte availability leads to redox (and potentially catalytic) activity of all in situ formed nickel sites. Thus, the Ni-Tp is an ideal precatalyst in terms of nickel (oxy) hydroxide active site exposure.

(ii) Electrochemical redox reactions of 3D Fe-Tp-MOF: It is important to note that the chemical resistance toward proton-assisted degradation is a critical factor to select the electrodes in electrochemical energy storage systems such as supercapacitors. However, most of the redox-active-based pseudo-supercapacitors face the possibility of chemical degradation of the electrode. The chemical fragility of redox-active electrodes affects the long-term performance of supercapacitor devices. In this regard, developing chemically stable redox-active electrode materials is important for the sustainable performance of supercapacitors. The thermal stability of Fe-Tp was recorded by thermogravimetric analysis (TGA) in an inert (N₂) atmosphere. The TGA plot of Fe-Tp displays thermal stability up to 280° C. with 93% retention of the initial mass. Furthermore, the porous properties of Fe-Tp were investigated using N₂ gas adsorption isotherm at 77 K. The N₂ adsorption of Fe-Tp showed a type IV isotherm, and a calculated BET surface area of 94 m² g⁻¹. The moderate surface area could be due to the ultra-microporous nature of Fe-Tp. The Horvath-Kawazoe microporous calculation of Fe-Tp indicates the pore size ranges from 0.8 nm to 1.2 nm. However, non-local density functional theory (NLDFT) pore size calculation indicates the negligible intensity of micropores compared to the mesopores (3-50 nm), which must be arising from the packing of the Fe-Tp nanocrystals. The hierarchical range of pores (from ultra-micropores to meso-pores) offers efficient diffusion of ultrasmall-size protons (0.84 fm) through the framework matrix. Moreover, the CO₂ gas adsorption analysis of Fe-Tp was carried out at 273 K and 298 K. The isotherms showed the reversible sorption of CO₂ at 1 bar with an uptake capacity of 563 μmol g⁻¹ and 358 μmol g⁻¹ at 273 K and 298 K respectively.

Conjugated networks typically facilitate electronic conductivity or semi-conductive property through the chemical bonding framework. Considering the formation of a 3D-conjugated framework through the bonding of the C³ symmetric salicylaldehyde functional groups with the iron cations, solid-state UV-visible spectroscopic analysis was carried out to find the band gap of the material. The spectra of Fe-Tp showed a broad range of visible-light absorption (400 nm to 700 nm) with wavelength maxima at 540 nm. The electronic band gap was calculated from the tauc plot which suggested a semiconductive band gap of 2.2 eV. Notably, Fe-Tp exhibits excellent structural stability in various solvents such as DMA, acetone, chloroform, tetrahydrofuran, and water (even in boiling conditions) for more than 7 days. In addition, Fe-Tp was also highly stable in strong acids like H₂SO₄, HCl, and HNO₃ at extreme concentrations (10 M) for 24 hours with ˜10% loss of initial mass.

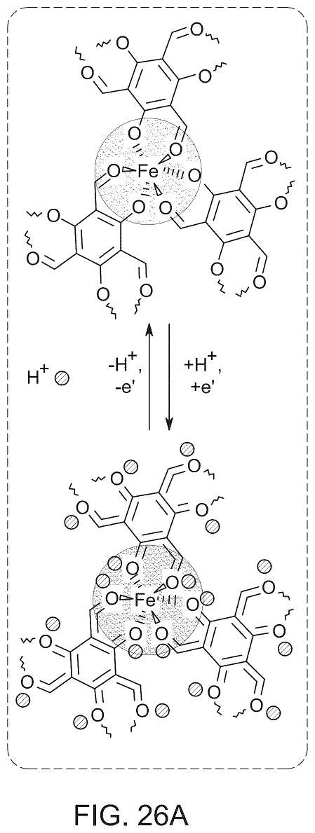

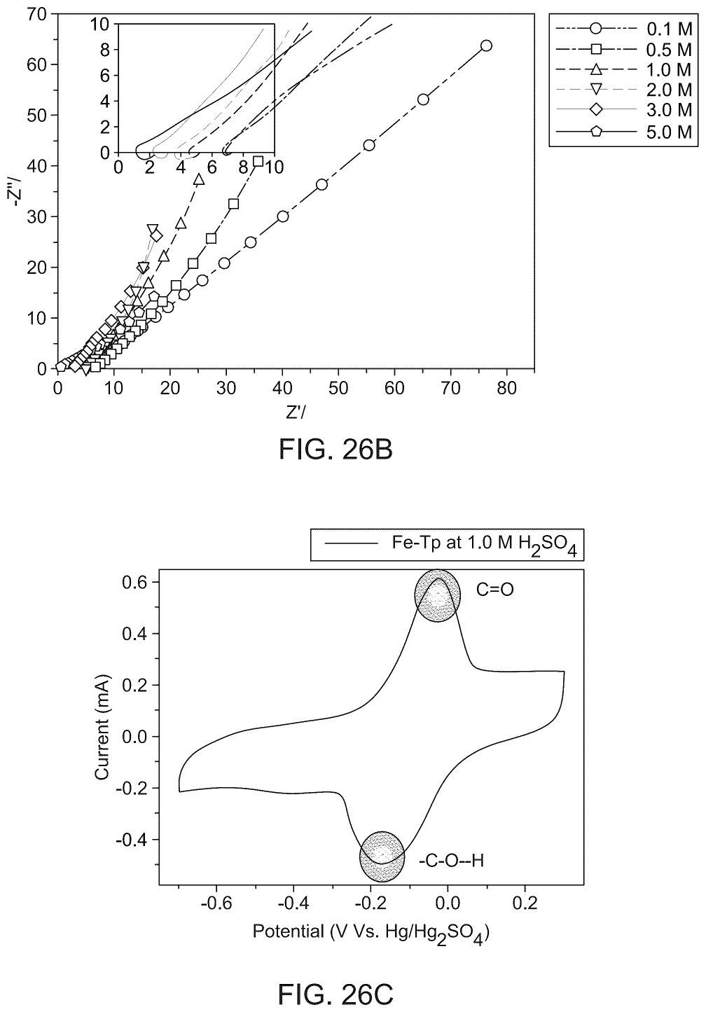

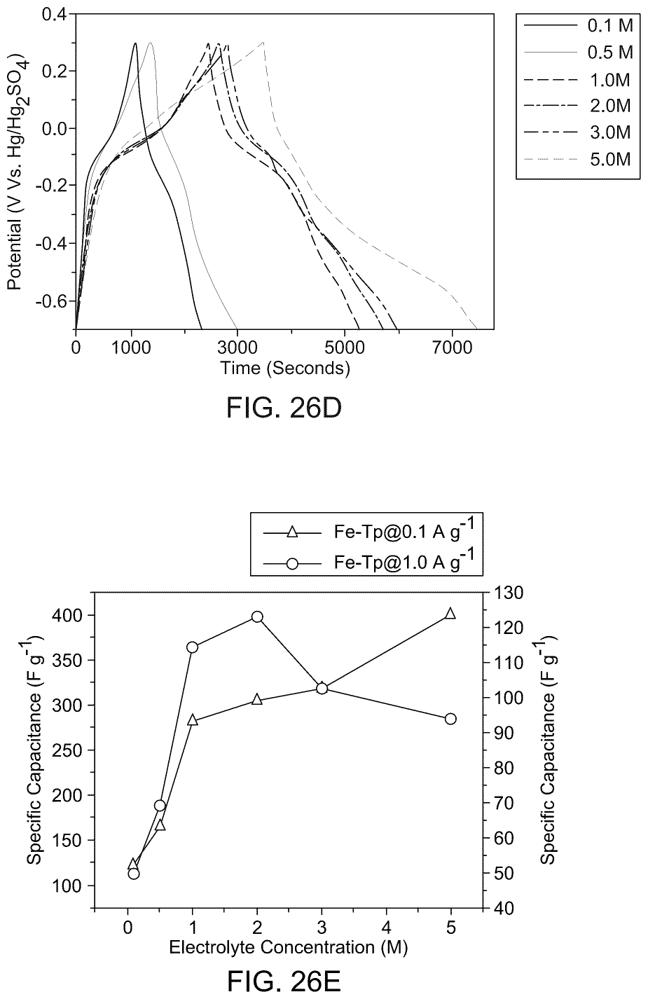

Considering the higher chemical stability and hierarchical porosity of Fe-Tp, the Fe-Tp was analyzed for charge storage performance under various electrolyte concentrations (0.1 M to 5 M H₂SO₄). The electro-chemical analysis of the Fe-Tp was investigated using a three-electrode assembly. The electrochemical impedance spectroscopy of Fe-Tp at different electrolyte concentrations revealed the effect of proton concentration on the electrochemical series resistances (ESR). It was found that the ESR decreases (from 6.7 (2 to 1.15 (2) with the increasing concentration of electrolyte (from 0.1 M to 5 M) (FIG. 26B). It signifies the higher ionic conductivity of electrolytes at higher concentrations, which retards the resistance between the electrode and electrolyte. The electrochemical features of Fe-Tp were noted from the cyclic voltammetry (CV) analysis with a potential window of 1 V (−0.7to 0.3 V) (FIG. 26C). The observed reversible oxidation-reduction peaks could originate from the oxygen-contained (C═O and C—O) Tp linker (FIG. 26A). The C₃ symmetric hydroxyl groups (C—O) in Tp can oxidatively switch into the carbonyl (C═O) group and reductively vice versa under the applied potential variations. Moreover, the current gain was increased upon the increasing scanning rate from 5 to 500 mVs-1. The effect of electrolyte concentration on the specific capacitance of the Fe-Tp electrode was measured by the galvanostatic charge-discharge experiment (GCDC). The GCDC was performed with the potential window of 1 V (−0.7 to 0.3 V) at the current density ranging from 0.1 to 1 A g−1 (FIG. 26D). The GCDC curves showed the pseudocapacitance (redox) nature of the Fe-Tp electrode. In general, the specific capacity of Fe-Tp was increased from a higher current density (1 A g⁻¹) to a lower current density (0.1 A g⁻¹) for all concentrations of electrolyte (FIG. 26E). The highest specific capacitance (400 F g⁻¹) was noted at 0.1 A g⁻¹ in 5 M H₂SO₄. Overall, the highest specific capacitances at higher current densities of 0.25, 0.5, and 1 A g⁻¹ are 200, 148, and 123 F g⁻¹ respectively in 2 M H₂SO₄. Notably, the regular increment of specific capacitance was observed in the lower current density (122 to 401 F g⁻¹ at 0.1 A g⁻¹) of GCDC upon the increasing electrolyte concentration. At higher densities, the specific capacities were increased from 0.1 M to 2 M H₂SO₄ and then decreased from 3 M to 5 M H₂SO₄ concentrations. The dynamic trend of specific capacities of Fe-Tp in various electrolyte concentrations and current densities could be due to the following reasons: 1) The proton diffusion through the ultra-microporous Fe-Tp is very efficient at lower current density. The protons are infiltrated into the inner cores of a doubly interpenetrated network and the specific capacities were increased upon the proton concentration increments. 2) At higher current densities, the protons mostly interact with the surface of the electrode and do not completely diffuse into the inner cores of the 3D framework. In this regard, the excessive accumulation of protons on the surface at higher concentrations of the electrolyte decreases the overall capacitance of Fe-Tp. Overall, the higher ionic conductivity and proper proton diffusion to the active sites enhance the specific capacity of the electrode. It is important to note that the chemical stability of Fe-Tp maintains the porous structure without any chemical degradation during the charge-discharge process.

### Example 9: Energy Storage Properties of 2D/3D SA MOFs

The SA-MOFs are potential electrode materials in energy storage devices like supercapacitors and various batteries like Li⁺, Na⁺, K⁺, Zn²⁺, Al³⁺, etc. We have explored the energy storage properties of Fe-Tp in supercapacitor and lithium-ion battery.

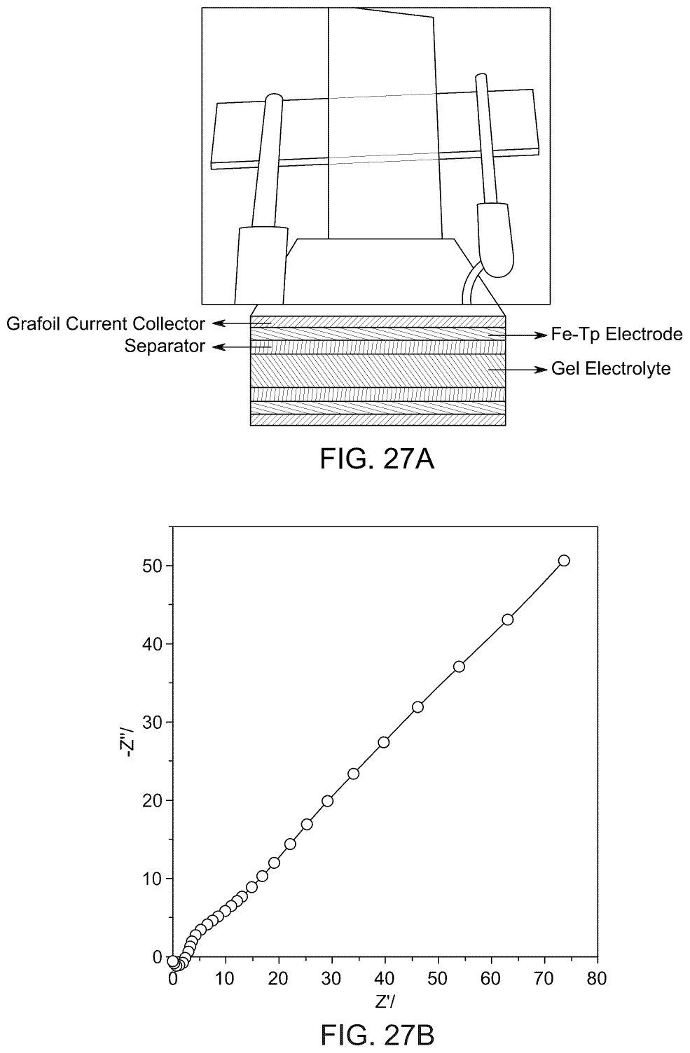

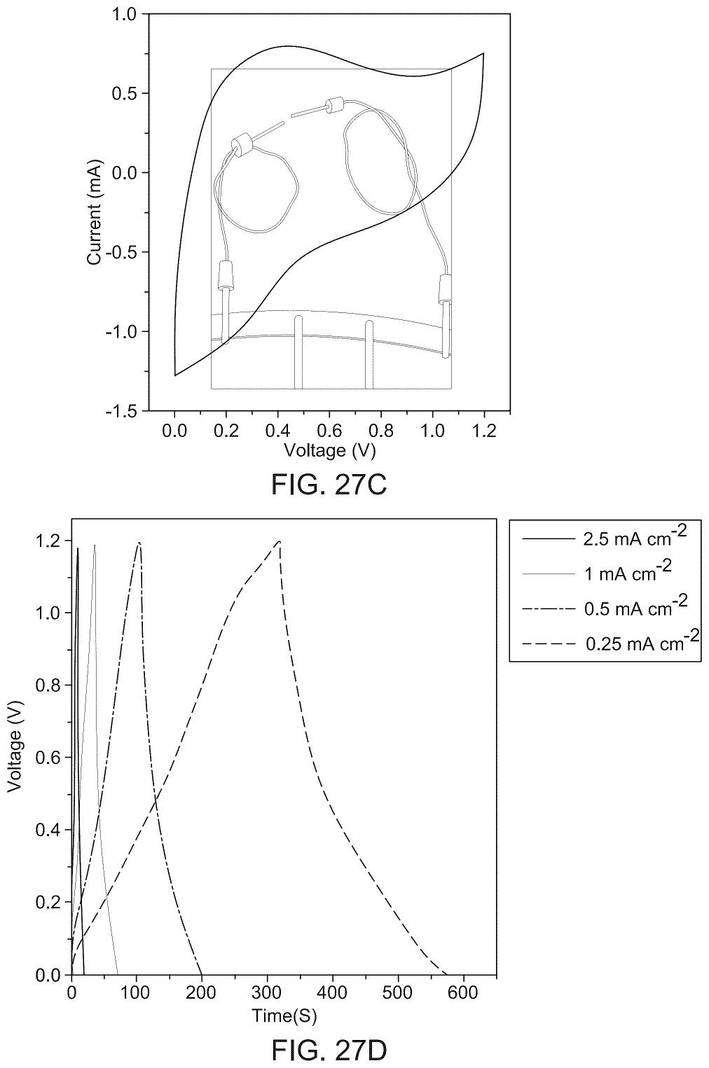

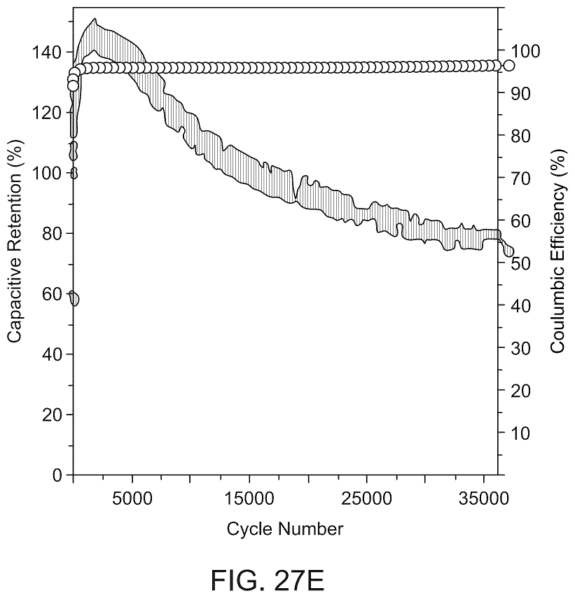

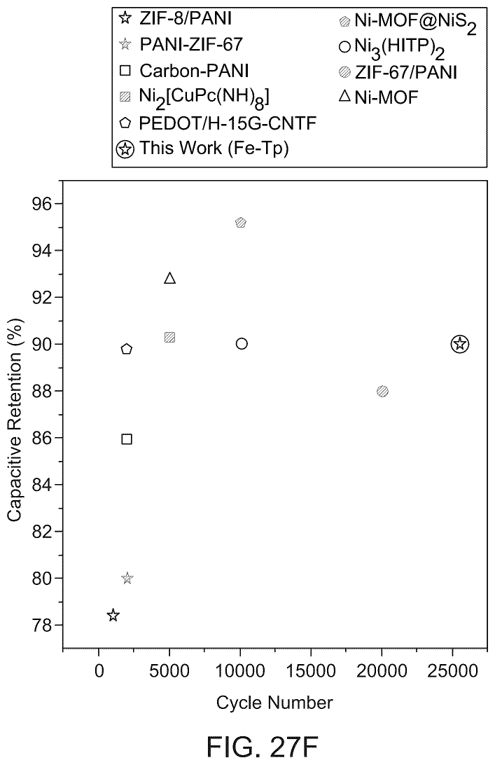

(i) Supercapacitor: Considering the excellent charge storage and chemical stability, a quasi-solid-state supercapacitor was fabricated using Fe-Tp as symmetric electrodes, grafoil as current collectors and proton-loaded PVA as gel electrolyte (FIG. 27A). The impedance analysis showed minimum interface resistance (ESR: 2.5 Ω) of the supercapacitor device (FIG. 27B). Moreover, the excellent charge storage feature of Fe-Tp was revealed in the CV of the supercapacitor (FIG. 27C). The single electrode-specific capacitance of the Fe-Tp supercapacitor was calculated from the GCDC experiment (FIG. 27D). Notably, The Fe-Tp supercapacitor offers a good areal capacitance of 106.25 mF cm⁻² and a very high energy density of 5.31 μW h cm⁻² at the current density of 0.25 mA cm⁻². Furthermore, the long-term cyclic stability performance of the Fe-Tp supercapacitor signifies the critical role of the chemical stability of electrode material in the device (FIG. 27E). Interestingly, the Fe-Tp retains 90% of the initial capacitance until 25000 charge-discharge cycles and maintained 80% of the initial capacitance even after 36000 continuous charge-discharge cycles at the current density of 5 A g⁻¹. Notably, the coulombic efficiency was also upheld at 95-96% throughout the 36000 cycles. The initial enhancement of the capacitance (up to 145%) until 1700 cycles could be due to the activation of the core micropores of the doubly interpenetrated 3D network of Fe-Tp. A possible reason for this unprecedented stability could be due to the strong chemical stability of Fe-Tp in an acidic environment. A comparison of the Fe-Tp SA MOF with other reported MOF-based supercapacitors showed that Fe-Tp is one of the best MOF-based electrode candidates for long-term cyclic stability in acid or base support electrolyte supercapacitor devices (FIG. 27F). Furthermore, three Fe-Tp supercapacitor devices were connected in series and powered a 3.5 V LED for 15 seconds (inset: FIG. 27C).

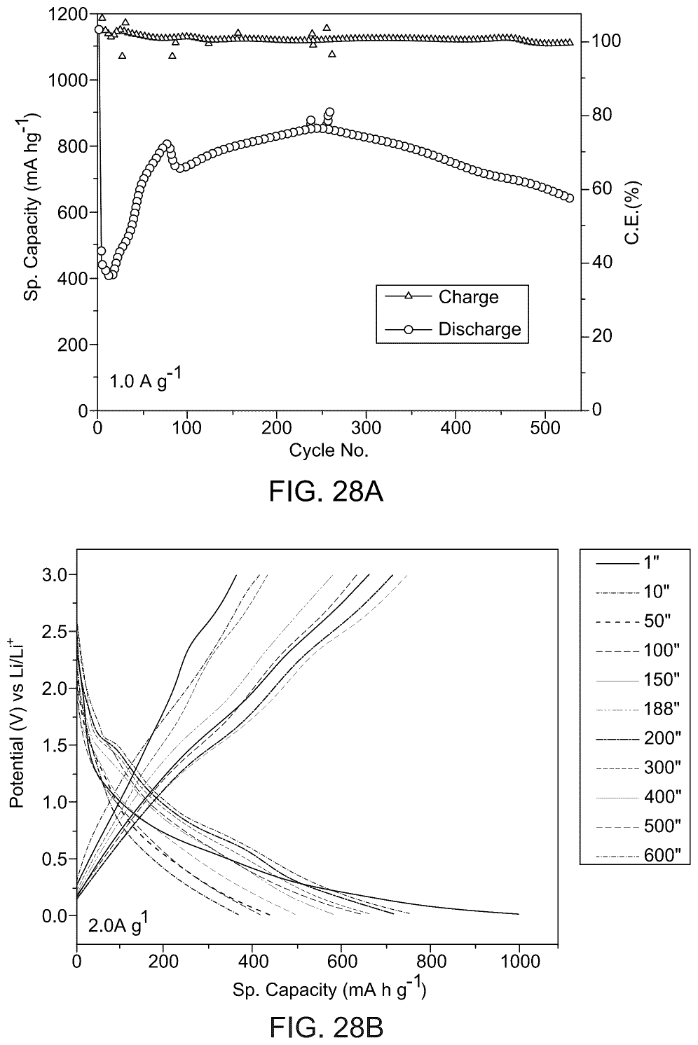

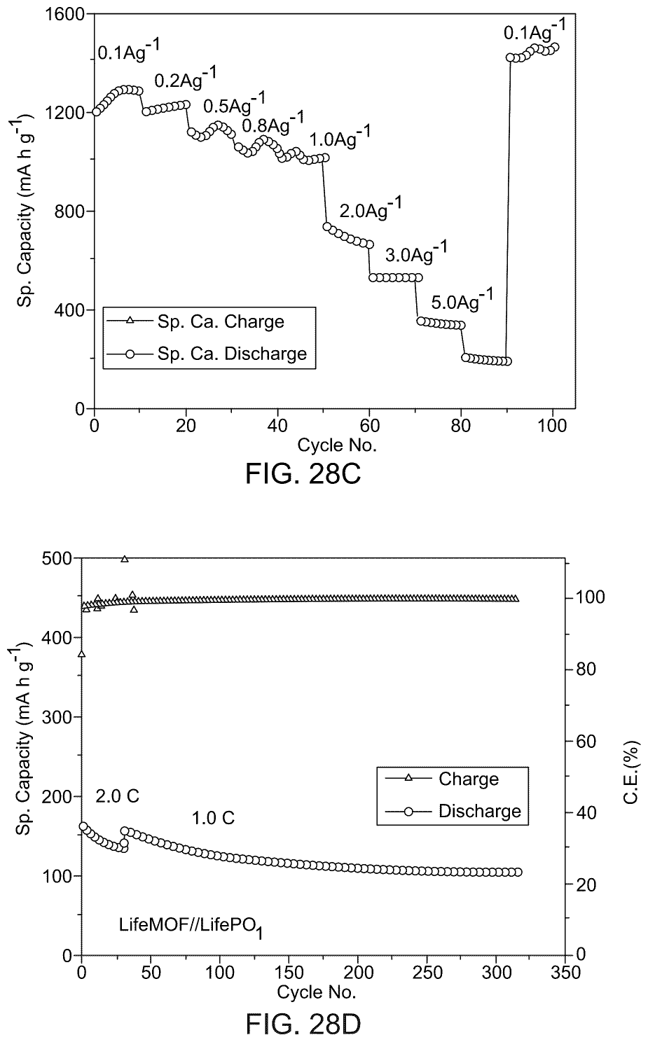

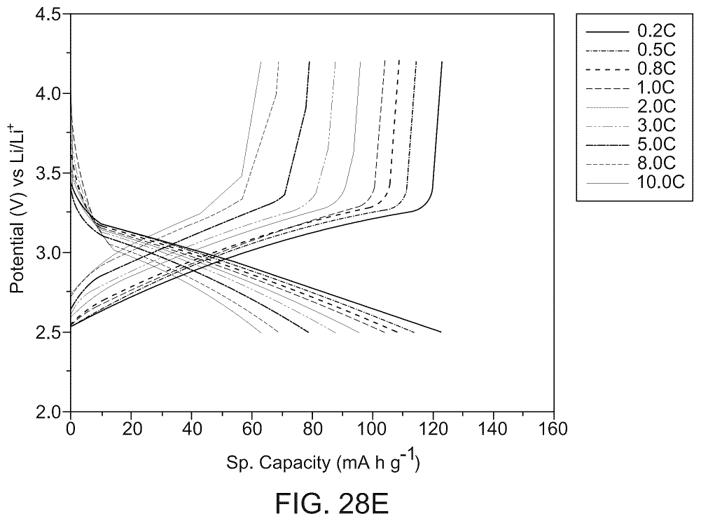

(ii) Lithium-ion Battery: Developing high performance rechargeable lithium-ion battery (LIB) electrodes need to meet many critical challenges like high Li ion storage capacity, stability, and potential commercial viability. In particular, hierarchical porosity for mass diffusion, lithium anchor sites for pseudo-capacitance, chemical and structural stability of electrodes for long-term performance, and the rapid and large-scale production feasibilities for commercialization, are some of the parameters for improving the electrode performance. Although several materials have been developed with certain advantages, many of them face difficulties keeping all these parameters in progress. Embodiments of the present disclosure describe a scalable, relatively cheap iron-based MOF (Fe-Tp) through simple mechano-mixing synthetic strategy using salicylaldehydate-metal coordination chemistry. The hierarchically porous and crystalline doubly interpenetrated Fe-Tp showed excellent chemical stability and LIB anode specific capacity. The electrochemical performance of Fe-Tp anodes was evaluated at various current densities from 0.1 A g⁻¹ to 3.0 A g⁻¹ within the potential window of 0.01 V and 3.0 V against Li/Li. The first cycle discharge capacity of the Fe-Tp anode was found to be 1000 and 1146 mA h g⁻¹ respectively. The maximum reversible capacity achieved was 760 mA h/g and 847 mA h/g at 2.0 A g⁻¹ and 1.0 A g⁻¹ (FIG. 28A). Such high Li-ion storage capacity values observed even at rapid charge-discharge rate suggest that the material has excellent Li-ion storage capacity. Further, the rate capability of Fe-Tp was evaluated by varying the current density values from 0.1 A g⁻¹ to 10.0 A g⁻¹, where the capacity values decreased from 1283 mA h g⁻¹ to 200 mA h g⁻¹ (FIG. 28C). The Fe-Tp anode retrieves a capacity of more than 1400 mA h g⁻¹ when the current density was switched back to 0.1 A g⁻¹, which indicates the excellent electrochemical stability of the material from very slow to rapid charge discharge rates. The long-term stability of these anodes at high current density of 1.0 A g⁻¹ shows the capacity values started increasing from around 400 mA h/g to 847 mA h/g in the first 230 cycles and after 600 charge-discharge cycles the capacity value was close to 600 mA h/g (˜71%), which is significantly higher than many reported MOFs and the commercialized graphite anode. To investigate the pseudocapacitive lithium storage nature of the Fe-MOF anodes, the CV measurements at various scan rates from 0.2 mV/s to 1.0 mV/s were recorded. The CV curves exhibit two sharp distinctive redox peaks which signify that the system possesses stable and reversible lithiation and de-lithiation.

Further, the full cell was fabricated using lithiated Fe-Tp anode and Lithium iron phosphate (LFP) cathode (Q theoretical=170 mA h g⁻¹). The cells were cycled between 2.5 V and 4.2 V. It was observed that the full cell delivered a high-capacity value of 125 mA h g⁻¹ at 0.2 C with an excellent rate performance of 60 mA h g⁻¹ at 10 C. The cell was further tested for long term cycling at 1.0 C with an initial capacity of 151 mA h/g and at the end of 500th cycle, the cell could retain 60% of its initial capacity with an average columbic efficiency of 99.8% (FIG. 28D and FIG. 28E).

### Example 10: Synthesis of Multi-metallic SA MOFs

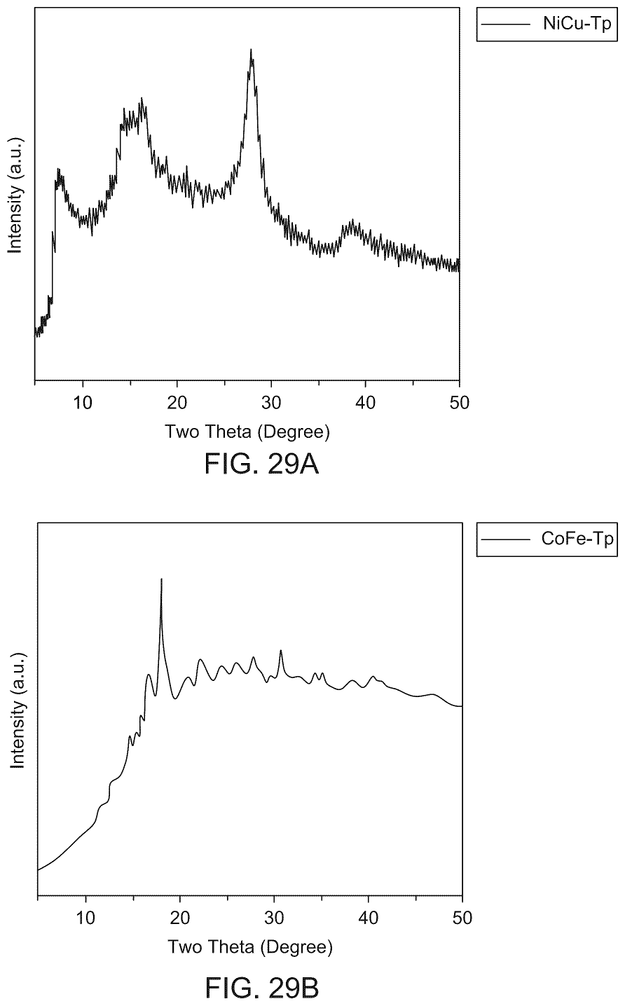

The SA-MOFs with multi metal centers were constructed using various metallic combinations like Ni:Cu, Co:Fe, Pd:Cu, Mn:Fe etc. The PXRD profiles of Ni:Cu and Co:Fe are shown in FIG. 29A and FIG. 29B respectively.

In addition to the electro or photo conversion or storage application, the SA-MOFs may be used for water treatment and solvent separation considering their ordered porosity and functionalities. The water treatment includes both adsorption and membrane-based separation applications.

The 2D/3D SA-MOFs of the present disclosure provide the following advantages for commercial-level purposes: 1) The synthetic conditions are completely free of organic solvents (green synthesis); 2) Use of moderate temperature (65° C.-90° C.) and time (5 hours-24 hours); 3) High yield of product (>90%); 4) The scale-up (gram to a kilogram) viability.

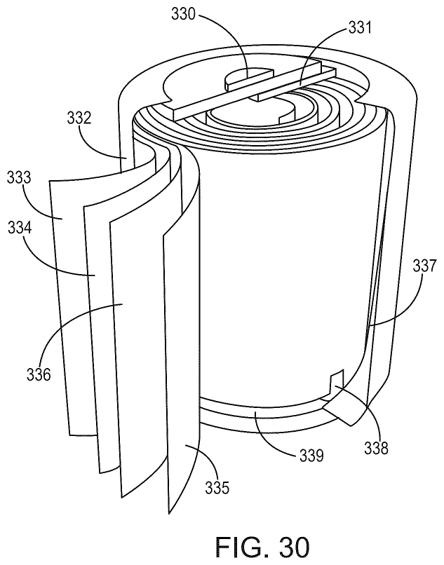

FIG. 30 illustrates a schematic cross-sectional view of a lithium-ion battery illustrating its principal internal components and overall structure. The battery is enclosed within a case 332, which serves as the external protective housing for the internal electrochemical cell assembly. The case 332 may be formed from metal, polymer, or a laminate structure depending on the battery format (e.g., cylindrical, prismatic, or pouch), and is typically designed to provide mechanical protection, thermal stability, and resistance to environmental factors such as moisture and impact.

Contained within the case is an electrochemical cell stack, which includes alternating layers of a cathode (positive electrode) 336, a first separator 334 and a second separator 335, and an anode (negative electrode) 333. The cathode 336 is typically composed of a lithium metal oxide material, such as lithium cobalt oxide (LiCoO₂), lithium iron phosphate (LiFePO₄), or other mixed metal oxides. The cathode 336 can be coated onto a conductive substrate, commonly aluminum foil, which acts as a current collector. The cathode 336 can function as the source of lithium ions during battery discharge and as the sink during charging.

The anode 333, functioning as the negative electrode, can be composed of a carbon-based material such as graphite, a silicon-carbon composite, or a graphite and iron composite material, as is described herein. As described in association with embodiments herein, the anode is composed of a salicylaldehydate-based iron metal-organic framework (Fe-Tp) and graphite, forming a hybrid anode material that enhances lithium-ion storage capacity and cyclic stability. In some examples, the anode 333 can be similarly coated onto a conductive substrate, generally copper foil, serving as its current collector. During charging, lithium ions can migrate from the cathode 336 through the electrolyte 337 and intercalated into the anode material 333; the reverse, from the anode material 333 to the cathode 336, can occur during discharge.

Separating the anode 333 and cathode 336 is a first separator 334, a thin, porous, and electrically insulating membrane that allows the passage of lithium ions but prevents direct electrical contact between the electrodes. The first separator 334 can be made from polyolefin materials such as polyethylene (PE), polypropylene (PP), or a multilayer combination thereof. The integrity and uniformity of the first separator 334 can be critical to battery safety and performance, as a short circuit between electrodes can lead to thermal runaway or failure. The first separator 334, between the positive 336 and negative 333 electrodes, is positioned to electrically insulate the electrodes while allowing the passage of lithium ions. The first separator 334 can be ion-permeable, ensuring efficient ionic conductivity during charge and discharge cycles.

The electrolyte 337 can permeate the porous structure of the separators 334/335 and electrode materials, providing the ionic medium necessary for lithium-ion transport. The electrolyte 337 typically consists of a lithium salt, such as lithium hexafluorophosphate (LiPF₆), dissolved in a mixture of organic solvents such as ethylene carbonate (EC), dimethyl carbonate (DMC), and diethyl carbonate (DEC). In some designs, additives are included to enhance performance, prevent degradation, or improve safety characteristics such as overcharge protection. The electrolyte 338 can include a lithium salt dissolved in a non-aqueous organic solvent, such as lithium hexafluorophosphate (LiPF₆) in ethylene carbonate (EC) and dimethyl carbonate (DMC). The electrolyte 338 can facilitate ionic contact with both the positive 336 and negative 333 electrodes, enabling the reversible intercalation and de-intercalation of lithium ions.

To facilitate electrical connection between the internal electrodes and external circuitry, the battery includes current collection tabs known as terminal leads. The positive terminal lead/cathode tab 331 is connected to the cathode current collector and extends to the positive terminal 330, which is exposed on the exterior surface of the case. This positive terminal lead 331 is typically made of aluminum to match the cathode current collector and ensure low-resistance conduction.

Conversely, the negative terminal lead/anode tab 338 is electrically connected to the anode current collector and extends to the negative terminal 399 on the case 332. This negative terminal lead 338 is usually constructed of copper, consistent with the anode current collector material. The positive terminal 330 and negative terminal 339 together provide the main interface for integrating the battery into external electronic systems, such as electric vehicles, consumer electronics, or energy storage devices.

The arrangement shown in FIG. 30 is intended to be illustrative and may represent a cross-sectional view of a wound jelly-roll structure (as in cylindrical cells), a stacked layer configuration (as in prismatic or pouch cells), or another internal architecture consistent with lithium-ion battery design. Additional features such as safety valves, pressure-relief mechanisms, insulating gaskets, and internal protection circuits may also be integrated within the battery structure but are not depicted in FIG. 30 for clarity.

This configuration allows the battery to efficiently store and release energy during charge and discharge cycles, making it suitable for applications in electric vehicles, portable electronics, and renewable energy systems. The integration of Fe-Tp in the anode provides enhanced lithium-ion diffusion and interaction, resulting in improved energy density and long-term cyclic stability.

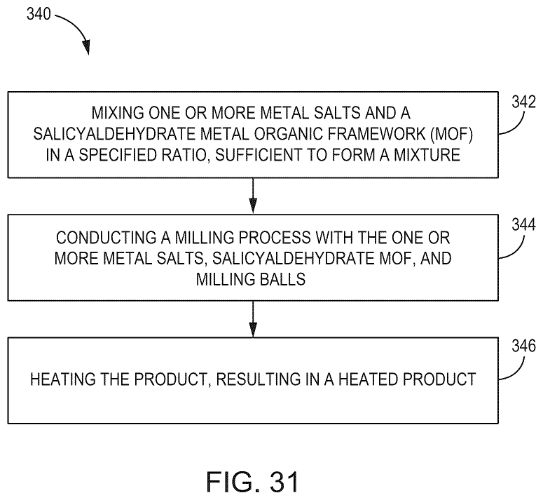

FIG. 31 is a flowchart illustrating the steps utilized in synthesizing a salicylaldehydate-based iron metal-organic framework (Fe-Tp) composition. The process is depicted step-by-step, highlighting the key stages of synthesis. Step 342 includes mixing metal salts and organic linkers. For example, the process can include mixing one or more metal salts, such as FeCl₃·6H₂O, with a salicylaldehydate-based metal organic framework (MOF) organic linker, such as 1,3,5-triformylphloroglucinol (Tp), in a specified ratio. The specified ratio of the metal salts to the salicylaldehydate linker can include ranging from 0.8:1 to 1:0.8. In some examples, it can be a 1:1 ratio. This ratio may be critical for achieving the desired stoichiometry and ensuring the formation of a stable crystalline framework. This step ensures uniform distribution of the reactants, forming a precursor mixture.

Step 344 includes conducting a milling process with the one or more metal salts, salicylaldehydate MOF, and milling balls. In some embodiments, the precursor mixture is subjected to a milling process using agate grinding balls in a ball-to-powder ratio of approximately 3:1. In some embodiments, the milling is conducted at a speed of 300-500 rotations per minute (rpm) for 50-70 minutes at room temperature. This step reduces the particle size of the reactants, facilitating enhanced interaction and uniformity.

Step 346 includes heating the product, resulting in a heated product. To accomplish this, the milled product is transferred to a closed container and heated in an oven for approximately 24 hours at approximately 90° C. This thermal treatment promotes the formation of the crystalline MOFite framework.

In some embodiments, the method 340 can include washing the heated product. The resulting solid product is washed sequentially with solvents such as N,N-dimethylacetamide (DMA), water, and acetone to remove impurities and unreacted precursors, yielding the final MOFite composition.

In some embodiments, the Fe-Tp composition (e.g., salicylaldehydate MOF composition) can be mixed with graphite, along with a PVDF binder and NMP solvent, to create the composite electrode material termed “MOFite.” This material is then coated onto a substrate, forming a high-performance electrode for lithium-ion battery applications, such as to make up the anode or negative electrode described in FIG. 30.

### Example 11: Synthesis of Fe-Tp

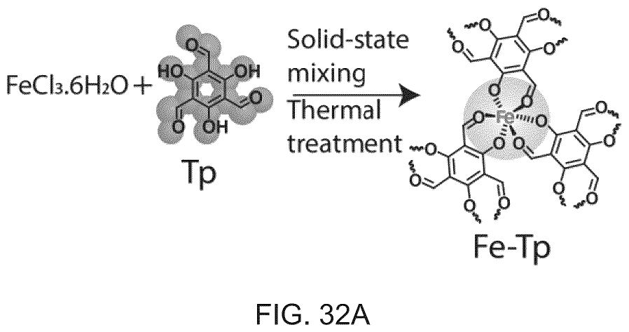

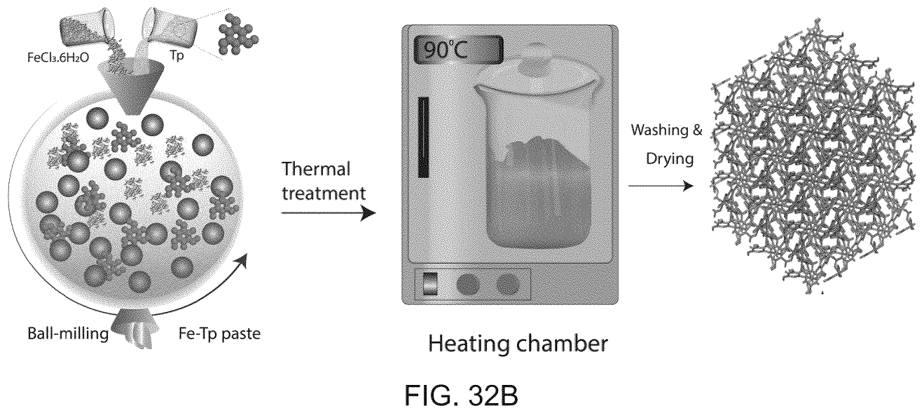

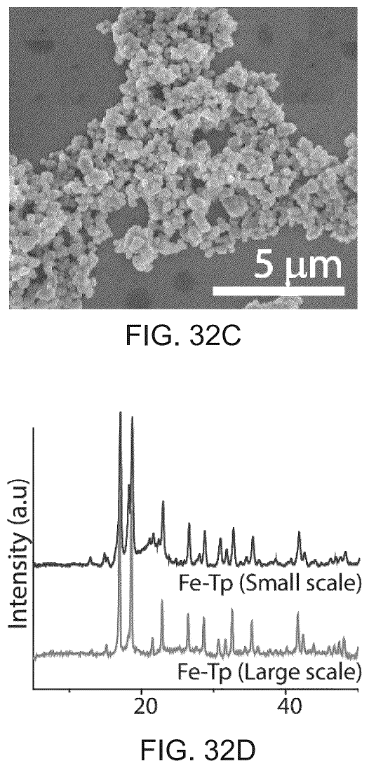

The scalable synthesis of salicylaldehydate-based iron metal-organic frameworks (Fe-Tp) and their applications in lithium-ion batteries is described herein. The synthesis process employs mechanochemical techniques to produce Fe-Tp in a cost-effective and environmentally friendly manner, enabling large-scale production while maintaining the material's structural and functional integrity. FIG. 32A shows a synthetic scheme of the synthesis of Fe-Tp while FIG. 32B shows a graphical representation of the synthesis of Fe-Tp using the ball-milling mechanochemical synthesis method. The resultant product of washing and drying is illustrated as a 3D-stick model of Fe-Tp. The battery industry demands the large-scale production of its components by easy synthetic steps using economic precursors. Considering the scalable prospect, the Fe-Tp was constructed using simple mechano-mixing of economic monomers (Tp and FeCl3·6H₂O) in a ball-milling instrument followed by thermal treatment without using any solvents or catalysts.

In some embodiments, the synthesis of Fe-Tp can be accomplished by using a ball mill, such as a planetary ball mill. The Fe-Tp can be synthesized using a planetary ball mill. Pre-weighed metal salts, specifically FeCl_{3·6}H₂O, and the Tp linker were mixed in a 1:1 molar ratio. However, the ratio of Tp:FeCl₃ can include 1:0.1 to 1:5 equivalents, in some examples. The mixture can then be transferred, in some examples, to a specified size mill jar, such as a 50 mL agate-A grade mill jar. Agate grinding balls can be added in a specified ball-to-power ratio, such as a ratio of 1:0.1 to 1.5 equivalents, to ensure efficient grinding and uniform particle size reduction. The milling process was conducted for a specified length of time, such as from 10 minutes to 120 minutes in some examples, at a specified speed, such as 400 rpm or within a range of 200-1000 rpm, at a specified temperature, such as within 20 degrees C. of room temperature.

Following the milling process, the resulting product was transferred to a closed vial and subjected to thermal treatment in an oven at a specified temperature for a specified period of time, such as within a range of 25 to 140° C. for within a range of 1-72 hours. This step facilitated the formation of the crystalline Fe-Tp framework. The final product was washed sequentially with N,N-dimethylacetamide (DMA), water, and acetone to remove impurities and unreacted precursors. The resulting Fe-Tp material was obtained as a dark reddish-brown powder, suitable for further applications.

In some embodiments, the synthesis of Fe-Tp can be performed by using an IKA tube mill. Similar to the planetary ball mill process, FeCl₃·6H₂O and the Tp linker were mixed in a specified molar ratio, such as a molar ratio within a range of 1:0.1 to 1:5 equivalents, and added to the grinding chamber of the tube mill. The mixture was subjected to a two-step grinding process: an initial step occurring within a range of 1 to 5 minutes at a speed within a range of 1000 to 10000 rpm, followed by an additional step occurring within a range of 1 to 5 minutes at a speed within a range of 10000 to 25000 rpm.

After grinding, the product was transferred to a closed container and heated at 90° C. for 24 hours to promote crystallization of the Fe-Tp framework. The final product was washed sequentially with N,N-dimethylacetamide (DMA), water, and tetrahydrofuran (THF) using a Soxhlet extraction process for two days. This thorough washing procedure ensured the removal of residual impurities and unreacted materials, yielding a high-purity Fe-Tp material. The Fe-Tp synthesized using both methods exhibited consistent structural and chemical properties, demonstrating its suitability for use as an anode material in lithium-ion batteries. The hierarchical porous structure and densely packed lithiophilic sites of Fe-Tp facilitate efficient lithium-ion diffusion and interaction, making it ideal for energy storage applications. The described synthesis methods enable scalable production of Fe-Tp, addressing critical challenges in the commercialization of MOF-based materials.

FIG. 32C illustrates SEM images of Fe-Tp showing spherical morphology. The scanning electron microscopic (SEM) images showed the micrometer-size monoliths of Fe-Tp composed of spherical particles with a 100-300 nm diameter and uniform Fe distribution. The powder X-ray diffraction (PXRD) of Fe-Tp showed major crystalline peaks at two theta 16.9°, 18.6°, 21.5°, 22.9°, 26.4°, 32.5° etc. Furthermore, the experimental PXRD is well-matched to the optimized calculated phases with the srs topology crystal model. Notably, the optimized crystal structures revealed ultramicrochannels (˜3-˜10 A) within the Fe-Tp frameworks. The absence of any building block crystalline peaks in the PXRD profile of Fe-Tp indicates the phase purity of the material.

The Fourier transform infrared spectroscopy (FT-IR) showed the C═O peak at 1560 cm⁻¹ in Fe-Tp. To test the scale-up feasibility in mild conditions, we have performed the Fe-Tp synthesis at different temperatures and reaction times. The 25 g scale production (using ball-milling and tube mill) resulted in similar quality to the material produced on a milligram scale (using mortar and pestle), which suggests the scale-up potential of the synthetic procedure, as shown in FIG. 32-D which illustrates the experimental PXRD of Fe-Tp in small-scale (milli-gram level) synthesis using mortar and pestle large-scale synthesis (several grams, −25 g, using ball-milling method. Moreover, the Fe-Tp was produced within an hour of thermal treatment at 90° C. The PXRD profile and FT-IR features are well-maintained in these synthetic conditions.

### Example 12: Fe-Tp and Li Interactions

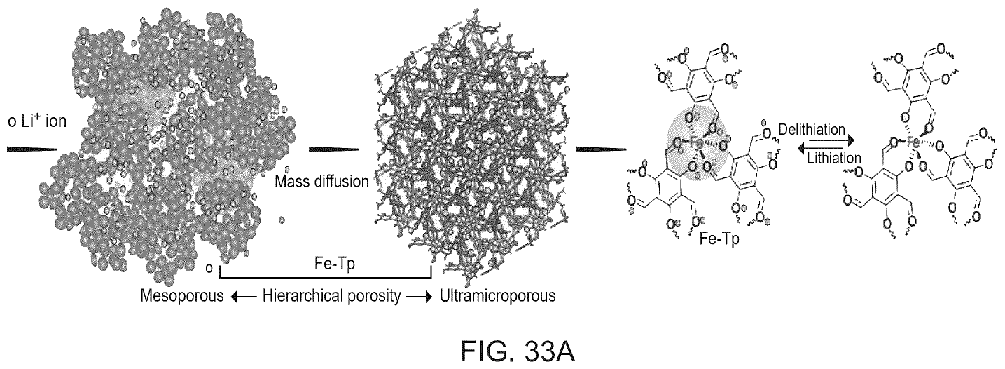

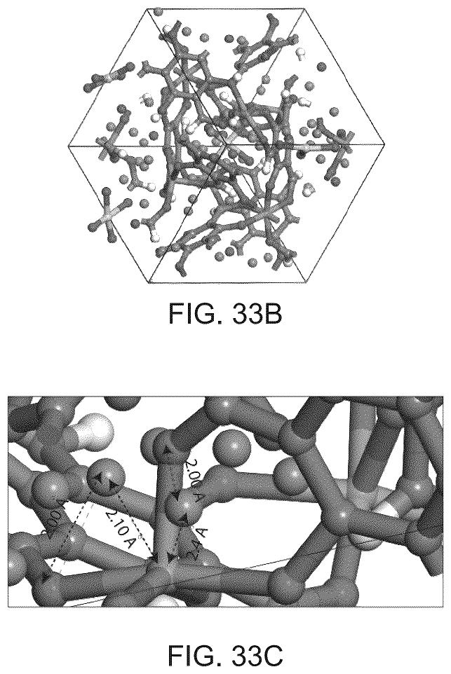

FIGS. 33A-33D illustrate the atomistic lithiation process of Fe-Tp as analyzed through static density functional theory (DFT) calculations. FIG. 33A is a diagrammatic representation of Li ion diffusion through the hierarchically porous Fe-Tp and possible sites of interactions. FIG. 33B illustrates the optimized crystal structure with 48 Li atoms, highlighting the structure with the maximum Li capacity at neutral conditions (e.g., without applying any electric potential). FIG. 33C illustrates the interaction of lithium with various binding sites (such as Fe and O) in the Fe-Tp. FIG. 33D illustrates the interaction of an FeO₆ unit with lithium. The high-density lithiophilic sites within the interpenetrated 3D framework of Fe-Tp create diffusion pathways that enhance its suitability as an electrode material for lithium-ion batteries (LIBs). The lithiophilic nature of oxygen atoms, which is described herein as improving anode performance, is leveraged in Fe-Tp's design, where oxygen atoms from carbonyl and phenolic functional groups, along with chlorides, serve as preferential lithium adsorption sites, as shown in FIG. 33A and FIG. 33D.

The FeO₆ octahedral unit, consisting of iron as the central metal atom and coordinated oxygen atoms, plays a critical role in lithium adsorption. Phenyl groups further stabilize the Fe-Tp-lithium interaction through lithium-x weak interactions. The DFT analysis, based on the theoretically optimized crystal structure obtained from experimental PXRD data, shown in FIGS. 33B-D, reveals bond lengths of approximately 2 Å for Li-O and 2.1-2.9 Å for Li-Fe interactions. These interactions highlight the structural features that facilitate lithium diffusion and binding.

The theoretical calculations suggest that Fe-Tp can accommodate up to 48 lithium ions per unit cell before the binding energy becomes positive, indicating a non-binding scenario. This demonstrates the high-density lithiophilic sites inherent in Fe-Tp, which are critical for its performance as an anode material. It is noteworthy that the calculations were performed under neutral conditions, and the application of an external potential may further increase lithium uptake, enhancing the material's electrochemical performance.

### Example 13: The Half-Cell Analysis of Fe-Tp

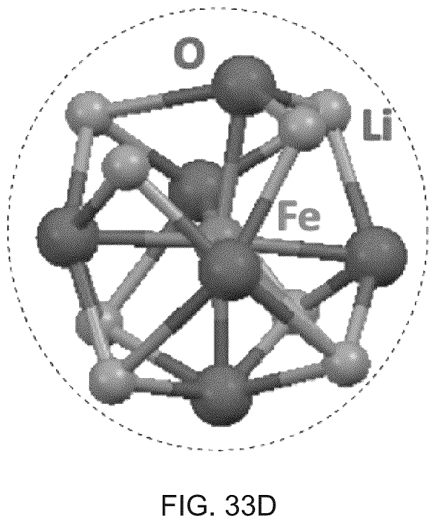

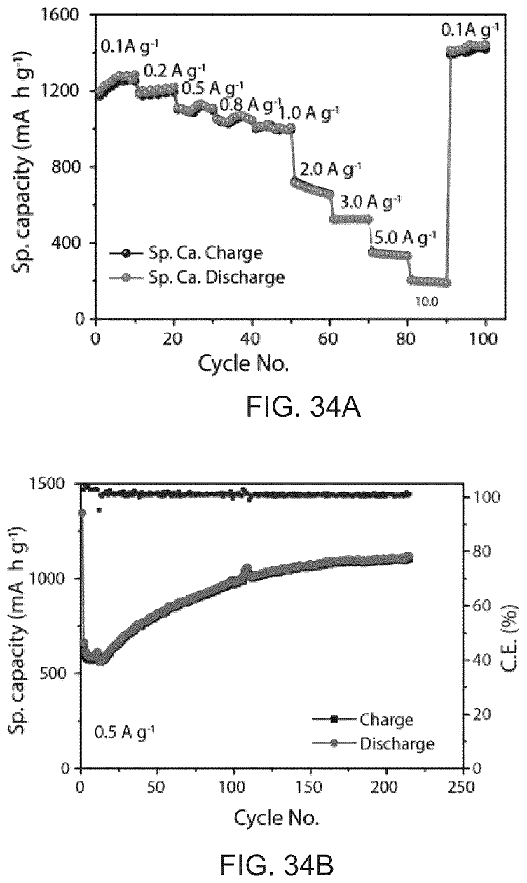

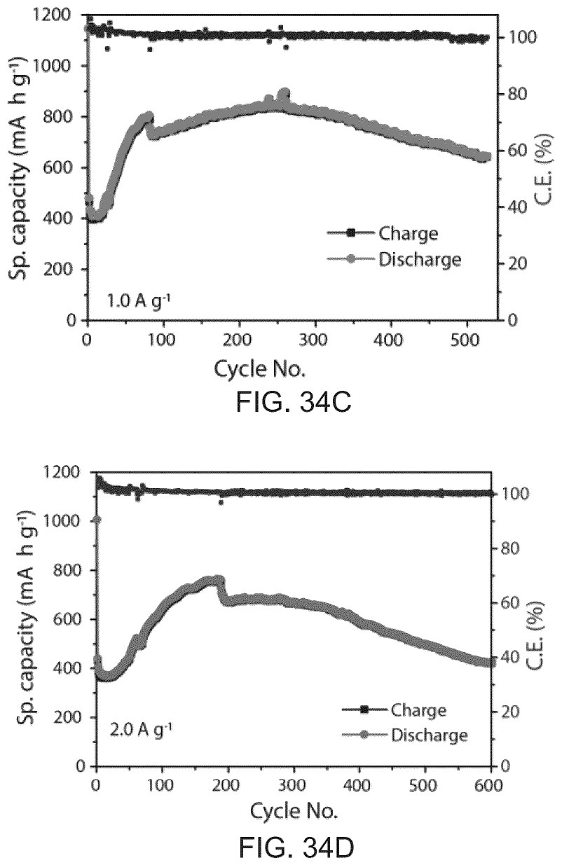

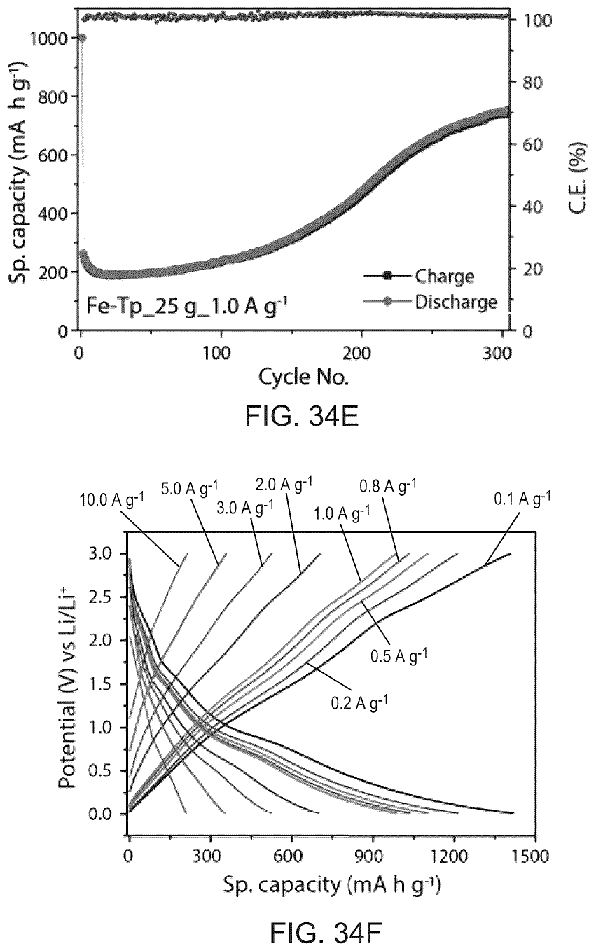

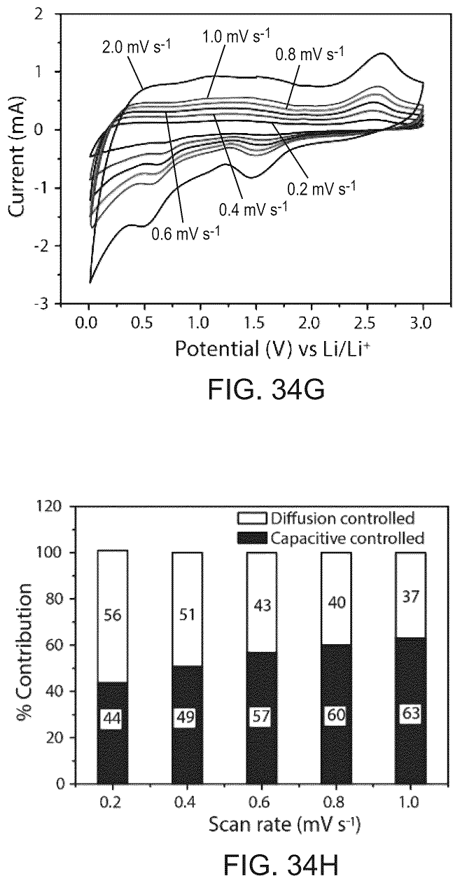

FIGS. 34A-34H illustrate the electrochemical evaluation of the Fe-Tp anode in lithium-ion batteries (LIBs) using 2032-type coin cells versus Li/Li³⁰. This analysis was performed to understand the reversible lithium-ion interactions and the performance of Fe-Tp as an anode material. The cells were tested at current densities ranging from 0.5 to 2.0 A g⁻¹ within a potential window of 0.01-3.0 V. The first cycle discharge capacities of the Fe-Tp anode were recorded as 1342, 1146, and 1004 mAh g⁻¹ at current densities of 0.5, 1.0, and 2.0 A g⁻¹, respectively. Over subsequent cycles, the specific capacities initially decreased but later increased to maximum reversible values of 1116 mAh g⁻¹ (214th cycle at 0.5 A g⁻¹), 847 mAh g⁻¹ (250th cycle at 1.0 A g⁻¹), and 760 mAh g⁻¹ (186th cycle at 2.0 A g⁻¹).

The continuous increase in specific capacity during the initial cycles is attributed to the electrochemical activation of functional sites within the deeper matrix of the Fe-Tp electrode via its hierarchical porous structure. The prolonged activation process is facilitated by the high-density packing of lithiophilic sites, which require multiple charge-discharge cycles for the electrolyte to access the deepest regions of the electrode. Additionally, the formation of a solid electrolyte interphase (SEI) during the initial cycles stabilizes the electrode-electrolyte interface, further enhancing capacity. SEM images confirm the formation of the SEI layer on the surface of the Fe-Tp electrode.

FIGS. 34A-34H also demonstrate the consistent performance of Fe-Tp synthesized at a large scale (25 g batch), which achieved a specific capacity of ˜800 mAh g⁻¹ at the 362nd cycle at 1.0 A g⁻¹. The specific capacity values of Fe-Tp are significantly higher than those of most reported pristine MOFs, MOF-related materials, and commercial graphite anodes, highlighting its superior cycling performance. This is attributed to the unique structural features of Fe-Tp, including its doubly interpenetrated 3D framework, high-density lithiophilic sites (phenyl rings and oxygen atoms), and hierarchical porosity, which facilitate smooth intercalation and deintercalation of Li ions.

The galvanostatic charge-discharge (GCD) profile of Fe-Tp, recorded at various current densities from 0.1 to 10 A g ⁻¹, further underscores its exceptional Li ion storage capacity. The coulombic efficiency of Fe-Tp remains nearly 100% across the tested current densities, indicating a highly reversible process throughout the cyclic stability analysis. The rate capability study shows a decrease in specific capacity from 1285 mAh g⁻¹ at 0.1 A g⁻¹ to 205 mAh g⁻¹ at 10 A g⁻¹, with the capacity recovering to 1447 mAh g⁻¹ when the current density is switched back to 0.1 A g⁻¹. This demonstrates the excellent electrochemical stability of Fe-Tp across varying charge-discharge rates.

FIGS. 34A-34F also includes cyclic voltammograms (CV) recorded at scan rates between 0.2 and 2.0 mV s⁻¹, which reveal two sharp, distinctive redox peaks, signifying stable and reversible lithiation and delithiation. The CV analysis indicates that the Li ion storage mechanism in Fe-Tp is governed by both capacitive and diffusion-controlled processes, with capacitive contributions becoming dominant at higher scan rates. The impedance measurements after the 1st, 100th, and 500th cycles show decreasing charge transfer resistance (Rct), indicating improved Li⁺ ion diffusion and stable SEI layer formation over cycling.

Ex-situ XPS analysis of pristine, lithiated, and delithiated Fe-Tp samples further confirms the reversible lithiation and delithiation processes. The analysis reveals changes in the oxidation state of iron, binding energy shifts in oxygen and carbon atoms, and reversible interactions with chlorides, all of which contribute to the lithiation process. The PXRD profiles of Fe-Tp after prolonged cycling (up to 528 cycles) show intact crystalline structure, demonstrating the structural stability of Fe-Tp even after extended use. These findings collectively highlight the suitability of Fe-Tp as a high-performance anode material for LIBs.

Specifically, FIG. 34A illustrates the rate performance of the half-cell analysis of Fe-Tp. FIGS. 34B-34D illustrate the cyclic stability analysis at various current density (0.5, 1, and 2 A g⁻¹, for each of FIGS. 34B, 34C, and 34D, respectively). FIG. 34 E illustrates the cyclic stability analysis of 25 g batch of Fe-Tp. FIG. 34F illustrates the GCDC profiles at various current densities (0.1 to 10 A g⁻¹). FIG. 34G illustrates the CV profile. FIG. 34H illustrates the plot scan rate (mV sec⁻¹) Vs. % contribution (diffusion or capacitive).

### Example 14: Analysis of Full Cell Based on Fe-Tp as Anode

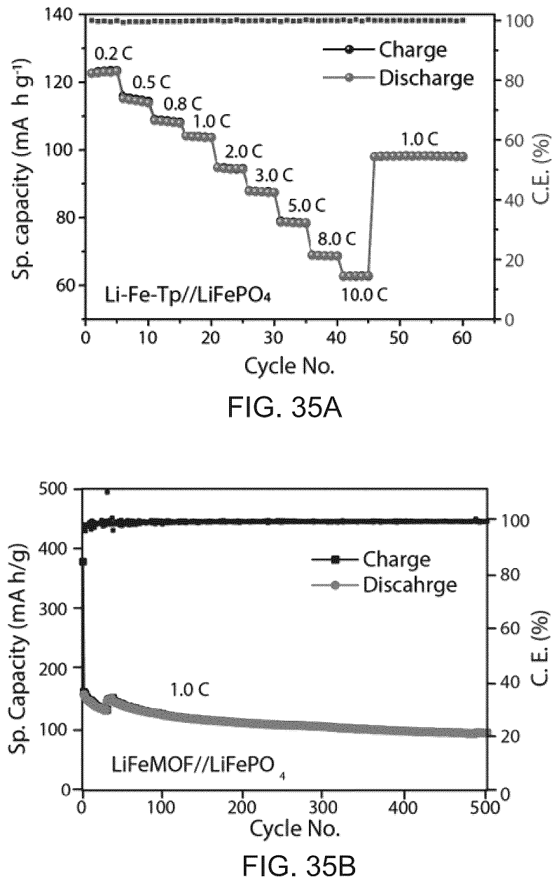

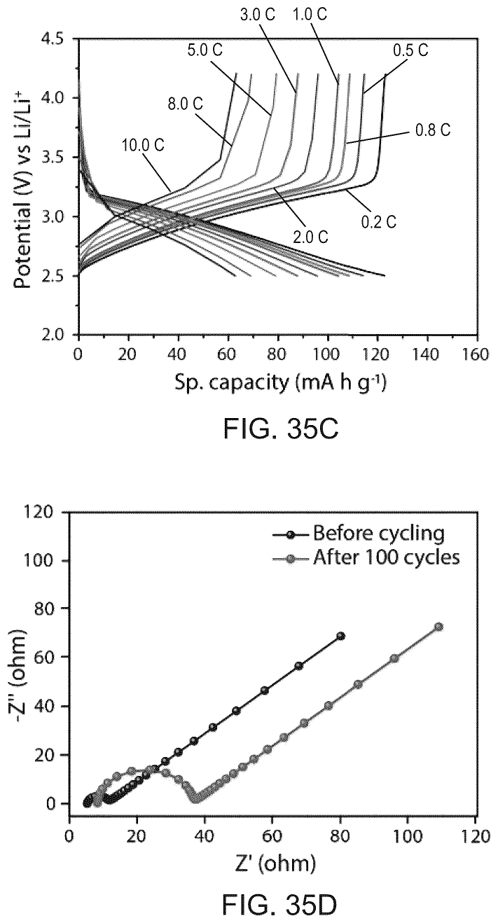

FIGS. 35A-35D each illustrate results of experimentation using a full cell that was fabricated using lithiated Fe-Tp anode (Li-Fe-Tp) and lithium iron phosphate (LFP) cathode (Q_{theoretical}=170 mAhg⁻¹). Specifically, FIG. 35A illustrates the electrochemical performance of a full cell fabricated using a lithiated Fe-Tp anode (Li-Fe-Tp) and a lithium iron phosphate (LFP) cathode, with a theoretical capacity of 170 mAh g⁻¹. The full cell delivered a high-capacity value of 125 mAh g⁻¹ at 0.2 C and demonstrated excellent rate performance, retaining a capacity of 60 mAh g⁻¹ at 10 C. The cyclic voltammetry (CV) profiles show a current increment as the scan rate increases from 0.2 to 1 mVs⁻¹, indicating efficient lithium-ion transport and interaction within the electrode.

FIG. 35B illustrates the long-term cycling performance of the full cell at 1.0 C. The cell exhibited an initial capacity of 151 mAh g⁻¹ and retained 60% of its capacity after 500 charge-discharge cycles, with a columbic efficiency of approximately 99.8%. The galvanostatic charge-discharge (GCD) analysis further demonstrates the increment in specific capacity as the current rate decreases from 10 C to 0.2 C, showcasing the adaptability of the cell to varying charge-discharge rates.

FIG. 35C depicts the full cell's performance at 10 C, where it delivered an initial specific capacity of 65 mAh g⁻¹.After 1000 charge-discharge cycles, the cell retained 85% of its initial capacity, underscoring the excellent electrochemical stability and long-term performance of the lithiated Fe-Tp anode in a full-cell configuration.

FIG. 35D illustrates the electrochemical impedance spectroscopy (EIS) profile of the full cell, recorded before and after 100 cycles. Initially, the cell exhibited a low series resistance of 5.24 Ω and a low charge transfer resistance (Rct) of 5.58 Ω, facilitating faster lithium-ion diffusion from the electrolyte to the electrode surface and bulk. After 100 cycles, the series resistance increased to 8.256 Ω, and the Rct rose to 27.61 Ω, indicating the impact of SEI layer growth and lithium-ion diffusion resistance on charge-transfer properties. If the capacity retention of the cell drops below 80%, the increased resistance through the SEI layer further affects the charge-transfer behavior, as reflected in the higher Rct values.

These figures collectively demonstrate the superior electrochemical performance, rate capability, and long-term stability of the lithiated Fe-Tp anode in full-cell configurations, making it a promising candidate for high-performance lithium-ion battery applications.

### Example 15: MOFite Performance

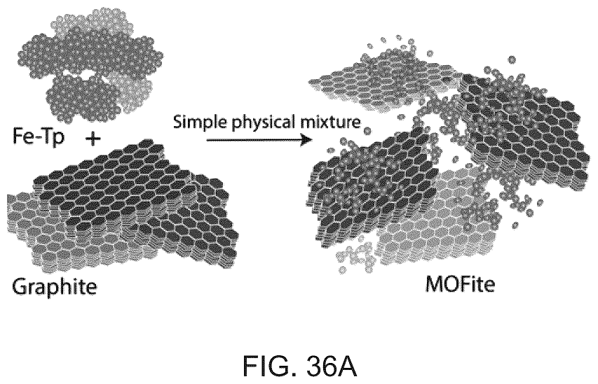

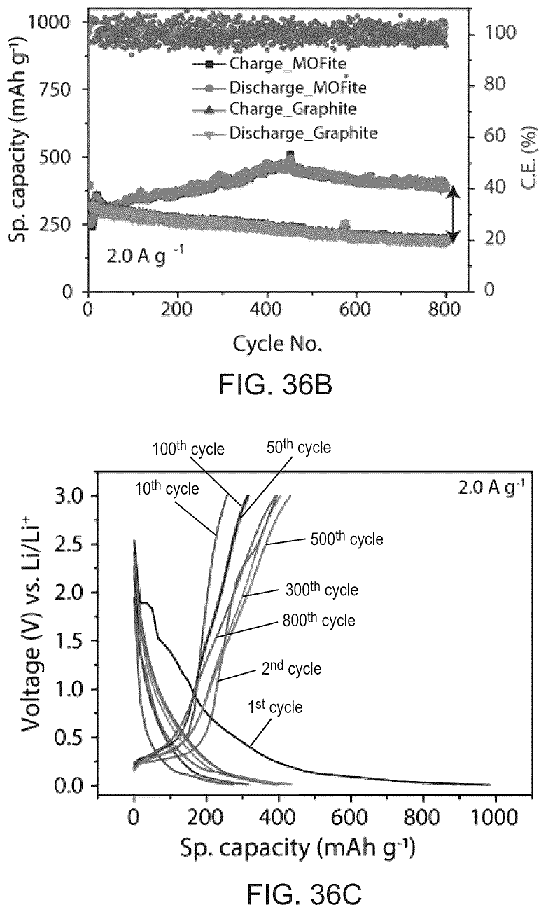

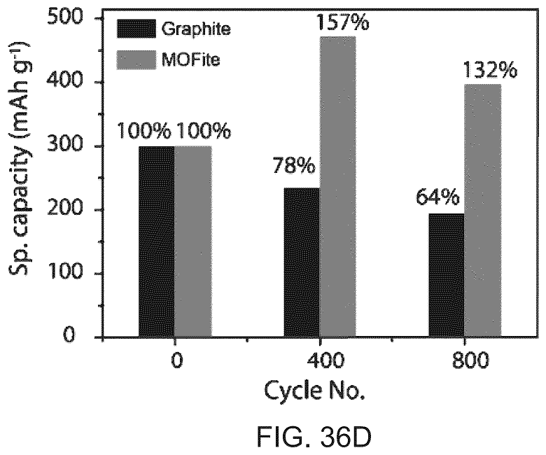

FIGS. 36A-36D illustrate the evaluation of MOFite, a composite material designed, as described herein, as a performance booster for commercially available graphite anodes in lithium-ion batteries (LIBs). The analysis aims to demonstrate the practical utility of high-performance Fe-Tp in enhancing the electrochemical performance of graphite-based anodes. MOFite was fabricated using a simple physical mixing strategy, as described above in association with FIGS. 32A-32B, combining Fe-Tp and graphite without requiring complex mixture fabrication procedures. The ratio of Fe-Tp:Graphite can be within a range of 1:99 to 30:70. In some examples, the ratio of Fe-Tp:Graphite is 10:90.

The initial charge-discharge experiments revealed that both MOFite and graphite exhibited a specific capacity of approximately 300 mAh g⁻¹ at a current density of 2 A g⁻¹. This suggests that the initial charge storage primarily originated from the graphite constituent in MOFite, which is readily accessible for lithium ions. Over extended cycling, the capacity of MOFite steadily increased, reaching double the capacity of graphite at 400 cycles (472 mAh g⁻¹ vs. 235 mAh g⁻¹). This significant enhancement in performance is attributed to the presence of 10 wt % Fe-Tp in MOFite, which acts as a lithiophilic substrate, improving lithium-ion access and utilization during the charge-discharge process.

After 800 cycles of charge-discharge, the specific capacitance of graphite decreased to 194 mAh g⁻¹, whereas MOFite displayed an enhanced capacity of 397 mAh g⁻¹. This performance underscores the substantial impact of incorporating Fe-Tp into the composite, leveraging its inherent charge storage capacity and ability to facilitate lithium-ion diffusion and interaction. These findings highlight the practical potential of MOFite as a high-performance anode material for LIBs.

FIG. 36A illustrates the fabrication process of MOFite, a composite material designed as a performance booster for commercially available graphite anodes in lithium-ion batteries (LIBs). The MOFite composite was prepared using a simple physical mixing strategy at room temperature, combining Fe-Tp (10 wt %) and graphite (90 wt %) without requiring complex fabrication procedures. This straightforward approach ensures ease of integration into existing LIB manufacturing processes.

FIG. 36B illustrates the initial specific capacity of MOFite and graphite during charge-discharge experiments at a current density of 2 A g⁻¹. Both materials exhibited a specific capacity of approximately 300 mAh g⁻¹, indicating that the initial charge storage primarily originated from the graphite constituent in MOFite, which is readily accessible for lithium ions.

FIG. 36C illustrates the extended cycling performance of MOFite compared to graphite. After 400 charge-discharge cycles, MOFite achieved a specific capacity of 472 mAh g⁻¹, doubling the capacity of graphite, which reached only 235 mAh g⁻¹. This significant enhancement in performance is attributed to the presence of 10 wt % Fe-Tp in MOFite, which acts as a lithiophilic substrate, improving lithium-ion access and utilization during the charge-discharge process.

FIG. 36D illustrates the long-term cycling performance of MOFite and graphite after 800 charge-discharge cycles. While the specific capacity of graphite decreased to 194 mAh g⁻¹, MOFite displayed an enhanced capacity of 397 mAh g⁻¹. This performance underscores the substantial impact of incorporating Fe-Tp into the composite, leveraging its inherent charge storage capacity and ability to facilitate lithium-ion diffusion and interaction.

Further, the PXRD profile of MOFite revealed crystalline peaks from both Fe-Tp and graphite, confirming the structural integrity of the composite. The enhanced performance of MOFite is attributed to the dual role of Fe-Tp: (1) contributing its inherent charge storage capacity and (2) acting as a lithiophilic substrate that improves lithium-ion access to graphite, which is not readily available for lithium ions. This dual functionality ensures effective lithium utilization during the charge-discharge process.

FIGS. 36A-36D collectively demonstrate the practical utility of MOFite as a high-performance anode material for LIBs, offering significant improvements in specific capacity and long-term cycling stability.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims. Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

### Discussion of Possible Embodiments

The following are non-exclusive descriptions of possible embodiments of the present disclosure.

According to one aspect, a metal organic framework (MOF)-like composite material (MOFite), comprising: a salicylaldehydate-based iron metal organic framework composition; and graphite.

The system/method of the preceding paragraph can optionally include, additionally and/or alternatively any, one or more of the following features/steps, configurations and/or additional components.

For example, the material may further include wherein the salicylaldehydate-based iron metal organic framework composition is within a range of 1-30% of the composite material.

For example, the material may further include wherein the graphite is 90% of the composite material.

For example, the material may further include wherein the salicylaldehydate-based iron metal organic framework composition is within a range of 1% to 20% of the MOF-like composite material and the graphite is within a range of 95% to 80% of the MOF-like composite material.

For example, the material may further include wherein:

the MOF-like composite material is electrically conductive, exhibits rechargeable lithium-ion battery anode specific capacity and is suitable for electrocatalytic conversion reactions; and a capacitance of the MOF-like composite material doubles after 400 charge-discharge cycles when used in a lithium-ion battery.

For example, the material may further include wherein a specific capacity of the MOF-like composite material is within a range of approximately 300-500 mAh g⁻¹at 2 A g⁻¹. According to one aspect, a lithium-ion battery, comprising:
a cathode comprising a lithium-containing metal oxide as an active material;
an anode including: a salicylaldehydate-based iron metal organic framework composition;
and graphite; a separator disposed between the cathode and the anode, the separator being electrically insulating and ion-permeable; and
an electrolyte comprising a lithium salt dissolved in a non-aqueous organic solvent, the electrolyte being in ionic contact with both the positive and negative electrodes (cathode and anode, respectively),
wherein the battery is configured to reversibly intercalate and de-intercalate lithium ions during charge and discharge cycles.

The system/method of the preceding paragraph can optionally include, additionally and/or alternatively any, one or more of the following features/steps, configurations and/or additional components.

For example, the lithium-ion battery may further include wherein the salicylaldehydate-based iron metal organic framework composition is a dopant booster to the graphite.

For example, the lithium-ion battery may further include a full cell, the full cell comprising: a lithiated Fe-Tp anode; and a lithium iron phosphate cathode.

For example, the lithium-ion battery may further include wherein the full cell delivers a high-capacity value of 125 mAh g⁻¹ at 0.2 degrees C. and a rate of 60 mAh g⁻¹ at 10 degrees C.

For example, the lithium-ion battery may further include wherein the full cell comprises an initial capacity of 151 mAh g⁻¹ with 60% capacity retention at a 500th cycle and a columbic efficiency of approximately 99.8%.

For example, the lithium-ion battery may further include wherein at 10 degrees C. the full cell delivers an initial capacitance of 65 mAh g⁻¹.

For example, the lithium-ion battery may further include wherein the full cell retains 85% of initial capacity after 1000 charge-discharge cycles.

For example, the lithium-ion battery may further include wherein the anode comprises an enhanced capacity of 397 mAh g⁻¹ after 800 charge-discharge cycles.

According to one aspect, a method for synthesis of a salicylaldehydate-based iron metal organic framework composition, the method comprising: (a) mixing one or more metal salts and a salicylaldehydate metal organic framework (MOF) in a specified ratio, sufficient to form a mixture; (b) conducting a milling process with the one or more metal salts, salicylaldehydate MOF, and milling balls, to reduce a particle size of the one or more metal salts and salicylaldehydate MOF sufficient to form a product; and (c) heating the product, resulting in a heated product.

The system/method of the preceding paragraph can optionally include, additionally and/or alternatively any, one or more of the following features/steps, configurations and/or additional components.

For example, the method may further include wherein heating the product comprises heating the product in an oven for 24 hours at 90 degrees C.

For example, the method may further include washing the heated product in N-dimethylacetamide (DMA), water, and acetone.

For example, the method may further include wherein: the specified ratio is within a range of 0.8:1 to 1:0.8; and the salicylaldehydate MOF is a 1,3,5-triformyl-phloroglucinol (Tp)-based salicylaldehydate MOF.

For example, the method may further include wherein: the milling balls include agate grinding balls added in a 3:1 ball-to-power ratio; and the milling process is conducted for a range of 50-70 minutes at a range of 300-500 rotations per minute (rpms) at within a range of 30 degrees C. of room temperature.

For example, the method may further include physically mixing the heated product and graphite with PVDF binder and NMP solvent to make a final electrode for coating, resulting in a salicylaldehydate metal oxide framework and graphite composition (MOFite).

What is claimed is:

1. A metal organic framework (MOF)-like composite material (MOFite), comprising:
a salicylaldehydate-based iron metal organic framework composition; and
graphite.

2. The MOF-like composite material of claim 1, wherein the salicylaldehydate-based iron metal organic framework composition is within a range of 1-20% of the composite material.

3. The MOF-like composite material of claim 1, wherein the graphite is 90% of the composite material.

4. The MOF-like composite material of claim 1, wherein the salicylaldehydate-based iron metal organic framework composition is within a range of 5% to 20% of the MOF-like composite material and the graphite is within a range of 95% to 80% of the MOF-like composite material.

5. The MOF-like composite material of claim 1, wherein:
the MOF-like composite material is electrically conductive, exhibits rechargeable lithium-ion battery anode specific capacity and is suitable for electrocatalytic conversion reactions; and
a capacitance of the MOF-like composite material doubles after 400 charge-discharge cycles when used in a lithium-ion battery.

6. The MOF-like composite material of claim 1, wherein a specific capacity of the MOF-like composite material is within a range of approximately 300-500 mAh g⁻¹ at 2 A g⁻¹.

7. A lithium-ion battery, comprising:
a cathode comprising a lithium-containing metal oxide as an active material;
an anode including:
a salicylaldehydate-based iron metal organic framework composition; and
graphite;
a separator disposed between the cathode and the anode, the separator being electrically insulating and ion-permeable; and
an electrolyte comprising a lithium salt dissolved in a non-aqueous organic solvent, the electrolyte being in ionic contact with both the cathode and anode,
wherein the battery is configured to reversibly intercalate and de-intercalate lithium ions during charge and discharge cycles.

8. The lithium-ion battery of claim 7, wherein the salicylaldehydate-based iron metal organic framework composition is a dopant booster to the graphite.

9. The lithium-ion battery of claim 7, comprising a full cell, the full cell comprising:
a lithiated Fe-Tp anode; and
a lithium iron phosphate cathode.

10. The lithium-ion battery of claim 9, wherein the full cell delivers a high-capacity value of 125 mAh g⁻¹ at 0.2 degrees C. and a rate of 60 mAh g⁻¹ at 10 degrees C.

11. The lithium-ion battery of claim 9, wherein the full cell comprises an initial capacity of 151 mAh g−1 with 60% capacity retention at a 500th cycle and a columbic efficiency of approximately 99.8%.

12. The lithium-ion battery of claim 9, wherein at 10 degrees C. the full cell delivers an initial capacitance of 65 mAh g⁻¹.

13. The lithium-ion battery of claim 7, wherein the full cell retains 85% of initial capacity after 1000 charge-discharge cycles.

14. The lithium-ion battery of claim 7, wherein the anode comprises an enhanced capacity of 397 mAh g⁻¹ after 800 charge-discharge cycles.

15. A method for synthesis of a salicylaldehydate-based iron metal organic framework composition, the method comprising:
(a) mixing one or more metal salts and a salicylaldehydate metal organic framework (MOF) in a specified ratio, sufficient to form a mixture;
(b) conducting a milling process with the one or more metal salts, salicylaldehydate MOF, and milling balls, to reduce a particle size of the one or more metal salts and salicylaldehydate MOF sufficient to form a product; and
(c) heating the product, resulting in a heated product.

16. The method of claim 15, wherein heating the product comprises heating the product in an oven for 24 hours at 90 degrees C.

17. The method of claim 15, further comprising washing the heated product in N-dimethylacetamide (DMA), water, and acetone.

18. The method of claim 15, wherein:
the specified ratio is within a range of 1:0.1 to 1:5; and
the salicylaldehydate MOF is a 1, 3, 5-triformyl-phloroglucinol (Tp)-based salicylaldehydate MOF.

19. The method of claim 15, wherein:
the milling balls include agate grinding balls added in a 3:1 ball-to-power ratio; and
the milling process is conducted for a range of 10 to 120 minutes at a range of 200-1000 rotations per minute (rpms) at within a range of 30 degrees C. of room temperature.

20. The method of claim 15, further comprising physically mixing the heated product and graphite with PVDV binder and NMP solvent to make a final electrode for coating, resulting in a salicylaldehydate metal oxide framework and graphite composition (MOFite).
